(19) United States
(12) Patent Application Publication
(10) Pub. No.: US 2026/0205675 A1
(43) Pub. Date: Jul. 16, 2026

(54) PIPELINE ENDOSCOPIC SYSTEM

(71) Applicant: SHENZHEN ANDELIAN TECHNOLOGY CO., LTD., SHENZHEN (CN)

(72) Inventors: SHAOHUA ZHONG, SHENZHEN (CN); QIANHUA ZHONG, SHENZHEN (CN)

(21) Appl. No.: 19/564,539

(22) Filed: Mar. 12, 2026

Related U.S. Application Data
(63) Continuation-in-part of application No. 18/916,760, filed on Oct. 16, 2024.

(30) Foreign Application Priority Data
Jan. 10, 2026 (WO) PCT/CN2026/071831
Feb. 28, 2026 (CN) 202620247442.4
Mar. 5, 2026 (CN) 202620271713.X
Mar. 5, 2026 (CN) 202620273819.3

(51) Int. Cl. H04N 23/50; G01B 7/02; G01D 5/14; G02B 23/24; H02G 11/02; H04N 7/18

(52) U.S. Cl. CPC H04N 23/555; G01B 7/026; G01D 5/145; G02B 23/2476; H02G 11/02; H04N 7/183

(57) ABSTRACT

A pipeline endoscope system includes an endoscope probe configured for extending into a pipeline and capturing images of the pipeline; a cable configured for electrically connecting the endoscope probe; a cable support device comprising a winding wheel for winding the cable; and a measurement display module. The measurement display module includes a cable length measuring device and a display device, the cable length measuring device comprises a control module and a detection module; at least part of the detection module is connected to the cable and rotates with the cable, and the control module is electrically connected to the cable to receive images captured by the endoscope probe; and the display device communicates with the control module to receive and display the images captured by the endoscope probe.

### CROSS-REFERENCE TO RELATED APPLICATIONS

The present application is a continuation-in-part of Ser. No. US18916760, field on October 16, 2024, and entitled "CABLE LENGTH MEASUREMENT DEVICE", now pending; and claims a priority of PCT/CN2026/071831, field on January 10, 2026; a priority of CN2026202738193, field on March 5, 2026; a priority of CN2026202474424, field on February 28, 2026; and a priority of CN202620271713X, field on March 5, 2026; the entire disclosures of which are incorporated herein by reference.

### TECHNICAL FIELD

The present application relates to the field of pipeline endoscopic technology, particularly involving a pipeline endoscopic system.

### BACKGROUND

Pipeline endoscopic systems, as pipeline inspection devices, typically includes an endoscope probe, cables, a cable support device, and a display unit. The cable support device holds the cables and display unit, while the endoscope probe connects to the display unit via the cables, enabling the visualization of images captured inside the pipeline on the display unit. However, existing pipeline endoscopic systems cannot measure the extension or retraction length of the cables, preventing users from determining the position of the endoscope probe within the pipeline, which results in suboptimal performance.

### SUMMARY

This application provides a pipeline endoscopic system that can solve the problem of the inability of pipeline endoscopic systems in related technologies to measure the length of cable extension or retraction, resulting in users being unable to know the position of the endoscope probe in the pipeline and poor usability.

A pipeline endoscope system includes an endoscope probe configured for extending into a pipeline and capturing images of the pipeline; a cable configured for electrically connecting the endoscope probe; a cable support device comprising a winding wheel for winding the cable; and a measurement display module. The measurement display module includes a cable length measuring device and a display device, the cable length measuring device comprises a control module and a detection module; at least part of the detection module is connected to the cable and rotates with the cable, and the control module is electrically connected to the cable to receive images captured by the endoscope probe; and the display device communicates with the control module to receive and display the images captured by the endoscope probe. The detection module is configured to generate a sensing signal when the winding wheel rotates, and the control module is capable of receiving the sensing signal, and calculating a length of the cable extension or retraction on the winding wheel based on the sensing signal.

Based on the pipeline endoscope system in this application, a cable length measuring device is designed, which includes a control module and a detection module, when the cable on the winding wheel extends or retracts, the winding wheel rotates, and the detection module generates a sensing signal, the detection module sends the sensing signal to the control module that is electrically connected to it, the control module calculates a length of the cable extension or retraction based on the sensing signal and a diameter of a central axle of the winding wheel, this effectively measures the length of the cable extension or retraction, making it easy for users to know the position of the endoscope probe in the pipeline and achieving good use experience. By designing a cable support device, the cable support device includes a winding wheel, the winding wheel is used for cable winding, so that the cables can be neatly arranged on the central axle of the winding wheel. By designing a display device, the display device is used to display the images captured by the endoscope probe, so that users can observe the internal situation of the pipeline from the display device.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a schematic view of a cable length measuring device according to a first embodiment of the present disclosure.

FIG. 2 shows another schematic view of the cable length measuring device of FIG. 1.

FIG. 3 is an exploded view of the cable length measuring device of FIG. 1.

FIG. 4 shows another exploded view of the cable length measuring device of FIG. 3.

FIG. 5 is an enlarged view of A part of FIG. 4.

FIG. 6 is a schematic view of a rotary transmission component used in the cable length measuring device of FIG. 1.

FIG. 7 is a plan view of the cable length measuring device of FIG. 1.

FIG. 8 is a cross-sectional view along A-A’ of the cable length measuring device of FIG. 7.

FIG. 9 is a cross-sectional view along B-B’ of the cable length measuring device of FIG. 7.

FIG. 10 is an enlarged view of the B part of FIG. 8.

FIG. 11 is an enlarged view of the C part of FIG. 9.

FIG. 12 is a schematic view of a pipeline endoscope system according to a second embodiment of the present disclosure.

FIG. 13 is a schematic view of a detection module according to a modified second embodiment of the present disclosure, which includes an encoder therein, and a support bracket which is different from the support base of FIG. 12.

FIG. 14 is another schematic view of FIG. 13.

FIG. 15 is a cross sectional view of the detection module of FIG. 13.

FIG. 16 is a schematic cross sectional view of a detection module according to another modified second embodiment of the present disclosure, which includes an encoder, and a support base which is the same as the support base of FIG. 12.

FIG. 17 is another schematic cross sectional view of the detection module of FIG. 16.

FIG. 18 is a schematic view of a pipeline endoscope system according to a modified second embodiment of the present disclosure, wherein an adapter cable and a triggering element are further included.

FIG. 19 is another schematic view of the pipeline endoscope system of FIG. 12.

FIG. 20 is an enlarged view showing a cable length measuring device of the pipeline endoscope system of FIG. 12 connected to a central axle of the winding wheel according to a second embodiment of the present disclosure.

FIG. 21 is an exploded view of FIG. 20.

FIG. 22 shows another exploded view of FIG. 20.

FIG. 23 shows a first detection component is a magnet located in the rotating housing, and a second detection component is a hall sensor located in the fixing housing.

FIG. 24 shows a first detection component is a transmitter located in the rotating housing, and a second detection component is a receiver located in the fixing housing.

FIG. 25 shows a detection module includes a gyroscope.

FIG. 26 is a schematic view of a control box used in the pipeline endoscope system of FIG. 12.

FIG. 27 is a schematic view of a pipeline endoscope system according to an alternative embodiment of the present disclosure, wherein a triggering element is arranged on the control box.

FIG. 28 is a partial circuit block diagram of the pipeline endoscopy system of FIG. 12.

FIG. 29 is a partial schematic view of the pipeline endoscope system of FIG. 12.

FIG. 30 is a schematic view of a centralizer used according an embodiment of present application.

FIG. 31 shows the centralizer of FIG. 30 is mounted on the endoscope probe.

FIG. 32 is another schematic view of the centralizer, showing the centralizer in another state.

FIG. 33 is another partial schematic view of the pipeline endoscope system of FIG. 29.

FIG. 34 is a schematic view of the detection module according to the second embodiment mounted on the support base.

FIG. 35 is another schematic view of the detection module according to the second embodiment mounted on the support base.

FIG. 36 is a schematic view showing the detection module of FIG. 34 includes a shell, a pulley assembly, a transmission component, an encoder, and a counting board.

FIG. 37 is another schematic view showing the detection module of FIG. 34 includes a shell, a pulley assembly, a transmission component, an encoder, and a counting board.

FIG. 38 is further another schematic view showing the detection module is mounted on the support base.

FIG. 39 is an enlarged view of the detection module of FIG. 38.

FIG. 40 is an exploded view the detection module of FIG. 38.

FIG. 41 is a schematic view of a pipeline endoscope system according to one embodiment of the present disclosure, wherein the protective cover covers a winding wheel.

FIG. 42 is another schematic view of the pipeline endoscope system of FIG. 41.

FIG. 43 is partially exploded view of the pipeline endoscope system of FIG. 41 showing the protective cover is detached from the winding wheel.

FIG. 44 is a schematic view of a pipeline endoscope system according to one embodiment of the present disclosure, wherein the cable is received in an accommodating cavity of a flexible cover body.

FIG. 45 is a schematic view of a protective cover according to one embodiment of the present disclosure, wherein the protective cover has a closed structure, and the closed structure includes a Velcro.

FIG. 46 is a schematic view of a protective cover according to one embodiment of the present disclosure, wherein the protective cover has a closed structure which is a buckle.

FIG. 47 is a schematic view of a protective cover according to one embodiment of the present disclosure, wherein the protective cover has a closed structure which is a tether, and the tether is untied.

FIG. 48 is a schematic view of a protective cover according to one embodiment of the present disclosure, wherein the protective cover has a closed structure which is a tether, and the tether is tied.

FIG. 49 is partially cross sectional view of a flexible cover body according to one embodiment of the present disclosure.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

In order to make the above objectives, features, and advantages of the present application more obvious and understandable, the following will provide further detailed explanations of the present application in conjunction with the accompanying drawings and specific implementation methods.

### First Embodiment

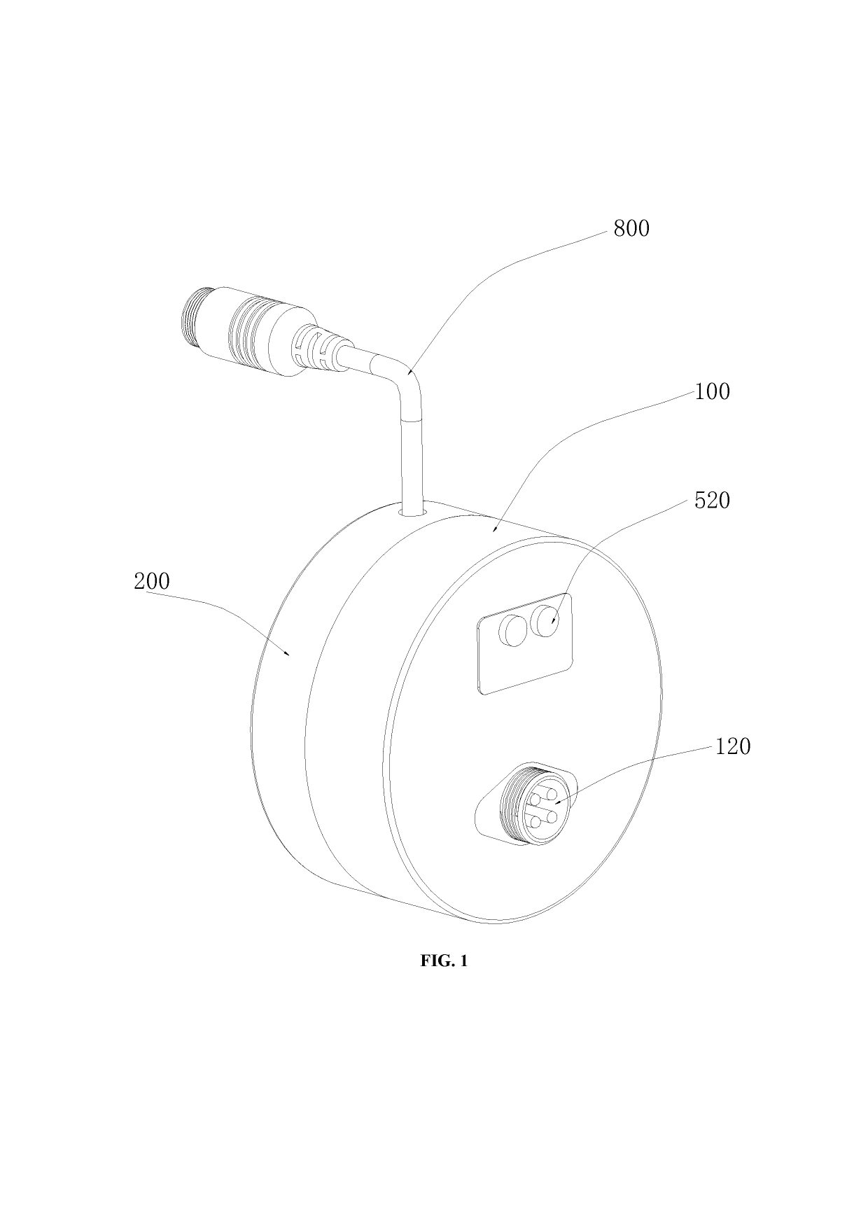

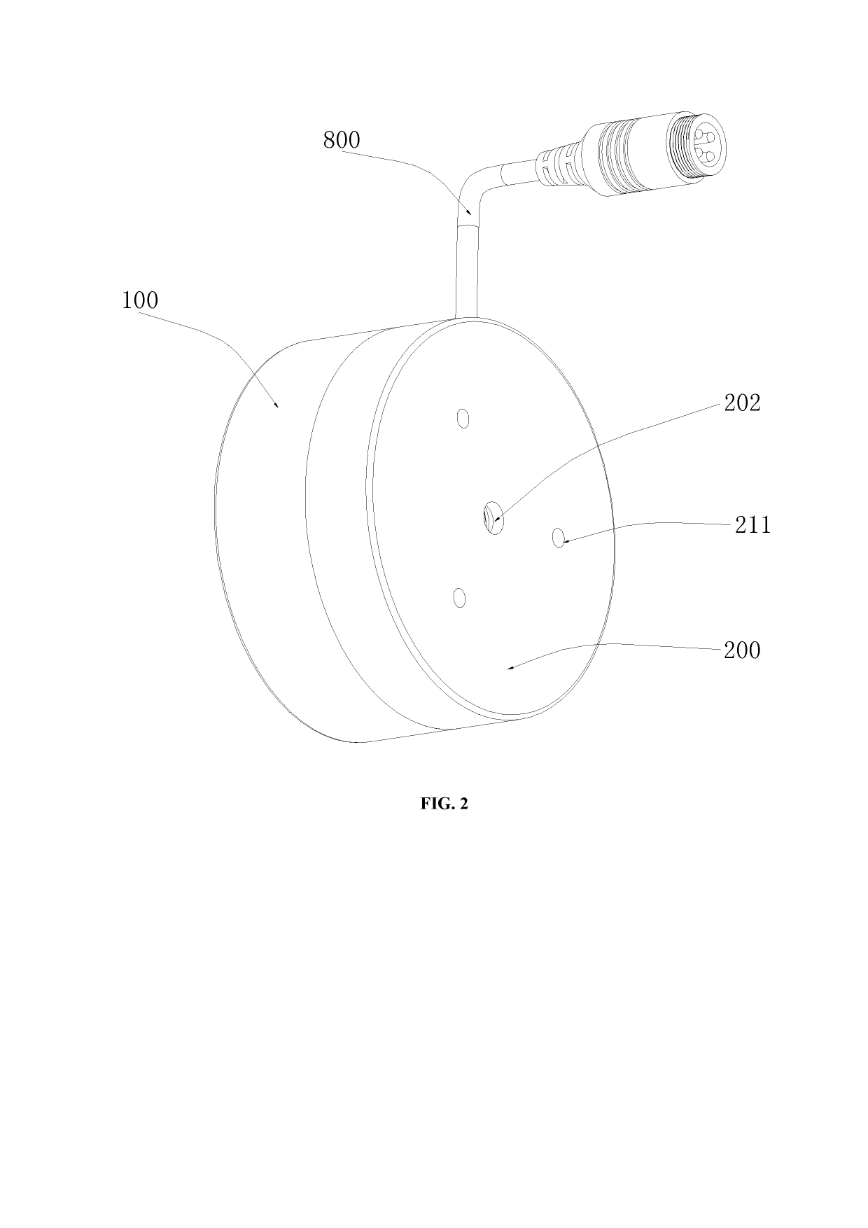

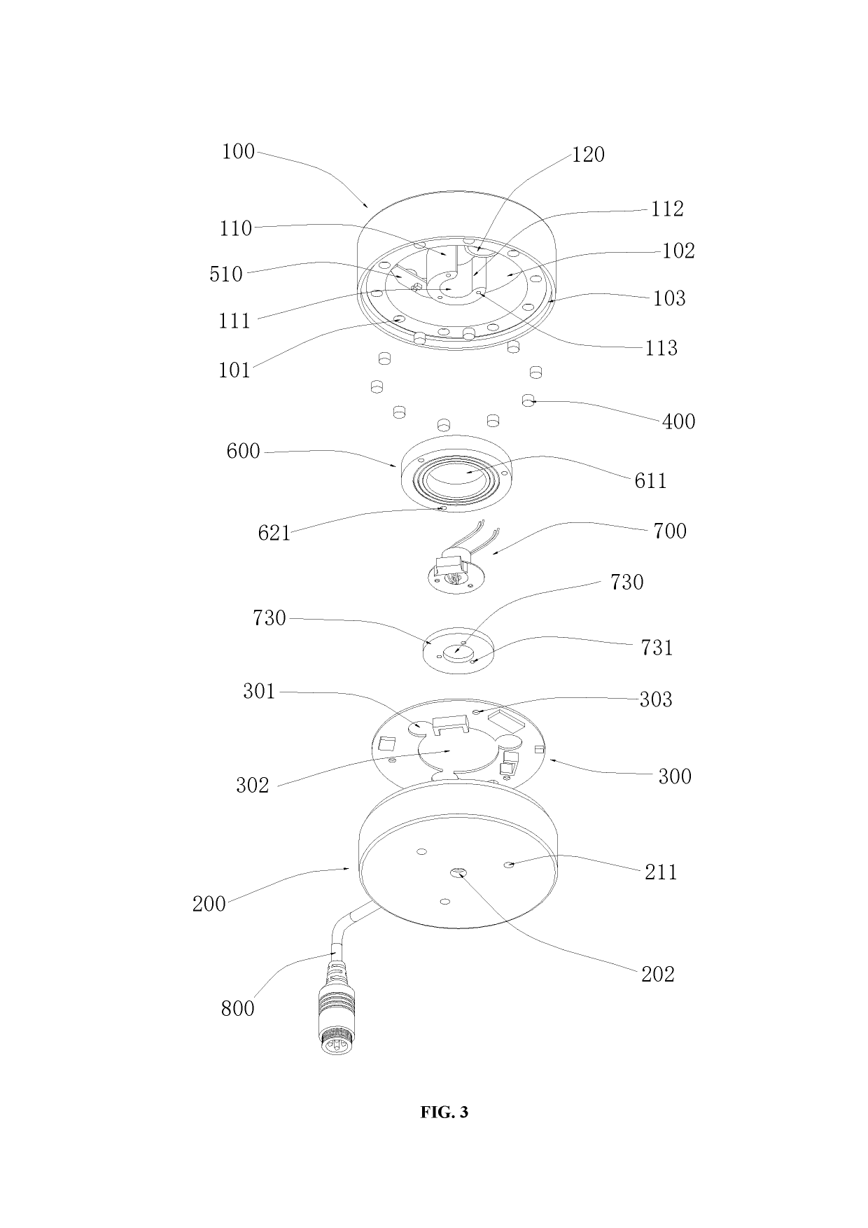

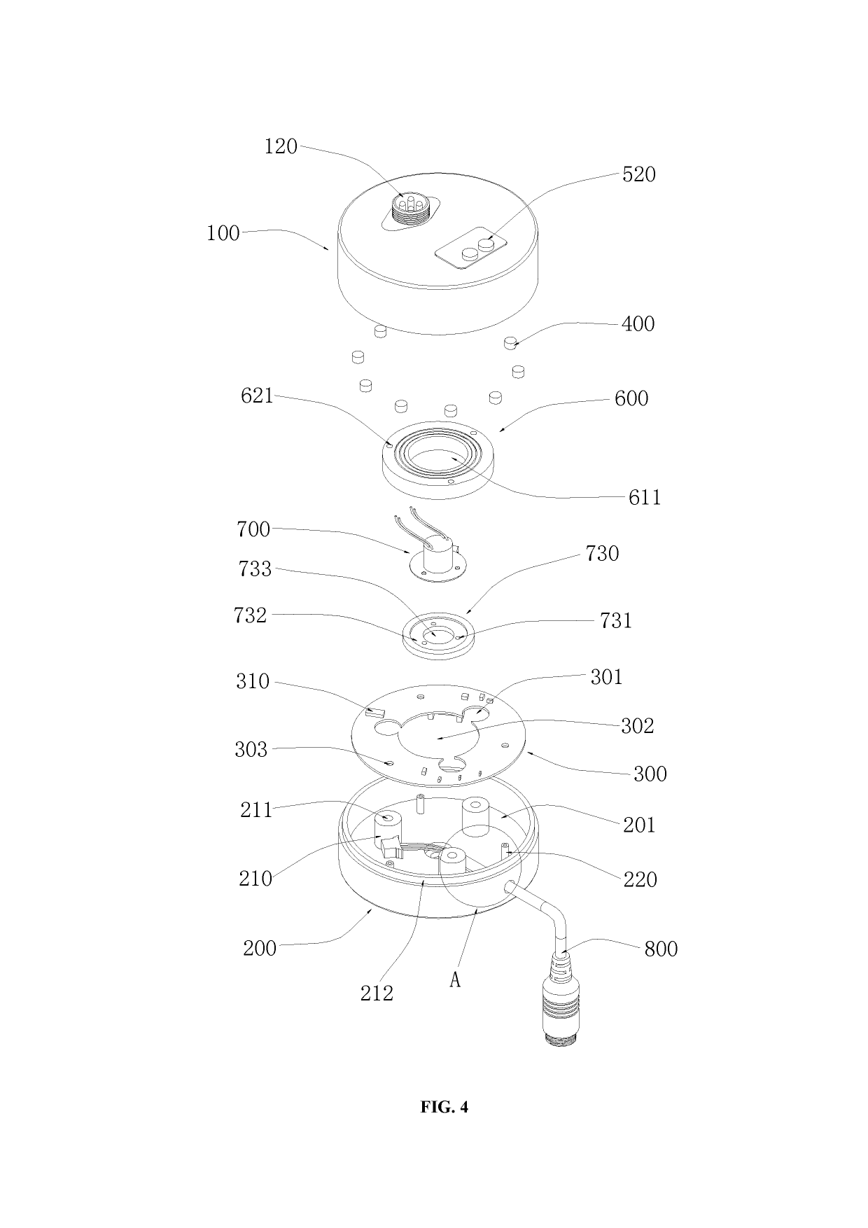

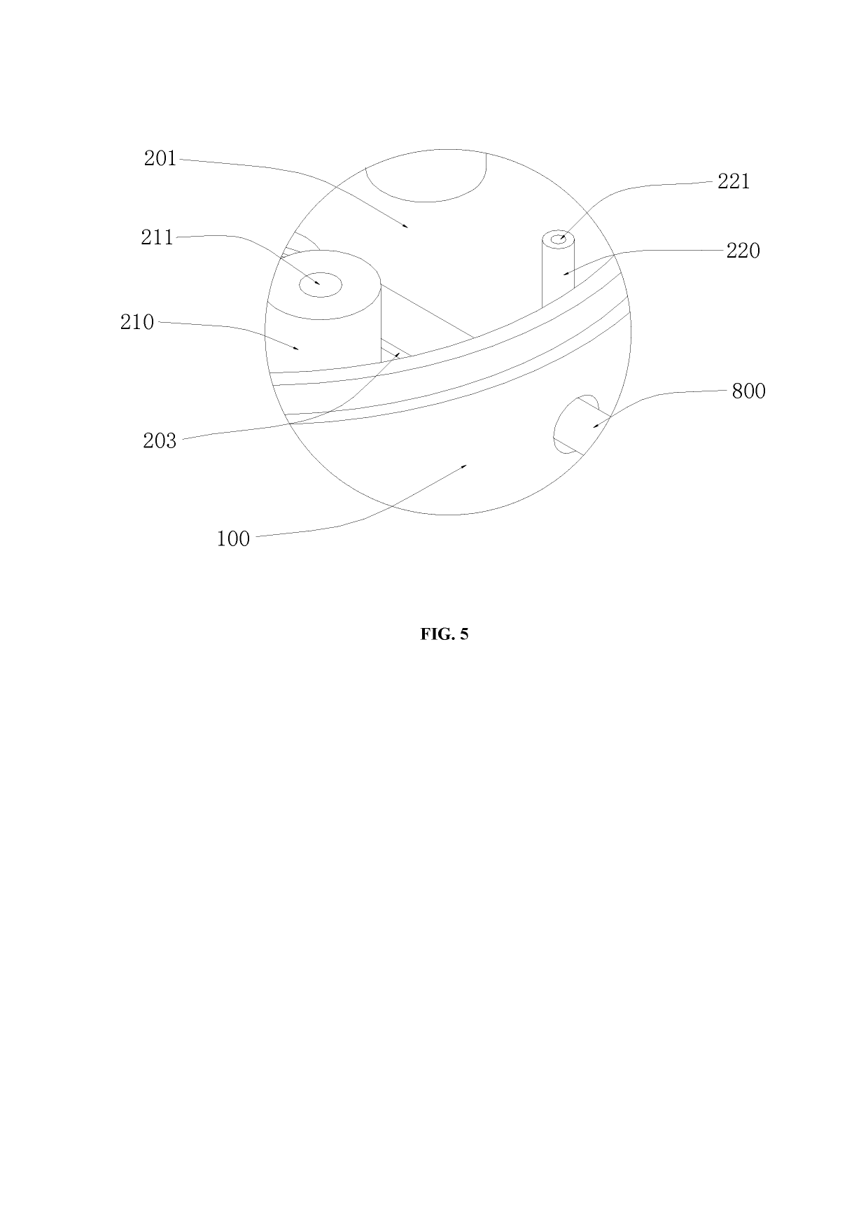

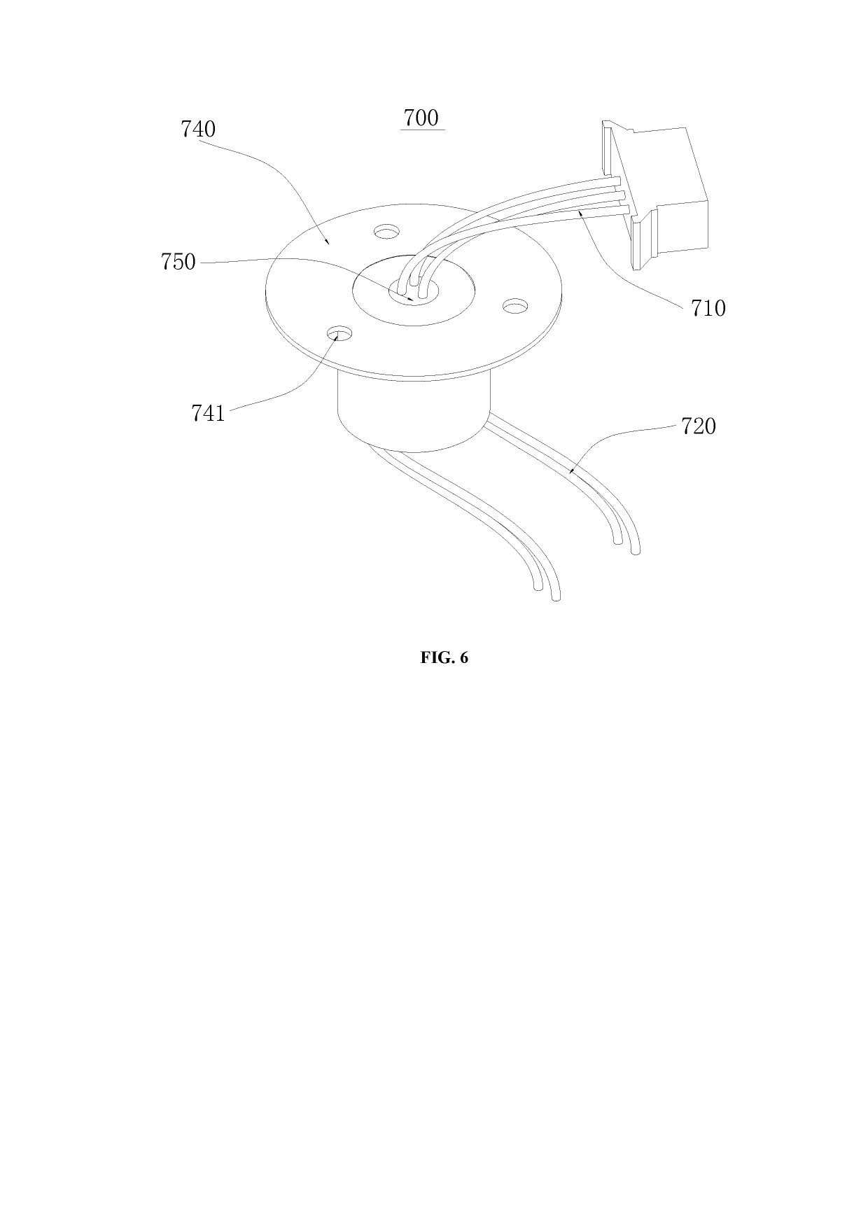

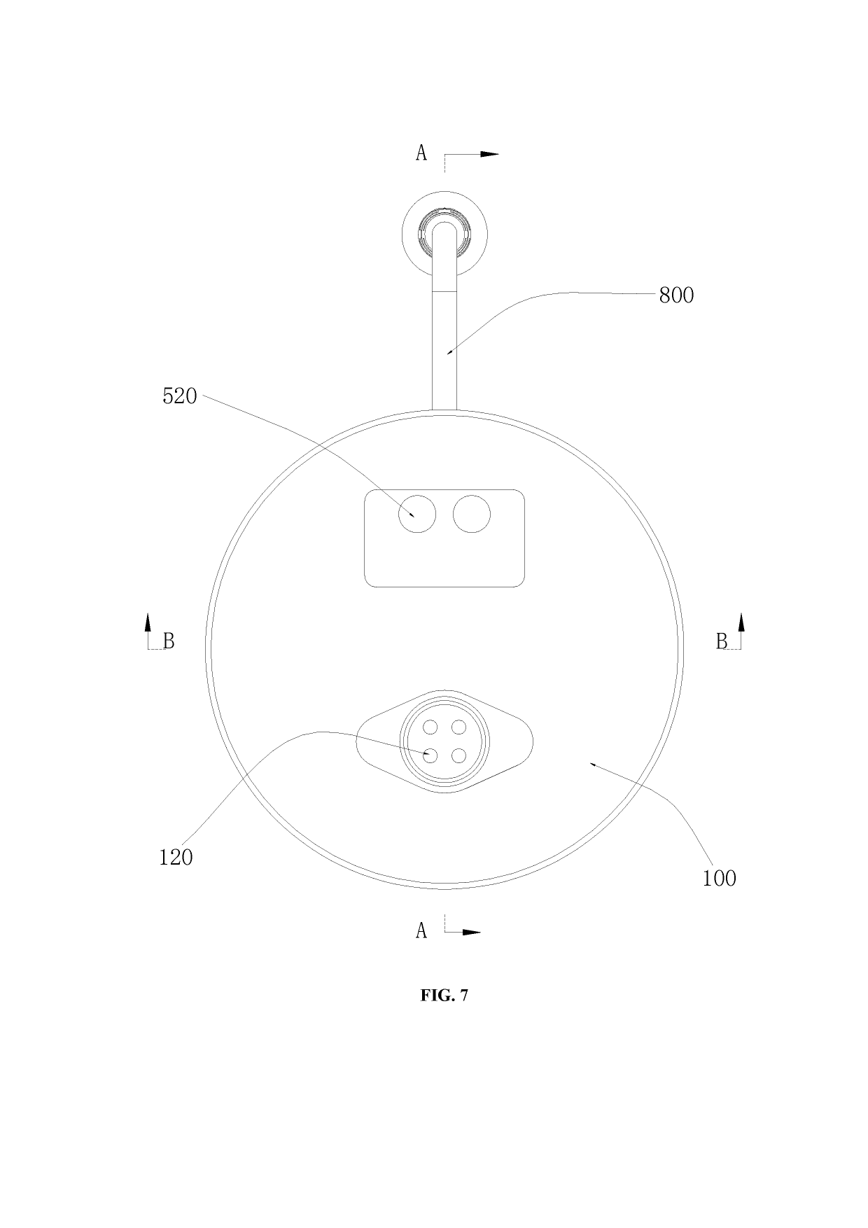

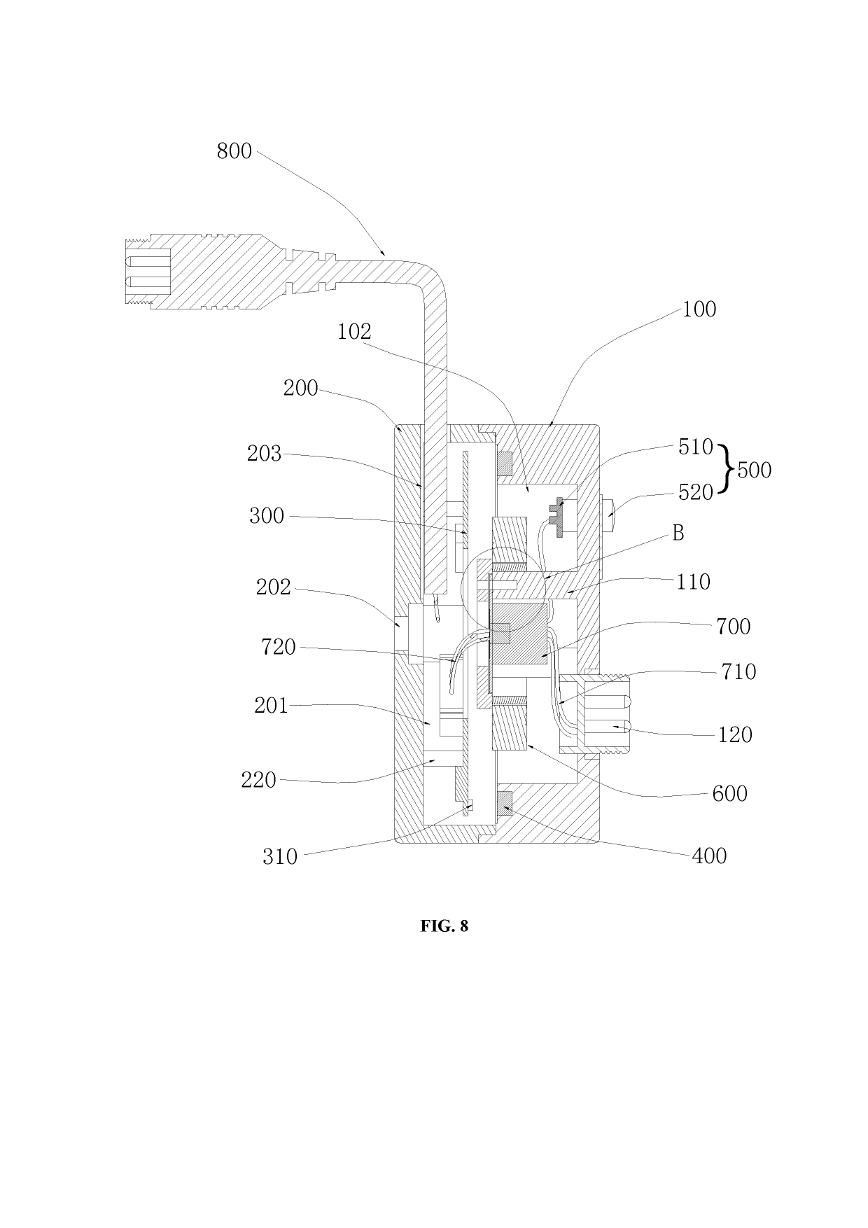

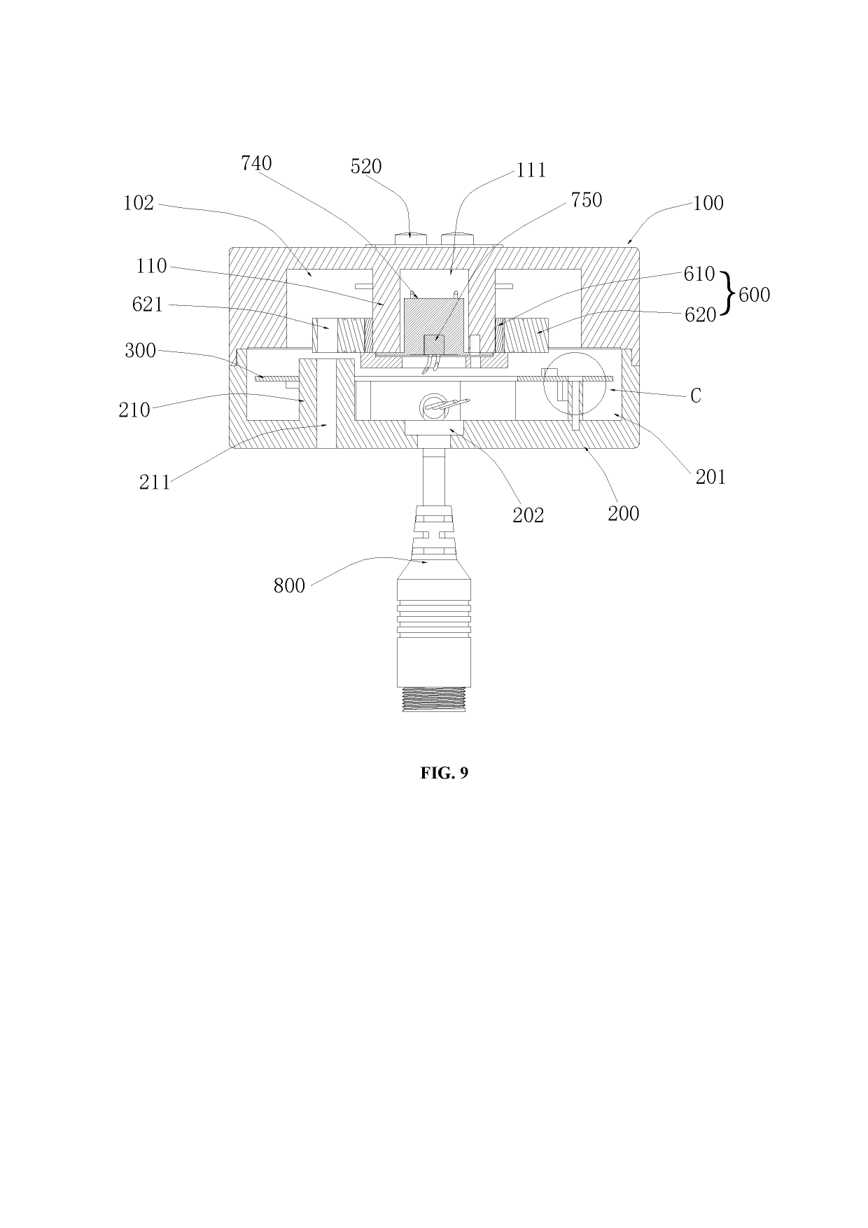

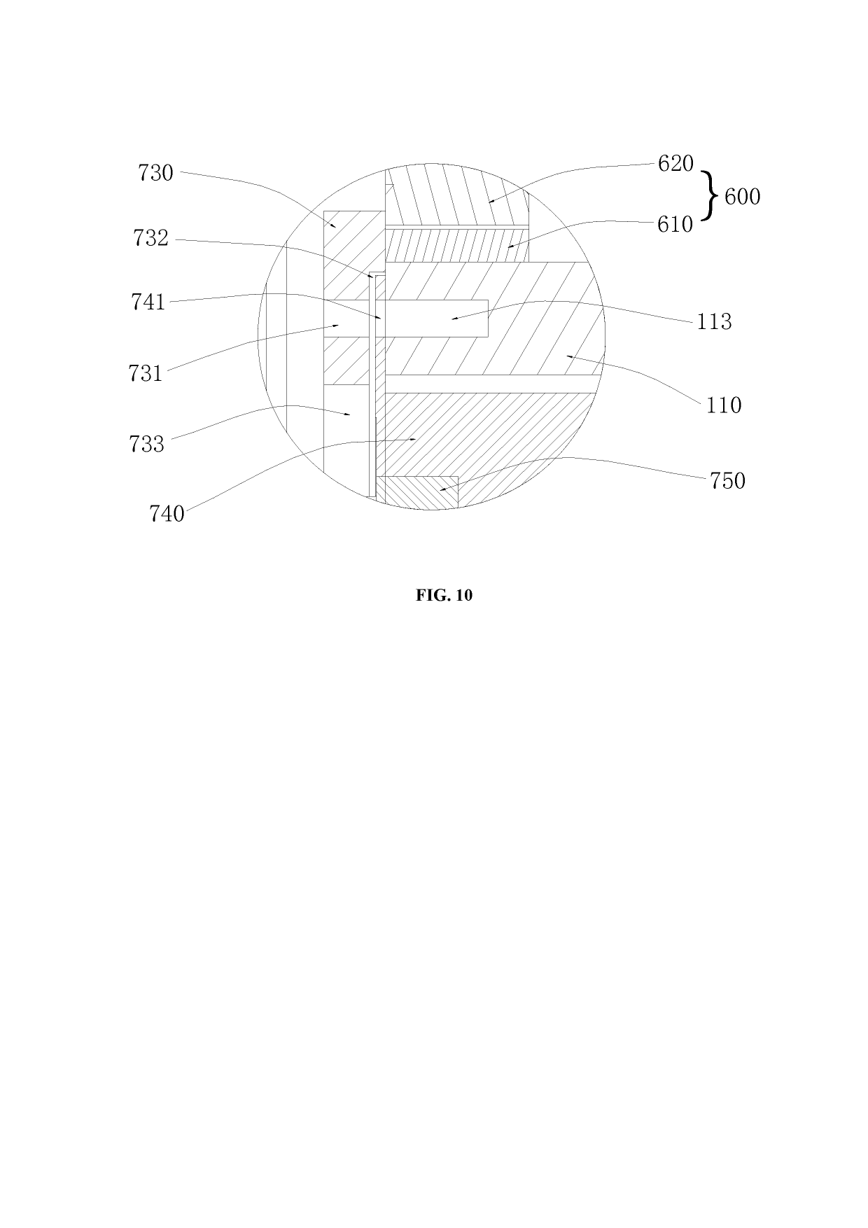

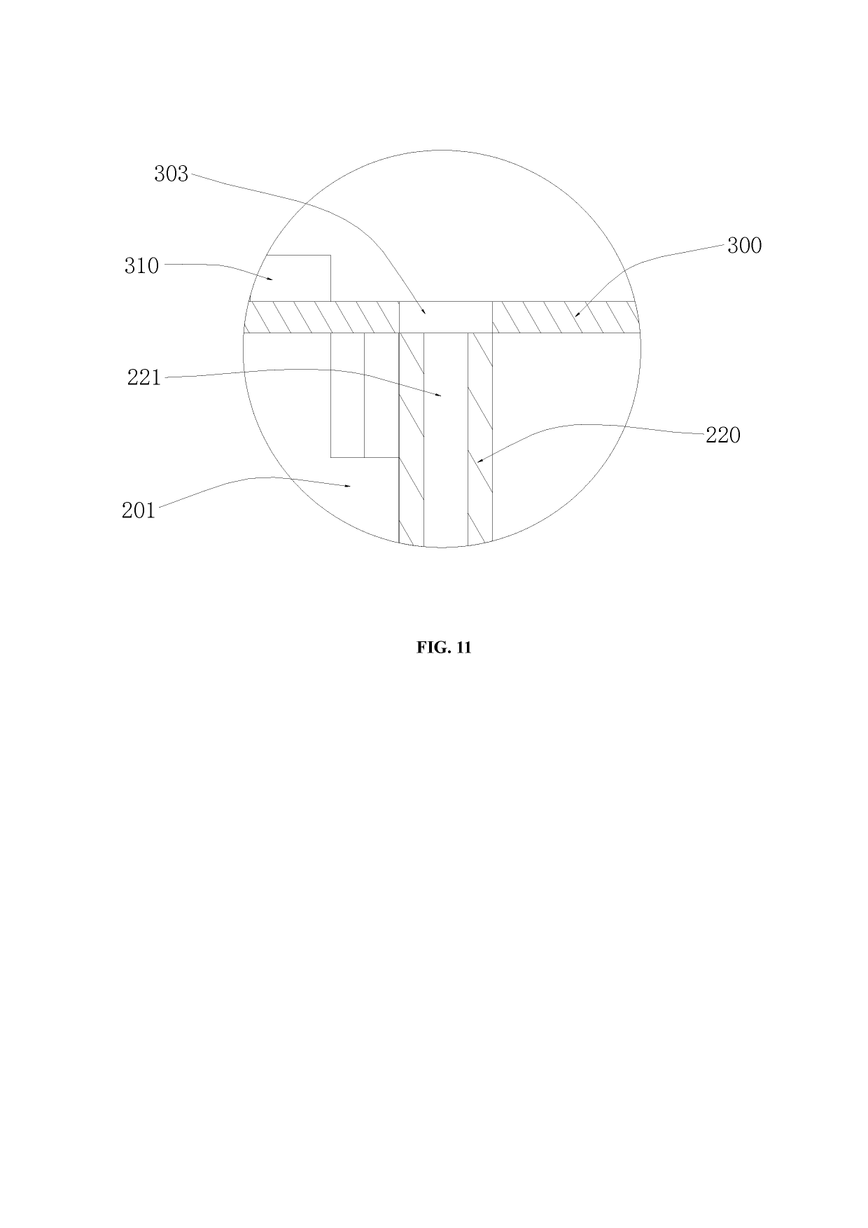

Referring to FIG. 1, the first embodiment of this application provides a cable length measuring device, which is connected to a winding reel to measure the extension or retraction length of the cable on the winding reel. Specifically, the cable length measuring device can be used in a pipe endoscopic system and is connected between the endoscopic probe and the display device to measure the length of the endoscopic probe extending into the pipe.

The cable length measuring device includes a fixing housing 100, a rotating housing 200, and a control board 300, wherein the rotating housing 200 is rotatably connected to the fixing housing 100, and the rotating housing 200 is used to connect to the winding wheel and rotate around a rotation axis with the winding wheel.

Wherein, one of the fixing housing 100 and the rotating housing 200 is equipped with at least one signal transmitter 400, and the other of the fixing housing 100 and the rotating housing 200 is connected to the control board 300, which is equipped with at least one signal receiver 310. When the signal transmitter 400 passes through the signal receiver 310, the signal receiver 310 generates a counting signal, and the control board 300 receives the counting signal to calculate the length of the cable extension or retraction on the winding wheel.

The at least one signal transmitter 400 includes two signal transmitters 400 arranged at equal intervals along one of a circumference of the fixing housing 100 and a circumference of the rotating housing 200; the at least one signal receiver 310 includes at least two signal receivers 310, which are arranged at equal intervals along the other one of the circumference of the fixing housing 100 and the circumference of the rotating housing 200.

By setting up the above structure, when in use, the rotating housing 200 is coaxially connected to the winding wheel. When the cable on the winding wheel extends or retracts, the winding wheel drives the rotating housing 200 to rotate. When the signal transmitter 400 passes by or aligns with the signal receiver 310, the signal receiver 310 generates a counting signal. The control board 300 receives the counting signal and calculates the length of the cable extension or retraction based on the central angle between adjacent signal transmitters 400 or adjacent signal receivers 310, the diameter of the winding wheel, etc. By adding multiple signal transmitters 400 or signal receivers 310, the detection accuracy can be effectively improved, allowing users to intuitively understand the length of the cable that can be extended or retracted and judge the position of the endoscope probe based on this. The user experience is better; Preferably, multiple signal transmitters 400 or multiple signal receivers 310 are evenly distributed on the circumference, dividing the circumference into multiple parts with the same central angle for each part; preferably, ten signal transmitters 400 can be set up, with a central angle of 36 degrees between adjacent two signal transmitters 400.

In this embodiment, the signal transmitter 400 is a magnet, and the signal receiver 310 is a Hall sensor. With the above structure, when the rotating housing 200 rotates relative to the fixing housing 100, the magnet passes by or aligns with the Hall sensor. The Hall sensor detects the change in magnetic flux, generates a counting signal, and sends it to the control board 300. Each time the control board 300 receives a counting signal, it indicates that the rotating housing 200 has turned a preset angle relative to the fixing housing 100. The preset angle is the central angle between two adjacent magnets, allowing the length of cable extension to be calculated. Similarly, the signal transmitter 400 and signal receiver 310 can also be infrared sensors, photoelectric sensors, or trigger counting sensors. However, magnets and Hall sensors are cost-effective and highly stable.

In this embodiment, at least two magnet accommodating slots 101 are provided on the side of the fixing housing 100 facing the rotating housing 200, with magnets inserted into these slots 101. By arranging multiple magnet accommodating slots 101 at equal intervals around the circumference of the rotating housing 200, the structure effectively positions and accommodates the magnets 400. This not only ensures product stability but also fixes the central angle between adjacent magnets, facilitating the calculation of the rotating housing 200's rotation angle and, consequently, calculating the length of cable extension or retraction.

In this embodiment, the rotating housing 200 is provided with a control board accommodating slot 201 and a first limiting column 210. The first limiting column 210 extends upward from a bottom wall of the control board accommodating slot 201. The control board 300 is inserted into the control board accommodating slot 201, and a positioning hole 301 is formed in the control board 300. The first limiting column 210 is inserted into the positioning hole 301. With the above structure, the control board 300 is mounted within the control board accommodating slot 201, effectively protecting the control board 300 from damage. Meanwhile, the first limiting column 210 inserted into the positioning hole 301 prevents the control board 300 from moving radially or circumferentially within the control board accommodating slot 201, further ensuring product stability. Additionally, since the signal receiver 310 is mounted on the control board 300, the stability of the control board 300 also ensures the positional accuracy of the signal receiver 310, preventing positional deviations that could affect measurement results.

In this embodiment, the rotating housing 200 is further provided with a second limiting column 220, which extends upward from the bottom wall of the control board accommodating slot 201, and is in contact with the surface of the control board 300. By setting the above structure, the second limiting column 220 can be pressed against the surface of the control board 300 to restrict the axial movement of the control board 300, further ensuring the stability of the product; at the same time, a connection space is formed between the surface of the control board 300 and the bottom wall of the control board accommodating slot 201, this connection space allows cables to be connected to the control board 300, facilitating the transmission of signals and data. The product structure distribution is more reasonable.

In this embodiment, a key component 500 is also included, which includes a key control board 510 and a key 520. The key control board 510 is disposed inside the fixing housing 100 and electrically connected to the control board 300, while the key 520 is disposed on the side of the fixing housing 100 away from the rotating housing 200. By setting the above structure, users can directly press the button 520 located on the fixing housing 100 to operate the product, such as changing the length measurement unit to metric or imperial measurement units, improving the applicability of the product; or reset the data and recalculate the cable length, making it more convenient for users to use.

In this embodiment, a bearing component 600 is also included, and the fixing housing 100 is provided with a bearing receiving groove 102. The bearing component 600 is inserted into the bearing receiving groove 102 and connected to the fixing housing 100 and the rotating housing 200. By setting the above structure, the bearing component 600 is placed in the bearing receiving groove 102, which can effectively protect the bearing component 600 and extend the service life of the product. The bearing component 600 is connected to the fixing housing 100 and the rotating housing 200 respectively, which can reduce the frictional force between the rotating housing 200 and the fixing housing 100 when they rotate relative to each other, making the rotation of the rotating housing 200 smoother and more stable.

In this embodiment, the fixing housing 100 is equipped with a bearing fixing column 110, which is inserted into a bearing hole 611 on an inner ring 610 of the bearing component 600. By setting the above structure, the bearing fixing column 110 is inserted into the bearing hole 611 with interference fit, which can tightly connect the inner ring 610 of the bearing component 600 to the bearing fixing column 110, and then to the fixing housing 100, the assembly is convenient and the connection is stable.

In this embodiment, a first connecting piece is also included. The first limiting column 210 is provided with a first through hole 211 that penetrates the rotating housing 200. An outer ring 620 of the bearing component 600 is provided with a first connecting hole 621, and the end of the first connecting piece is connected to the first connecting hole 621 through the first through hole 211. By setting up the above structure, when in use, the end of the first connecting piece is passed through the first through hole 211 and connected to the first connecting hole 621, which can securely connect the rotating housing 200 and the outer ring 620 of the bearing assembly 600. The connection is stable, and usually the first connecting piece is a screw.

In this embodiment, a rotary transmission component 700 is also included, which is arranged in the fixing housing 100 along a rotation axis direction thereof. The rotary transmission component 700 is electrically connected to the control board 300 and the button control board 510. By setting up the above structure, when in use, one end of the rotary transmission component 700 is electrically connected to the control board 300, and the other end is electrically connected to the button control board 510, so as to maintain a stable electrical connection between the control board 300 and the button control board 510 when the rotating housing 200 rotates relative to the fixing housing 100, thereby achieving stable transmission of signals and data. The rotary transmission component 700 is also a rotating electrical connector.

In this embodiment, a first receiving groove 111 is provided at the center of the bearing fixing column 110, and the rotary transmission component 700 is inserted into the first receiving groove 111 and connected to the bearing fixing column 110. By setting the above structure, the rotary transmission component 700 is inserted into the first receiving groove 111, which can effectively protect the rotary transmission component 700, ensure the stability of the product, and stably connect the rotary transmission component 700 to the bearing fixing column 110.

In this embodiment, the bearing fixing column 110 is further provided with an opening 112 in communication with the first receiving groove 111, and the fixing housing 100 is further provided with an output terminal 120 on the side away from the rotating housing 200. The output terminal 120 is used to electrically connect to the display device. The first data line group 710 of the rotary transmission component 700 is electrically connected to the button control board 510 and the output terminal 120 through the opening 112, and the second data line group 720 of the rotary transmission component 700 is electrically connected to the control board 300. By setting the above structure, the opening 112 can allow the first data cable group 710 to pass through, to electrically connect the button control board 510 and output terminal 120 with the rotary transmission component 700, and to electrically connect the control board 300 with the rotary transmission component 700 through the second data cable group 720, achieving electrical connection of the entire circuit system. The product structure is reasonable, and signal and data transmission are stable; When in use, the control board 300 transmits the counting signal generated by the signal receiver 310 and the video data transmitted by the endoscope probe through the rotary transmission component 700 to the output terminal 120, and finally displays it through the display device.

In this embodiment, there is also a limiting cover 730 and a second connecting piece. The limiting cover 730 is provided with a second through hole 731, and the bearing fixing column 110 is provided with a second connecting hole 113. The end of the second connecting piece passes through the second through hole 731 and is connected to the second connecting hole 113 to limit the rotary transmission component 700 in the first receiving groove 111. By setting the above structure, when in use, the second connecting piece can be passed through the second through hole 731 and connected to the second connecting hole 113 to achieve the connection between the limiting cover 730 and the bearing fixing column 110. The limiting cover 730 limits the rotary transmission component 700 in the first receiving groove 111, ensuring the stability of the product.

In this embodiment, the rotary transmission component 700 includes a connecting part 740 and a rotating part 750. The rotating part 750 is rotatably connected to the connecting part 740 and maintains electrical connection. The connecting part 740 is provided with a third through hole 741, and the end of the second connecting piece passes through the third through hole 741. The connecting part 740 is electrically connected to the first data line group 710, and the rotating part 750 is electrically connected to the second data line group 720. By setting the above structure, when in use, the rotating housing 200 rotates relative to the fixing housing 100, the second data line group 720 is electrically connected to the control board 300, which is connected to the rotating housing 200, i.e., the control board 300, the second data line group 720, and the rotating part 750 rotate with the rotating housing 200. The connecting part 740 is set on the fixing housing 100, and the first data line group 710 is electrically connected to the connecting part 740, the output terminal 120, and the button control board 510, achieving data transmission.

In this embodiment, the limiting cover 730 is provided with a limiting groove 732 facing one side of the rotary transmission component 700, and the end of the rotary transmission component 700 is inserted into the limit groove 732. By setting the above structure, during use, the limiting cover 730 is connected to the bearing fixing column 110 through the second connecting piece, and the end of the rotary transmission component 700 is inserted into the limiting groove 732, effectively limiting the rotary transmission component 700 and improving the stability of the product.

In this embodiment, the control board 300 is provided with a fourth through hole 302, and the middle of the limiting cover 730 is provided with a sixth through hole 733. The second data line group 720 passes through the fourth through hole 302 and the sixth through hole 733. By setting the above structure, the second data line group 720 passes through the fourth through hole 302 and the sixth through hole 733, and is electrically connected to the surface of the control board 300. The product wiring is simple and the layout is reasonable.

In this embodiment, there is also a connecting wire 800, wherein a first end of the connecting wire 800 passes through the rotating housing 200 and is electrically connected to the control board 300, and the second end of the connecting wire 800 is used to electrically connect to the cable on the winding wheel. By setting the above structure, the first end of the connecting wire 800 is electrically connected to the control board 300, and the other end of the connecting wire 800 is electrically connected to the cable on the winding wheel. Through the cable and the connecting wire 800, the endoscope probe transmits video data to the control board 300, the control board 300 calculates the cable extension length data based on the counting signal generated by the signal receiver 310, and transmits the video data and cable extension length data to the output terminal 120 through the rotary transmission component 700. The output terminal 120 is electrically connected to the display device, which displays the video and cable extension length data.

In this embodiment, the control board accommodating slot 201 of the rotating housing 200 is provided with a connecting wire accommodating slot 203, and the connecting wire 800 is set in the connecting wire accommodating slot 203. By setting the above structure, when in use, place the connecting wire 800 in the connecting wire accommodating slot 203 and use a fixing device to fix the connecting wire 800, which can effectively improve the stability of the product and prevent the connecting wire 800 from shifting. The fixing device is usually a cable tie.

In this embodiment, a third connecting piece is also included. The control board 300 is provided with a fifth through hole 303, and the second limiting column 220 is provided with a third connecting hole 221, the end of the third connecting piece passes through the fifth through hole 303 and is connected to the third connecting hole 221. By setting the above structure, when in use, the end of the third connecting piece passes through the fifth through hole 303 and is connected to the third connecting hole 221, which can fix the control board 300 on the second limiting column 220, hinder the axial movement of the control board 300, and improve the stability of the product. Generally, the third connecting piece is a screw.

In this embodiment, there is also a central hole 202 in communication with the control board accommodating slot 201 at the center of the rotating housing 200, and the central hole 202 is located on the rotation axis. By setting the above structure, the cable length measuring device can be coaxially connected to the winding wheel through the central hole 202, so that the cable length measuring device rotates coaxially with the winding wheel. By setting the above structure, the central hole 202 is located on the axis of rotation, through the central hole 202, it is convenient for users to connect the product coaxially with the winding wheel, ensuring correct installation and facilitating user use.

In this embodiment, one of the fixing housing 100 and the rotating housing 200 is provided with a sliding groove 103, and the other of the fixing housing 100 and the rotating housing 200 is provided with a slider 212, which is slidably inserted into the sliding groove 103. By setting the above structure, the slider 212 is inserted into the sliding groove 103. When the rotating housing 200 rotates relative to the fixing housing 100, the slider 212 slides in the sliding groove 103 to connect the fixing housing 100 and the rotating housing 200 more stably, and the relative rotation between the two is smoother.

It can be understood that the fixing housing 100 and the rotating housing 200 can jointly serve as a housing assembly of the cable length measuring device of the pipeline endoscope system; in other embodiments, the rotating housing 200 can also be omitted.

### Second Embodiment

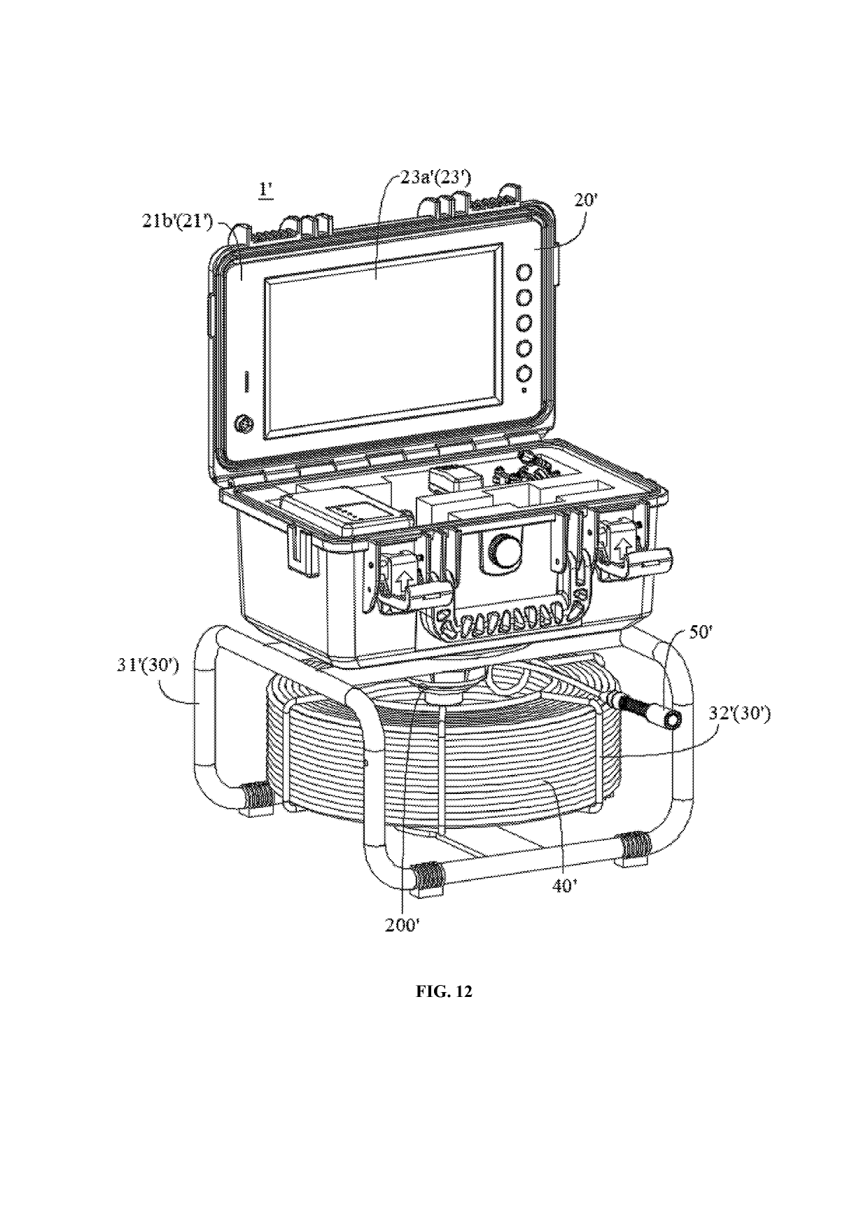

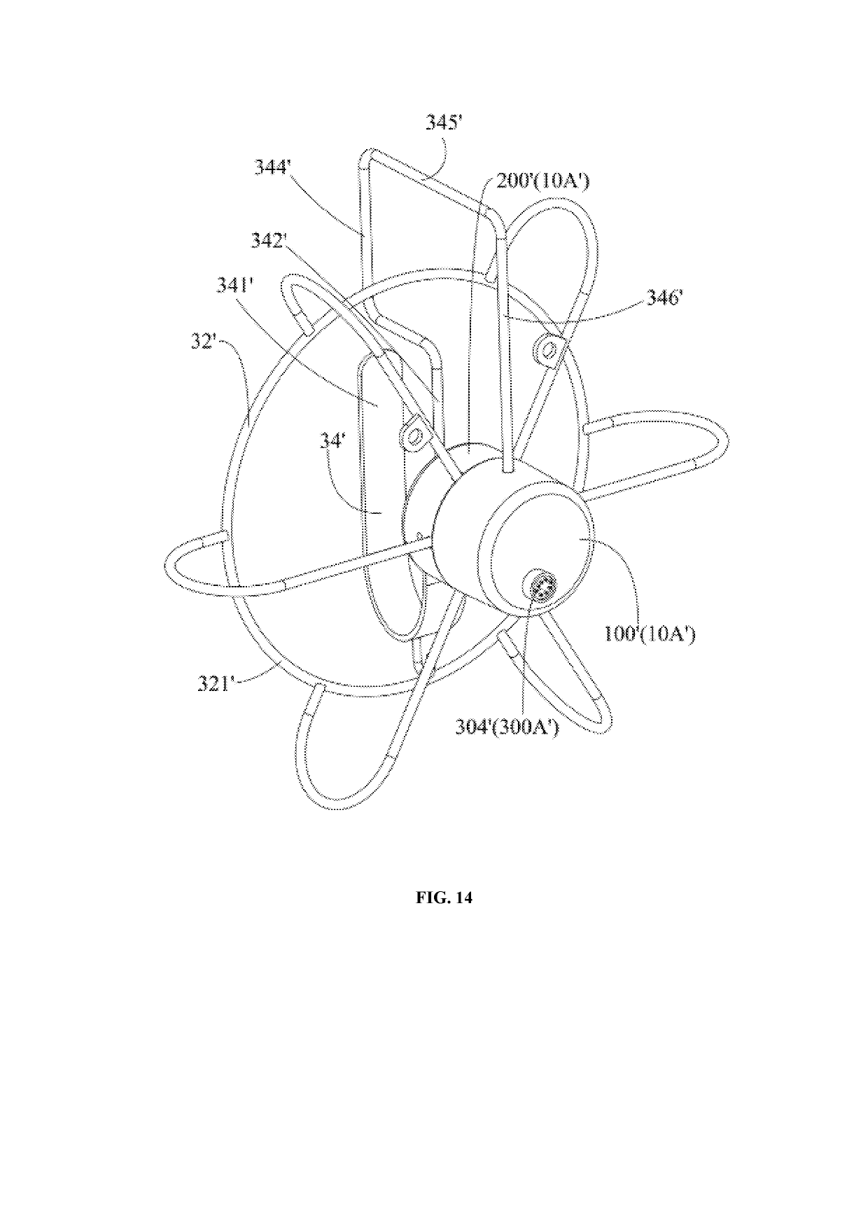

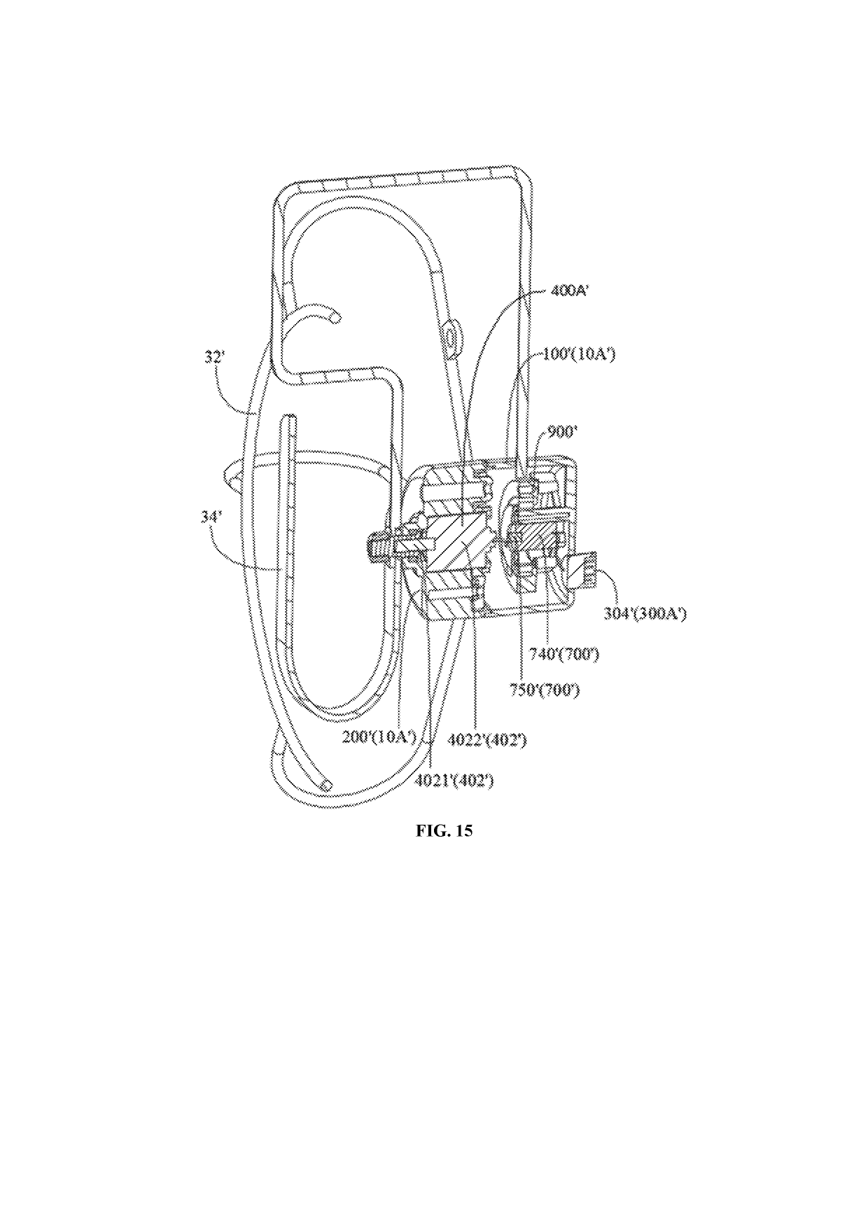

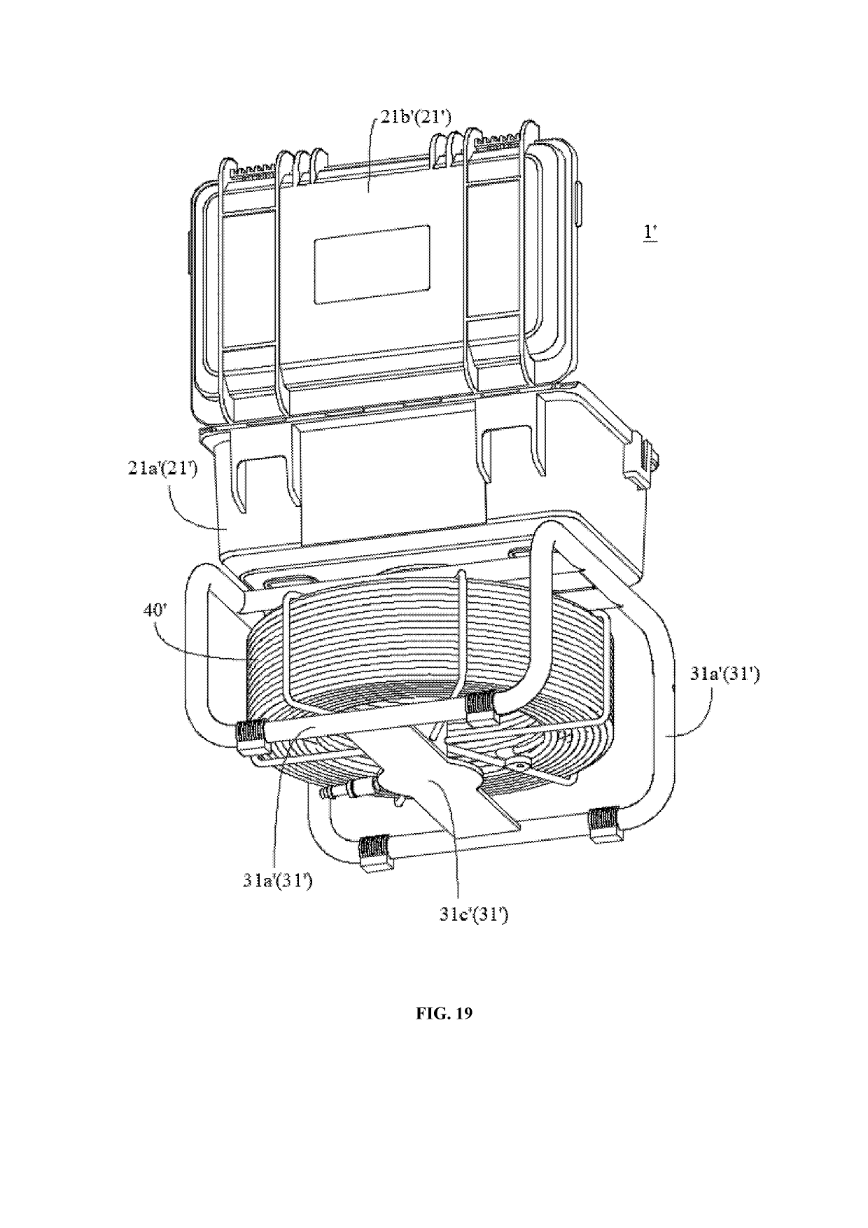

Referring to FIGS. 12 to 20, the second embodiment of the present application provides a pipeline endoscope system 1', which includes an endoscope probe 50', a cable 40', a cable support device 30', and a measurement display module.

The endoscope probe 50' is used to capture images to detect the internal conditions of pipelines. The cable 40' is used to electrically connect the endoscope probe 50'.

The cable support device 30' includes a winding wheel 32' for winding the cable 40'.

Specially, the measurement display module includes a cable length measuring device 10', which includes a control module 300A', and a detection module 400A'. It can be understood that in some embodiments, the cable length measuring device 10' can use the cable length measuring device in the first embodiment of the present application.

At least part of the detection module 400A' is connected to the winding wheel 32' or cable 40' and rotates synchronously with the winding wheel 32' or cable 40'.

The detection module 400A' is electrically connected to the control module 300A'.

The control module 300A' is electrically connected to cable 40' to receive images captured by endoscope probe 50.

As shown in FIG. 12, the measurement display module also includes a display device 20', which communicates with the control module 300A' to receive and display images captured by the endoscope probe 50'. The specific structure of the display device 20' will be introduced in the following text.

When the winding wheel 32' rotates, the detection module 400A' generates a sensing signal, and the control module 300A' receives the sensing signal and calculates the length of the cable 40' extending or retracting on the winding wheel 32' based on the sensing signal.

It should be noted that the sensing signal generated by the detection module 400A' in the second embodiment of the present application is used to calculate the length of the cable 40' extending or retracting on the winding wheel 32', and the counting signal generated by the signal receiver 310 in first embodiment of the present application is also used to calculate the length of the cable extending or retracting on the winding wheel. Therefore, the "sensing signal" in the second embodiment of the present application can be used as the "counting signal" in the first embodiment of the present application.

Based on the pipeline endoscopic system 1' in the present embodiment, a cable length measuring device 10' is designed. The cable length measuring device 10' includes a control module 300A', and a detection module 400A'. When the cable 40' on the winding wheel 32' extends or retracts, the winding wheel 32' rotates. At this time, during the rotation of the rotating housing 200' relative to the fixing housing 100', the detection module 400A' generates a sensing signal, and the detection module 400A' sends the sensing signal to the electrically connected control module 300A'. The control module 300A', based on the sensing signal and combined with a diameter of the central axle 32a' to calculate the length of the cable 40' extension or retraction, so that the length of the cable 40' extension or retraction can be effectively calculated, making it easier for users to know the position of the endoscope probe 50' in the pipeline and achieving good results. By designing a cable support device 30', the cable support device 30' includes a winding wheel 32'. The winding wheel 32' is used to wrap the cable 40', so that the cable 40' can be neatly wrapped on the central axle 32a' of the winding wheel 32'. By designing a display device 20', the display device 20' is used to display the images captured by the endoscope probe 50', so that users can observe the internal situation of the pipeline through the display device 20'.

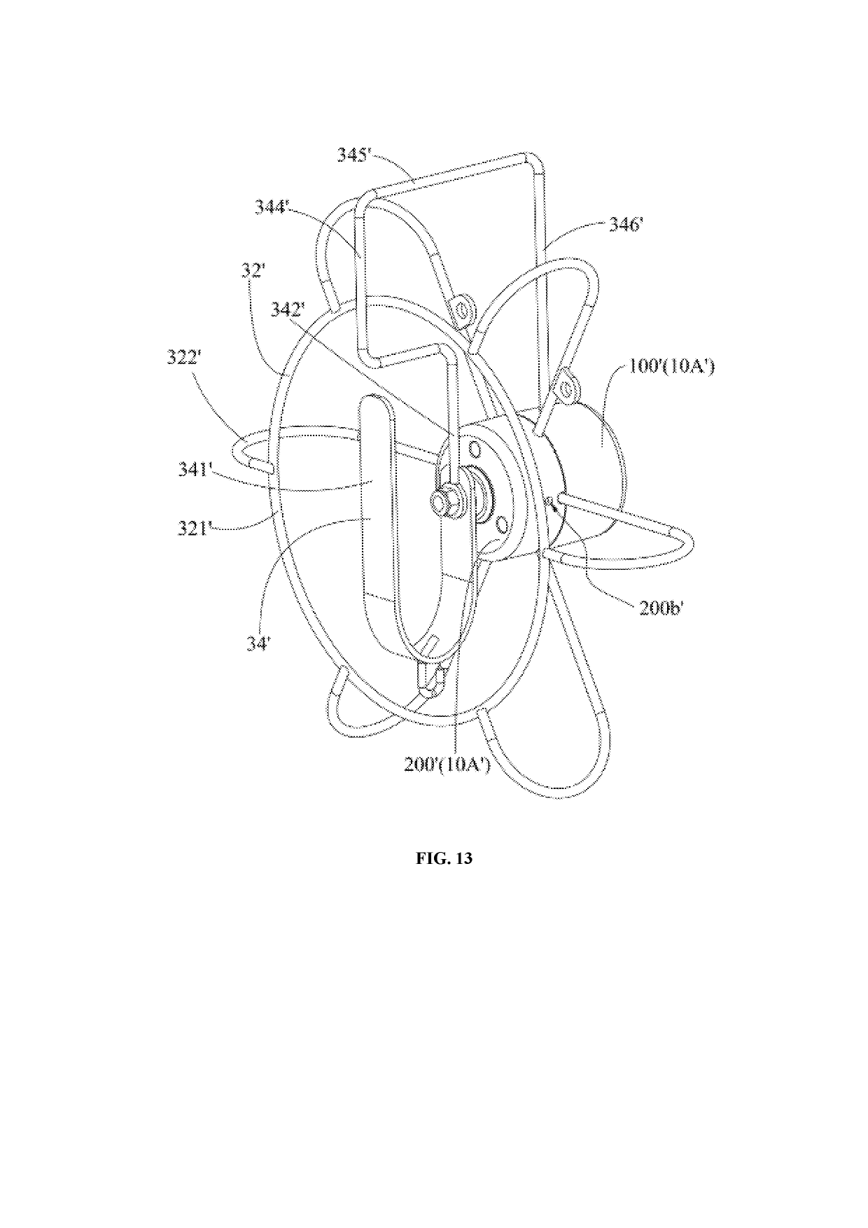

Referring to FIGS. 13 to 15, these figures illustrate a detection module 400A' in a modified embodiment of present disclosure, which includes an encoder 402', and a support bracket 34' which is different from the support base 31' of FIG. 12 to serve as the cable support device 30'.

The cable length measurement device 10' further comprises a housing assembly 10A', which consists of a fixing housing 100' and a rotating housing 200'. The fixing housing 100' is fixedly connected to a support bracket 34', while the rotating housing 200' can rotate relative to the fixing housing 100'. The winding wheel 32' is fixedly connected to the rotating housing 200'. Thus, when the winding wheel 32' rotates relative to the support bracket 34', it drives the rotating housing 200' fixedly connected to it to rotate relative to the fixing housing 100'.

Among them, the support bracket 34' is used to provide support for the fixing housing 100'. The specific fixed connection method between the fixing housing 100' and the support bracket 34' is not limited here, and designers can make reasonable designs based on actual needs. For example, the fixing housing 100' can be detachably fixed to the support bracket 34' through at least one of methods such as screwing, snapping, or plugging; alternatively, the fixing housing 100' can also be non-detachably fixed to the support bracket 34' through methods such as welding, gluing, or riveting. The rotating housing 200' is used to provide support for the winding wheel 32'. The specific fixed connection method between the winding wheel 32' and the rotating housing 200' is not limited here, and designers can make reasonable designs based on actual needs. For example, the winding wheel 32' can be detachably fixed to the rotating housing 200' through at least one of methods such as screwing, snapping, or plugging; alternatively, the winding wheel 32' can also be non-detachably fixed to the rotating housing 200' through methods such as welding, gluing, or riveting.

The detection module 400A' includes an encoder 402' electrically connected to the control module 300A'. The rotating end 4021' of the encoder 402' is fixedly connected to the support bracket 34', and the fixing end 4022' of the encoder 402' is fixedly connected to the rotating housing 200'. It can be understood that relative rotation can occur between the rotating end 4021' of the encoder 402' and the fixing end 4022' of the encoder 402'. Based on the fixed connection between the rotating end 4021' of the encoder 402' and the support bracket 34', and the fixing end 4022' of the encoder 402' and the rotating housing 200', when the winding wheel 32' rotates relative to the support bracket 34', the rotating end 4021' of the encoder 402' is stationary relative to the support bracket 34', while the fixing end 4022' of the encoder 402' rotates relative to the rotating end 4021' of the encoder 402' along with the rotating housing 200'. During the rotation of the fixing end 4022' of the encoder 402' relative to the rotating end 4021' of the encoder 402', the above sensing signal will occur.

The cable length measuring device 10' also includes a rotary transmission component 700', which includes a connecting part 740' and a rotating part 750'. The connecting part 740' is fixedly connected to the fixing housing 100', and the rotating part 750' is rotatably connected to the connecting part 740' and maintains electrical connection with the connecting part 740'.

Among them, the cable length measuring device 10' also includes a first bearing 900', the inner ring of the first bearing 900' is fixedly connected to the fixing housing 100', and the outer ring of the first bearing 900' is fixedly connected to the rotating housing 200' by locking screws. Therefore, when the rotating housing 200' rotates relative to the fixing housing 100', the rotating housing 200' will drive the outer ring of the first bearing 900' fixedly connected to it to rotate relative to the inner ring of the first bearing 900'.

The fixing end 4022' of the encoder 402' is electrically connected to the rotating part 750', and the connecting part 740' is electrically connected to the control module 300A'. The fixing end 4022' of the encoder 402' rotates relative to the rotating end 4021' of the encoder 402' to generate the above-mentioned sensing signal. The encoder 402' transmits the sensing signal to the electrically connected rotary transmission component 700', which then transmits the sensing signal to the electrically connected control module 300A'. The control module 300A' calculates the length of the cable 40' extending or retracting on the winding wheel 32' based on the sensing signal.

Among them, the control module 300' incudes an aviation connector 304', which is installed on the fixing housing 100' and electrically connected to the connecting part 740’. The rotating housing 200' is provided with a wire hole 200c', and the cable 40' extends through the wire hole 200c' and electrically connected to the rotating part 750'. Specifically, 8 wires are led out from the side where the rotating part 750' is located, 4 wires are led out from the side where the fixing end 4022' of the encoder 402' is located, and the 4 wires led out from the side where the fixing end 4022' of the encoder 402' is located are electrically connected to 4 of the 8 wires led out from the side where the rotating part 750' is located. Cable 40' is a 4-core wire that passes through a wire hole 200b' and is electrically connected to the remaining 4 wires out of the 8 wires on the side where the rotating part 750' is located. 8 wires are led out from the side where the connecting part 740' is located, and the aviation connector 304' is an 8-core aviation connector 304'. The 8 wires led out from the side where the connecting part 740’ is located are electrically connected to the 8-core aviation connector 304'.

The winding wheel 32' includes a circular support rod 321' and multiple J-shaped support rods 322'. The multiple J-shaped support rods 322' are arranged at intervals along the circumference of the circular support rod 321', and the heads of each J-shaped support rod 322' are fixedly connected to the circular support rod 321'. The tails of each J-shaped support rod 322' are fixedly connected to the rotating housing 200'. Among them, multiple J-shaped support rods 322' can be fixedly connected to the circular support rod 321' through welding, but not limited to. The specific connection method between the J-shaped support rod 322' and the rotating housing 200' is not limited here, and designers can make reasonable designs according to actual needs; for example, the J-shaped support rod 322' can be fixedly connected to the rotating housing 200' through at least one method such as screwing, clamping, or plugging. The cable 40' is located in the space enclosed by the circular support rod 321' and multiple J-shaped support rods 322', which allows the cable 40' to be arranged neatly.

The support bracket 34' includes a grip 341', a first support rod 342', a second support rod 343', a third support rod 344', a fourth support rod 345', and a fifth support rod 346'. The grip 341' is used for the user to grip, and the rotating end 4021' of the encoder 402' is fixedly connected to the grip 341'. One end of the first support rod 342' is fixedly connected to the grip 341', and the second support rod 343' is bent and connected to the end of the first support rod 342' away from the grip 341'. The third support rod 344' is bent and connected to the end of the second support rod 343' away from the first support rod 342', and the fourth support rod 345' is bent and connected to the third support rod 344' away from the second support rod. At one end of 343', the fifth support rod 346' is bent and connected to the end of the fourth support rod 345' away from the third support rod 344', and the other end of the fifth support rod 346' is fixedly connected to the fixed housing 100'. Among them, the first support rod 342', the second support rod 343', the third support rod 344', the fourth support rod 345', and the fifth support rod 346' are integrally formed. The design of the grip 341' facilitates carrying of the pipeline endoscope system 1'.

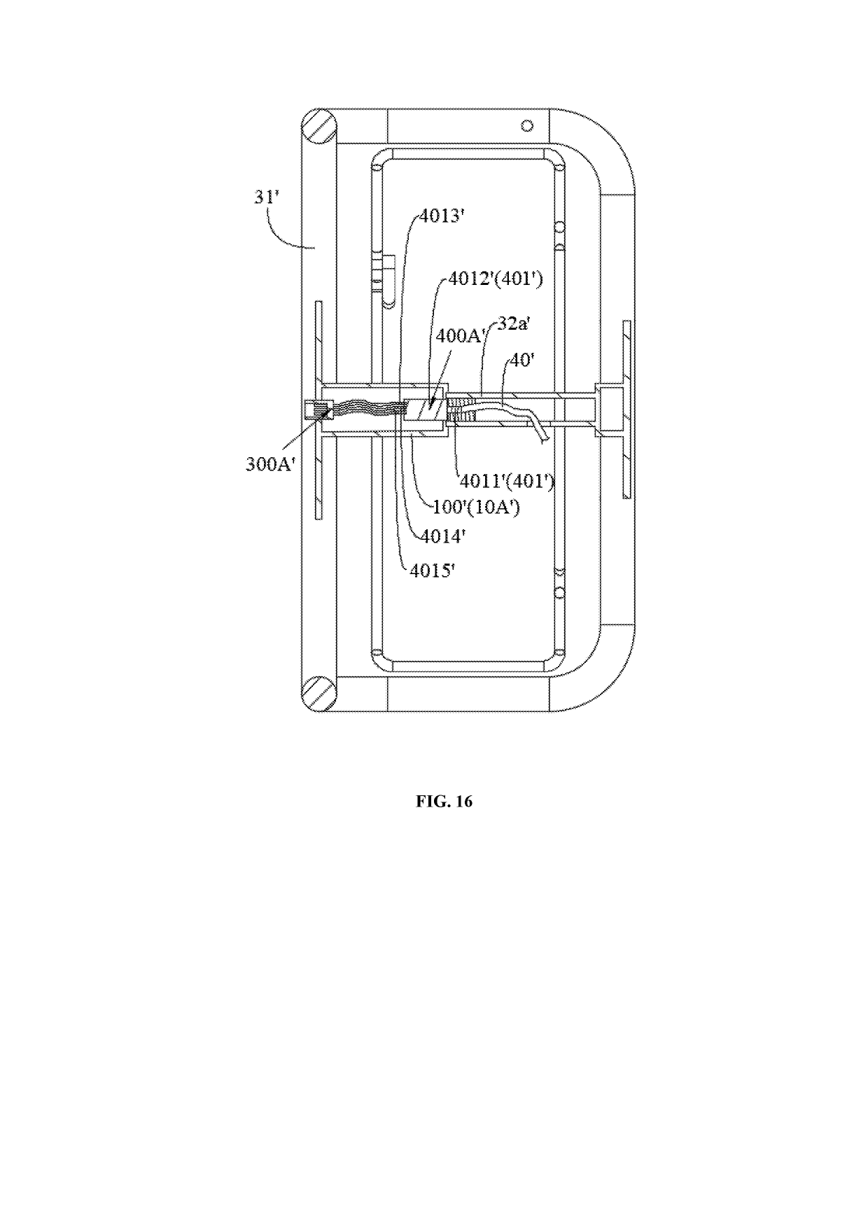

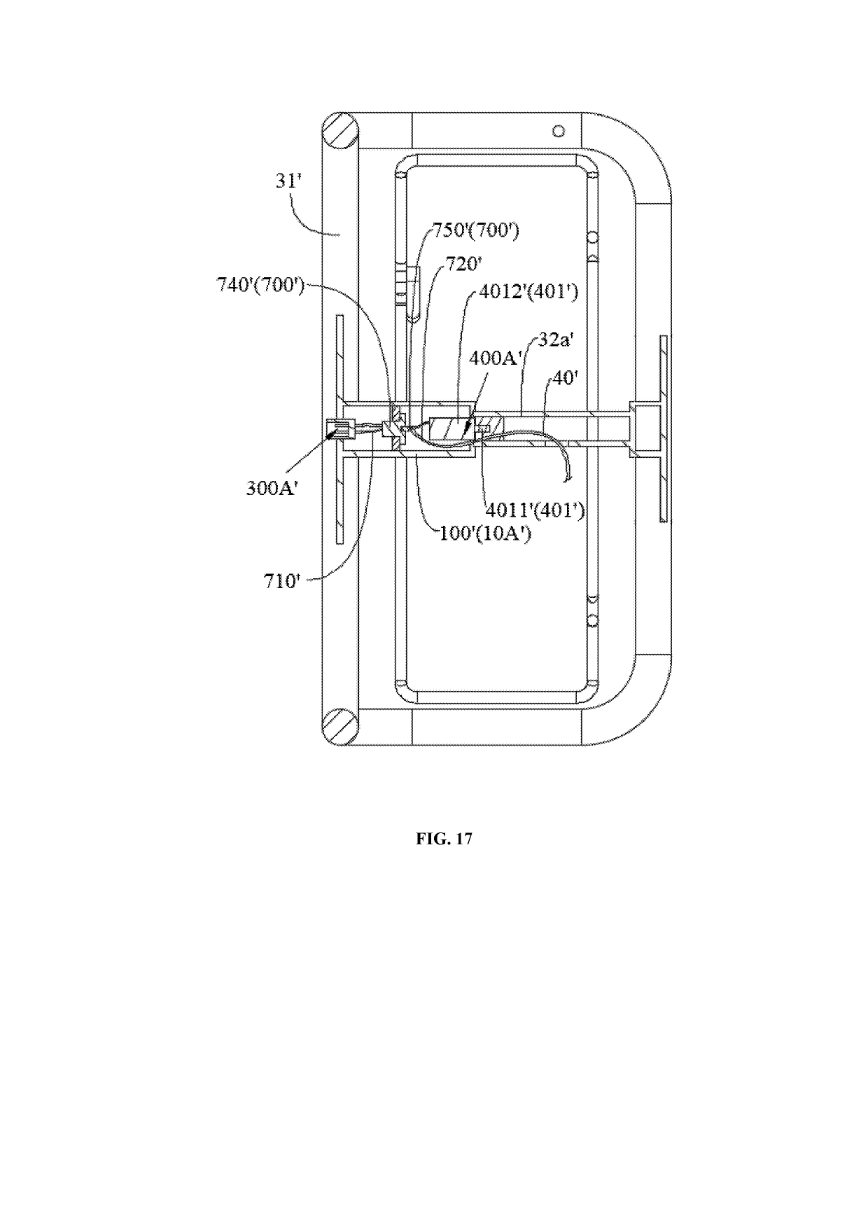

As shown in FIGS. 16-17, these figures illustrate another detection module 400A' in another modified embodiment of present disclosure, which also includes an encoder 401' .

The cable support device 30' includes a support base 31', the support base 31' is the same as the support base 31' of FIG. 12, and the support base 31' is rotatably connected to the winding wheel 32' to provide support for the winding wheel 32'. The support base 31' serves as the base for the winding wheel 32' to provide support for the winding wheel 32', so that the winding wheel 32' can be smoothly placed on an object waiting to be carried on the ground. The specific structure of the support base 31' is not limited here, and designers can make reasonable designs according to actual needs; for example, the support base 31' can be, but is not limited to, a hollow frame structure, and the support base 31' can also be, but is not limited to, a box structure. The specific rotational connection method between the central axis of the winding wheel 32' and the support base 31' is not limited here, and designers can make reasonable designs according to actual needs; for example, the central axis of the winding wheel 32' can be connected to the support base 31' through a second bearing, but not limited to.

The cable length measuring device 10' also includes a housing assembly 10A', which includes a fixing housing 100', the central axle 32a' of the winding wheel 32' is rotatably connected to the fixing housing 100', and the detection module 400A' is built into a cavity formed by the central axle 32a' of the winding wheel 32 and the fixing housing 100'.

The encoder 401' is electrically connected to the control module 300A'. A rotating end 4011' of the encoder 401' is fixedly connected to the central axle 32a' of the winding wheel 32', and a fixing end 4012' of the encoder 401' is set in the fixing housing 100'. When the winding wheel 32' rotates, the central axle 32a' of the winding wheel 32' rotates relative to the fixing housing 100', at this time, the rotating end 4011' of the encoder 401' fixedly connected to the central axle 32a' of the winding wheel 32, rotates relative to a fixing end 4011' of the encoder 401' fixedly connected to the fixing housing 100' to generate the above-mentioned sensing signal (i.e., the rotating end 4011' of the encoder 401' rotates relative to the fixing end 4012' of the encoder 401' to generate the above-mentioned sensing signal). The encoder 401' transmits the sensing signal to the electrically connected control module 300A', and the control module 300A' calculates the length of the cable 40' extending or retracting on the winding wheel 32' based on the sensing signal.

The control module 300A' internally stores calculation models corresponding to multiple different winding wheels 32', based on preset winding wheel size data or user provided winding wheel size data, the control module 300A' calculates the extension or retraction length of the cable 40' by combining the calculation model and sensing signals.

As shown in FIG. 16, the rotating end 4011' of the encoder 401' is electrically connected to the cable 40', and the image captured by the endoscope probe 50' is transmitted to the control module 300A' via the cable 40' and the encoder 401', at this time, the endoscope probe 50' is electrically connected to the cable 40', and the cable 40' is electrically connected to the rotating end 4011' of the encoder 401'. The rotating end 4011' of the encoder 401' is electrically connected to the fixing end 4012' of the encoder 401', and the fixing end 4012' of the encoder 401' is electrically connected to the control module 300A'. The control module 300A' communicates with the display device 20', so that the image captured by the endoscope probe 50' can be effectively transmitted to the display device 20', allowing users to clearly observe the internal situation of the pipeline by directly observing the display device 20'.

The control module 300A' supplies power to the endoscope probe 50' through the encoder 401' and the cable 40', at this time, the control module 300A' is electrically connected to the fixing end 4012' of the encoder 401', the fixing end 4012' of the encoder 401' is electrically connected to the rotating end 4011' of the encoder 401', the rotating end 4011' of the encoder 401' is electrically connected to the cable 40', and the cable 40' is electrically connected to the endoscope probe 50', forming a power supply path to provide the required electrical energy for the operation of the endoscope probe 50'.

Specifically, the encoder 401' includes an image signal transmission terminal 4013' for transmitting images captured by the endoscope probe 50', a power signal transmission terminal 4014' for transmitting power supply signals, and a sensing signal transmission terminal 4015' for transmitting the aforementioned sensing signals.

As shown in FIG. 17, the cable length measuring device 10' also includes a rotary transmission component 700', which is set on the fixing housing 100' along the rotation axis direction. The rotary transmission component 700' is electrically connected to the control module 300A' and the cable 40', thereby achieving electrical connection between the control module 300A' and the cable 40'. When the central axle 32a' of the winding wheel 32' rotates relative to the fixing housing 100', the rotation transmission component 700' is used to maintain electrical conductivity between the control module 300A' and the cable 40'. By setting up this structure, when in use, one end of the rotary transmission component 700' is electrically connected to the control module 300A' (specifically the control board 300' described below), and the other end is electrically connected to the cable 40', so as to maintain a stable electrical connection between the control module 300A' and the cable 40' when the central axis of the winding wheel 32' rotates relative to the fixing housing 100', in order to achieve stable signal and data propagation. Generally, the rotary transmission component 700' is an electric slip ring, four of the eight wires on a rotating side of the electric slip ring are connected to the cable 40', the remaining four wires on the rotating side of the electric slip ring are connected to the encoder 401', and the eight wires on a connecting side of the electric slip ring are connected to the aviation connector of the control module 300A'. The aviation connector is an 8-core connector.

The rotary transmission component 700' includes a connecting part 740' and a rotating part 750', the connecting part 740' is set on the fixing housing 100', and the rotating part 750' is rotatably connected to the connecting part 740' and electrically connected to the connecting part 740'. The fixing end 4012' of the encoder 401' is electrically connected to the rotating part 750', the cable 40' is electrically connected to the rotating part 750', and the connecting part 740' is electrically connected to the control module 300A'. Specifically, the connecting part 740' is electrically connected to the first data line group 710', the rotating part 750' is electrically connected to the second data line group 720', the connecting part 740' is connected to the control module 300A' via the first data line group 710', and the rotating part 750' is electrically connected to the cable 40' via the second data line group 720'. In this design, when in use, the central axis of the winding wheel 32' rotates relative to the fixed housing 100', and the second data cable group 720' is electrically connected to the cable 40'. The second data cable group 720' and the rotating part 750' rotate with the central axis of the winding wheel 32', and the cable 40' does not knot or entangle, achieving data transmission. It should be noted that the first data cable group 710' includes 8 wires. The 8 wires in the first data cable group 710' are electrically connected to the 8-core aviation connector in the control module 300A'. The cable 40' is a 4-core wire. The second data cable group 720' includes 8 wires. Among the 8 wires in the second data cable group 720', 4 wires are electrically connected to the fixing end 4012' of the encoder 401'. The remaining 4 wires in the 8 wires in the second data cable group 720' are electrically connected to the 4 wires in the cable 40'.

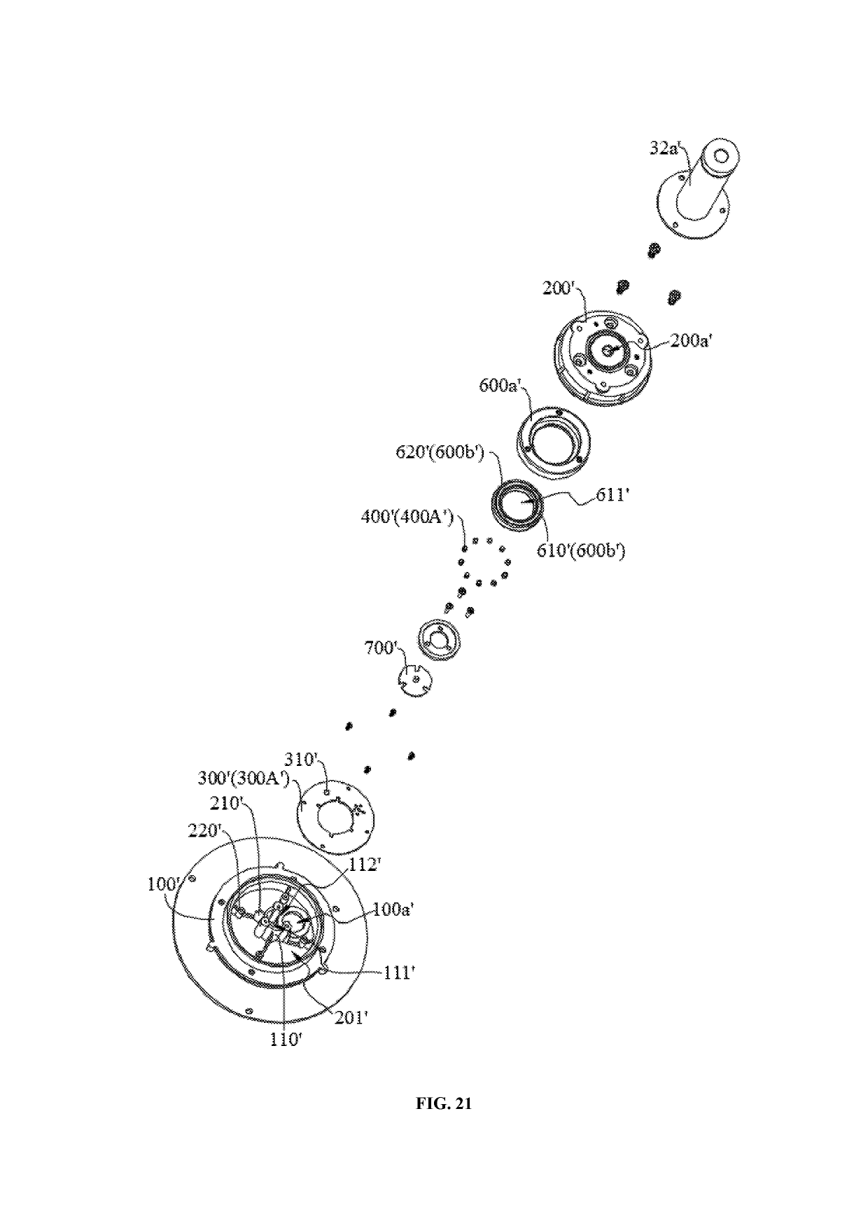

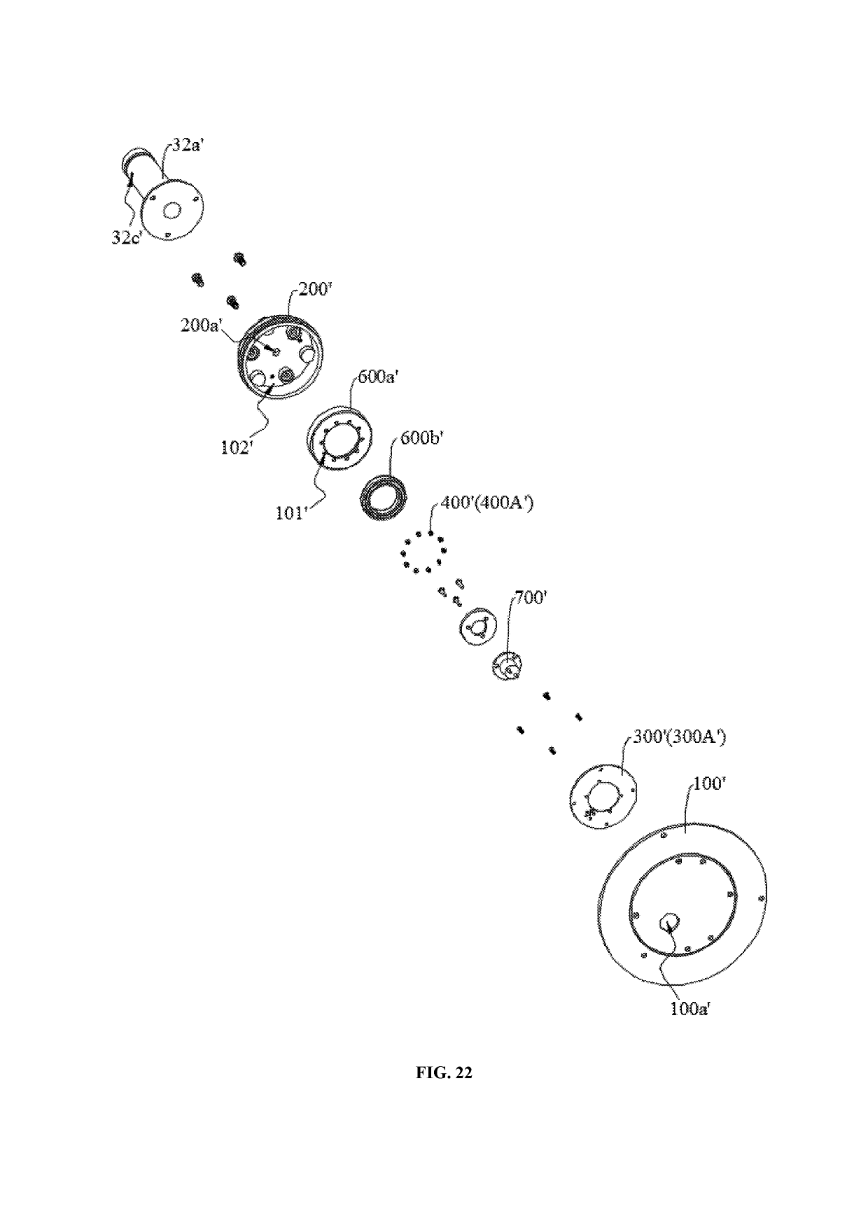

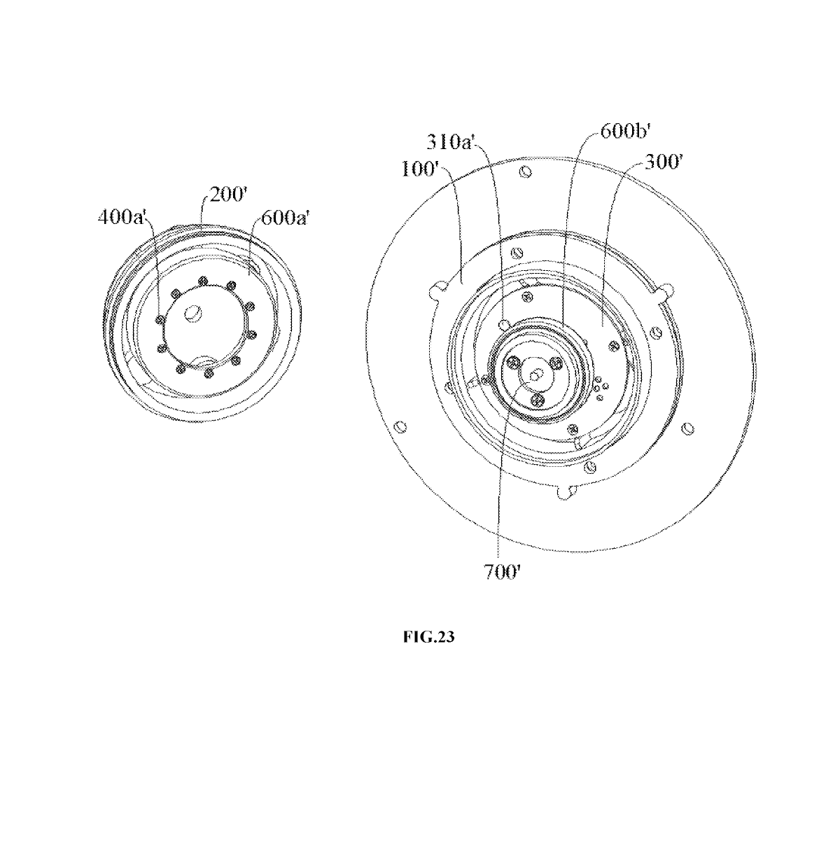

As shown in FIGS. 12 and 18-25, FIGS. 15-22 illustrate the structural schematic view of the detection module 400A' in a modified second embodiment of the present application, which includes a first detection component 400' and a second detection component 310'.

The cable support device 30' also includes a support base 31', which is rotatably connected to the winding wheel 32' to provide support for the winding wheel 32'. The support base 31' serves as the base for the winding wheel 32' to provide support for the winding wheel 32', so that the winding wheel 32' can be smoothly placed on an object waiting to be carried on the ground. The specific structure of the support base 31' is not limited here, and designers can make reasonable designs according to actual needs; for example, the support base 31' can be, but is not limited to, a hollow frame structure, and the support base 31' can also be, but is not limited to, a box structure. The specific rotational connection method between the central axis of the winding wheel 32' and the support base 31' is not limited here, and designers can make reasonable designs according to actual needs; For example, the central axis of the winding wheel 32' can be connected to the support base 31' through a second bearing, but not limited to.

The cable length measuring device 10' also includes a housing assembly 10A', which includes a fixing housing 100' and a rotating housing 200'. The fixing housing 100' is connected to a central axle 32a' of the winding wheel 32' through the rotating housing 200', and the detection module 400A' is built into the cavity formed by the fixing housing 100' and the rotating housing 200'.

The fixing housing 100' is fixedly connected to the support base 31'. The specific fixing connection method between the fixing housing 100' and the support base 31' is not limited here, and designers can make reasonable designs according to actual needs; for example, the fixing housing 100' can be, but is not limited to, detachably fixed to the support base 31' through at least one of screw connection, card connection, or plug connection; for example, the fixing housing 100' can also, but is not limited to, be fixedly connected to the support base 31' in a non detachable manner through riveting, bonding, or welding.

The rotating housing 200' is fixedly connected to the central axis of the winding wheel 32', and the specific fixing connection method between the rotating housing 200' and the central axle 32a' of the winding wheel 32' is not limited here. Designers can make reasonable designs according to actual needs; for example, the rotating housing 200' can be, but is not limited to, fixedly connected to the central axle 32a' of the winding wheel 32' via at least one of screw connection, card connection, or plug-in connection; for another example, the rotating housing 200' can also, but is not limited to, be fixedly connected to the central axle 32a' of the winding wheel 32' via riveting, bonding, or welding in a non removable manner.

The rotating housing 200' is rotatably connected to the fixing housing 100'. Specifically, the cable length measuring device 10' also includes a bearing component 600', and the rotating housing 200' is provided with a bearing receiving groove 102'. The bearing component 600' is inserted into the bearing receiving groove 102' and connected between the fixing housing 100' and the rotating housing 200'. By setting the above structure, the bearing component 600' is placed in the bearing receiving groove 102', which can effectively protect the bearing component 600' and extend the service life of the product; and the bearing component 600' is connected to the fixing housing 100' and the rotating housing 200' respectively, which can reduce the frictional force when the rotating housing 200' rotates relative to the fixing housing 100', making the rotating housing 200' rotate more smoothly and stably.

At least part of the detection module 400A' is located on the side where the rotating housing 200' is located, and the detection module 400A' is electrically connected to the control module 300A'.

When the rotating housing 200' rotates relative to the fixing housing 100', the detection module 400A' generates a sensing signal, and the control module 300A' calculates the length of the cable 40' extending or retracting on the winding wheel 32' based on the sensing signal. When the cable 40' on the winding wheel 32' extends or retracts, the winding wheel 32' drives the rotating housing 200' fixedly connected to it to rotate relative to the fixing housing 100', at this time, during the rotation of the rotating housing 200' relative to the fixing housing 100', the detection module 400A' generates a sensing signal, the detection module 400A' sends the sensing signal to the control module 300A' that is electrically connected to the detection module 400A'. The control module 300A' calculates the length of the cable 40' extension or retraction based on the sensing signal and a diameter of the central axle 32a' of the winding wheel 32', so as to effectively measure the length of the cable 40' extension or retraction, which is convenient for users to know the position of the endoscope probe 50' in the pipeline, resulting good using effect of the entire product.

Specifically, the control module 300A' includes a control board 300', which is mounted in the fixing housing 100' and electrically connected to a cable 40'. The specific connection method between the control board 300' and the fixing housing 100' is not limited here, and designers can make reasonable designs according to actual needs; for example, the control board 300' can be, but is not limited to, detachably connected to the fixing housing 100' through at least one of screw connection, card connection, or plug-in connection; for another example, the control board 300' can also be non removable connected to the fixing housing 100' through riveting or adhesive bonding, but not limited to.

The detection module 400A' includes a first detection component 400' and a second detection component 310'. The first detection component 400' is located on the side where the rotating housing 200' is located. The second detection component 310' is located on the control board 300' and is electrically connected to the control board 300'. When the rotating housing 200' rotates relative to the fixing housing 100', the second detection component 310' cooperates with the first detection component 400' to generate a sensing signal. The control board 300' calculates the length of the cable 40' extending or retracting on the winding wheel 32' based on the sensing signal. Specifically, the first detection component 400' is set on the bearing component 600' mentioned above.

It should be noted that the first detection component 400' is a component used to cooperate with the second detection component 310' during the rotation of the rotating housing 200' relative to the fixing housing 100' to generate a counting signal for the second detection component 310'. The second detection component 310' is a component used to cooperate with the first detection component 400' during the rotation of the rotating housing 200' relative to the fixing housing 100' to generate the aforementioned counting signal. When the signal transmitter 400 in the first embodiment passes through or aligns with the signal receiver 310, the signal receiver 310 detects the signal transmitter 400 and generates a counting signal. The signal receiver 310 sends the counting signal to the control board 300' electrically connected to it. The control board 300' calculates the length of the cable 40' extending or retracting on the winding wheel 32' based on the received counting signal. Therefore, the signal transmitter 400 in the first embodiment can serve as the first detection component 400', and the signal receiver 310 in the first embodiment can serve as the second detection component 310'. The display device 20' is also used to display cable extension length data and/or retraction length data, so that users can directly observe the position of the endoscope probe 50' in the pipeline by observing images on the display device 20'. The display device 20' is installed on the fixing housing 100'. The specific installation method between the display device 20' and the fixing housing 100' is not limited here, and designers can make reasonable designs according to actual needs; for example, the display device 20' can be, but is not limited to, detachably connected to the fixing housing 100' through at least one of screw connection, card connection, or plug connection; for another example, the display device 20' can also be non detachably connected to the fixing housing 100' through riveting, bonding, or welding, but not limited to.

Specially, the specific manifestations of the first detection component 400' and the second detection component 310' can include, but are not limited to, the following situations.

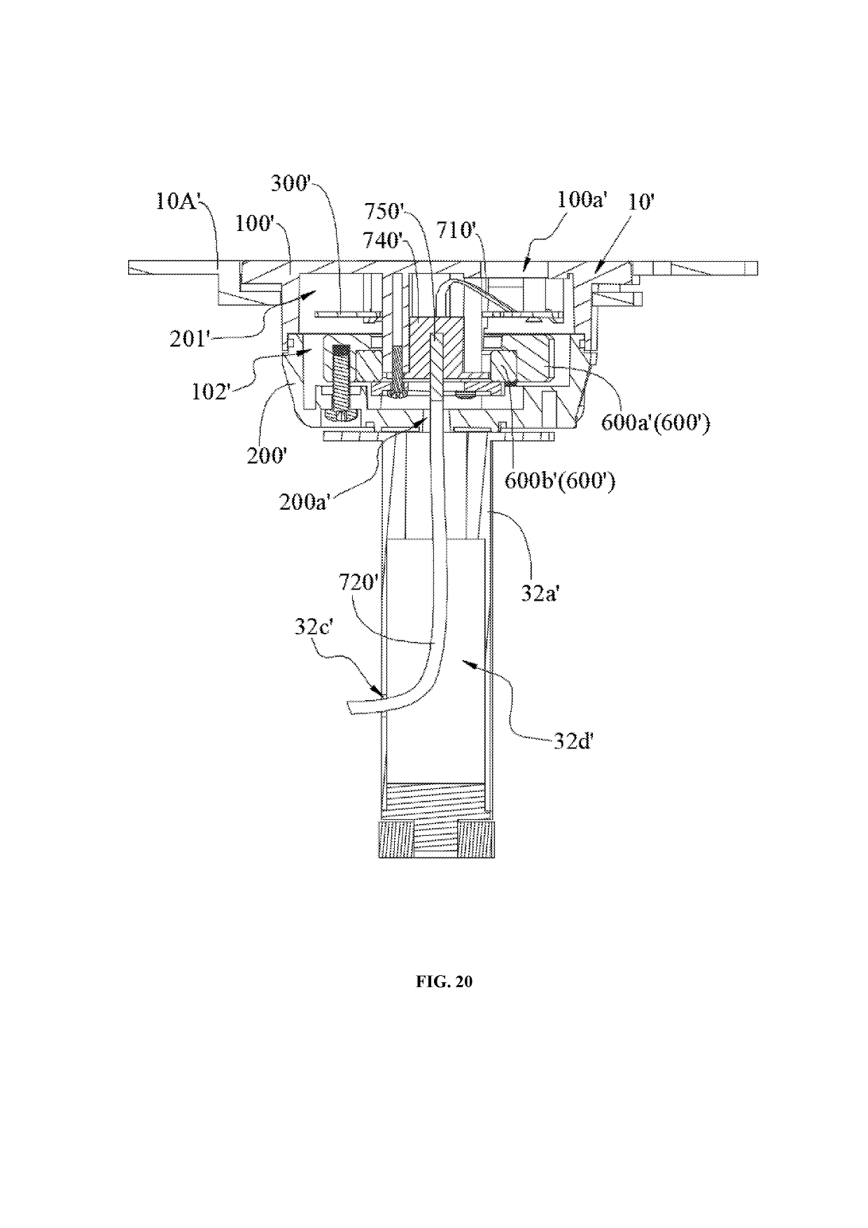

As shown in FIGS. 20-23, in the first scenario, the first detection component 400' is a magnet 400a' located on one side of the rotating housing 200' (the magnet 400a' is specifically set on the bearing component 600'), and the second detection component 310' is a Hall sensor 310a' set on the control board 300' and electrically connected to the control board 300'. The number of magnets 400a' is at least two, and at least two magnets 400a' are evenly spaced along a circumference of the rotating housing 200'; and/or the number of Hall sensors 310a' is at least two, and at least two Hall sensors 310a' are evenly spaced along a circumference of the fixing housing 100'. When the rotating housing 200' rotates relative to the fixing housing 100', the magnet 400a' passes through the Hall sensor 310a', the Hall sensor 310a' detects the change in magnetic flux, generates a counting signal, and sends it to the control board 300'. Each time the control board 300' receives a counting signal, it represents that the rotating housing 200' rotates relative to the fixing housing 100' by a preset angle, which is the central angle between adjacent magnets 400a' or two Hall sensors 310a'. This can be used to calculate the length of the cable 40' extension and contraction. By designing at least two magnets 400a' or at least two Hall sensors 310a', the detection accuracy can be effectively improved, allowing users to intuitively understand the length of the cable 40' that can be extended or retracted, and based on this, determine the position of the endoscope probe 50', providing a better user experience. Specifically, the number of magnets 400a' is ten, and the ten magnets 400a' are evenly spaced along the circumference of the rotating housing 200', that is, the central angle between adjacent magnets 400a' is 36 degrees.

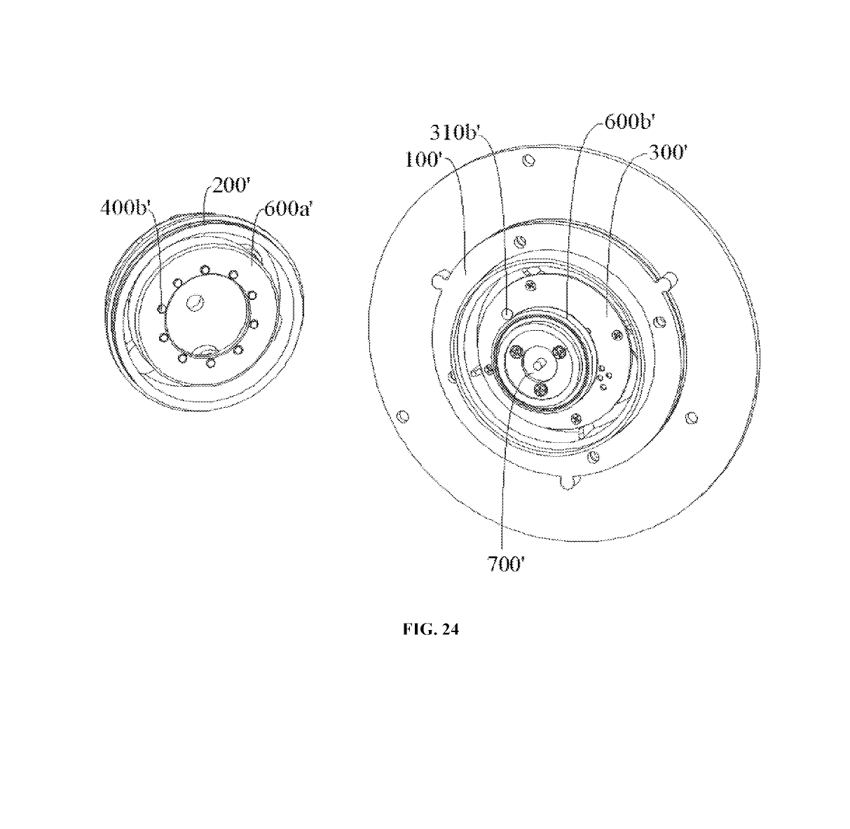

As shown in FIG. 24, in the second scenario, the first detection component 400' is an transmitter 400b' located on the side of the rotating housing 200' (the transmitter 400b' is specifically set on the bearing component 600'), and the second detection component 310' is a receiver 310b' located on the control board 300' and electrically connected to the control board 300'. The number of transmitters 400b' is at least two, and at least two transmitters 400b' are evenly spaced along the circumference of the rotating housing 200'; and/or the number of receivers 310b' is at least two, and at least two receivers 310b' are evenly spaced along the circumference of the fixing housing 100'. Among them, the transmitter 400b' is an infrared transmitter, photoelectric transmitter, or ultrasonic transmitter, and the receiver 310b' is an infrared receiver, photoelectric receiver, or ultrasonic receiver. When the rotating housing 200' rotates relative to the fixing housing 100', the transmitter 400b' passes through the receiver 310b', the receiver 310b' detects the infrared light, generates a counting signal, and sends it to the control board 300'. Each time the control board 300' receives a counting signal, it represents that the rotating housing 200' rotates relative to the fixing housing 100' by a preset angle, which is the central angle between adjacent two transmitters 400b' or two receivers 310b', this can be used to calculate the length of the cable 40' extension and contraction. By designing at least two transmitters 400b' or at least two receivers 310b', the detection accuracy can be effectively improved, allowing users to intuitively understand the length of the cable 40' that can be extended or retracted, and based on this, determine the position of the endoscope probe 50', which provides better experience.

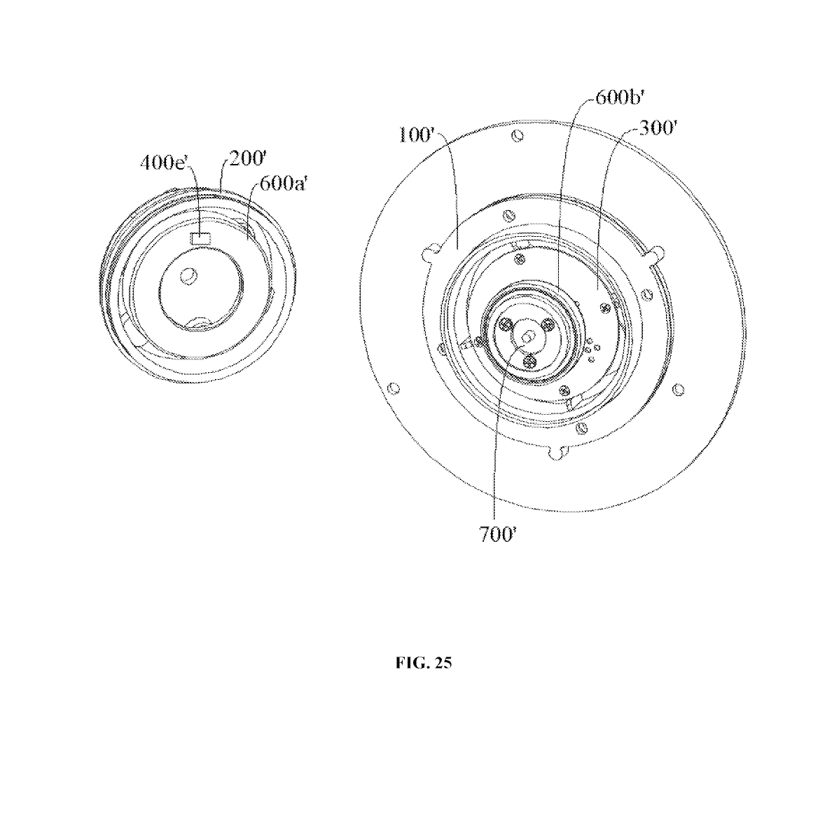

Of course, as shown in FIG. 25, the detection module 400A' can also include a gyroscope 400e', which is located on one side of the rotating housing 200'. When the rotating housing 200' rotates relative to the fixing housing 100', the gyroscope 400e' generates a sensing signal, and the control board 300' calculates the length of the cable 40' extending or retracting on the winding wheel 32' based on the sensing signal.

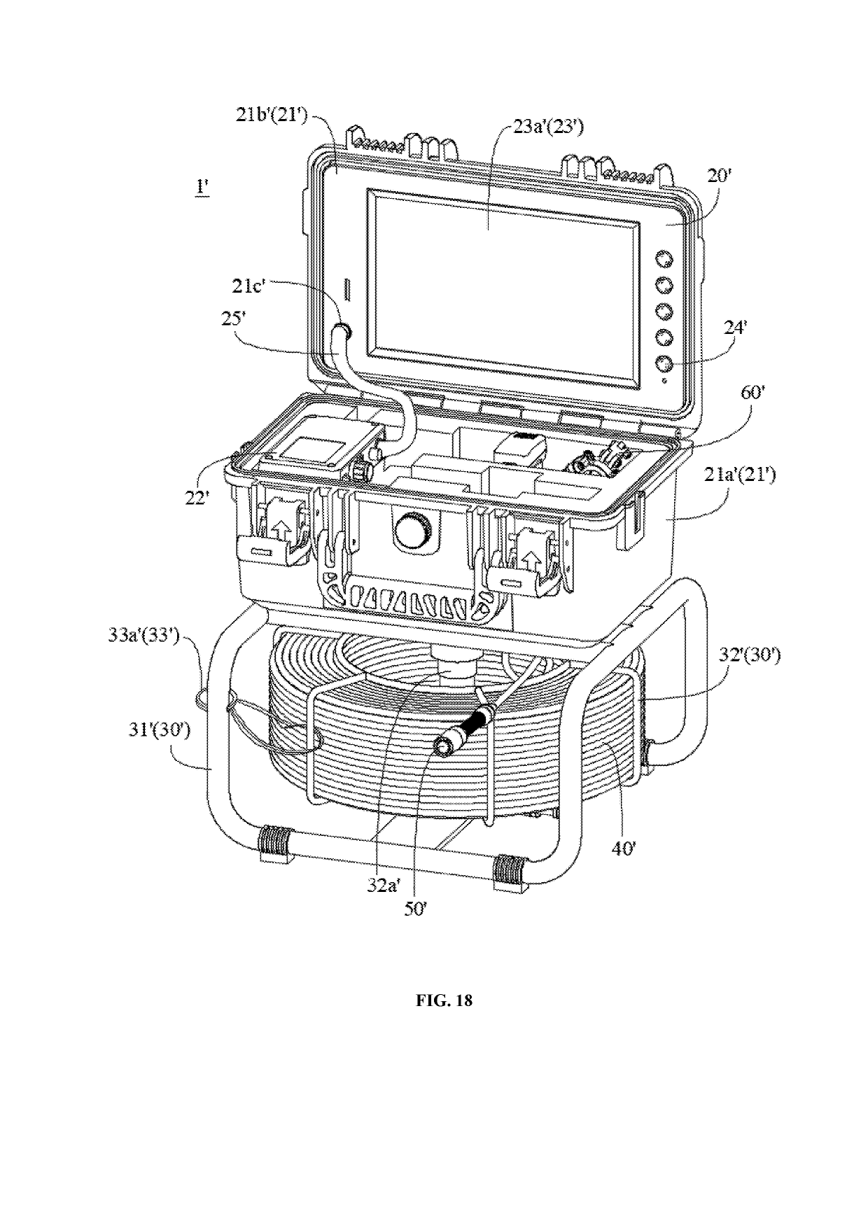

As shown in FIGS. 12 and 18, the display device 20' is also used to display cable extension length data and/or retraction length data, so that users can determine the position of the endoscope probe 50' in the pipeline based on the cable extension length data, this allows users to directly observe the display device 20' to obtain the position of the endoscope probe 50' in the pipeline. The display device 20' is installed on the fixing housing 100'. The specific installation method between the display device 20' and the fixing housing 100' is not limited here, and designers can make reasonable designs according to actual needs; for example, the display device 20' can be, but is not limited to, detachably connected to the fixing housing 100' through at least one of screw connection, card connection, or plug connection; for another example, the display device 20' can also be non detachably connected to the fixing housing 100' through riveting, bonding, or welding, but not limited to.

In this embodiment, as shown in FIGS. 12, 18, 20-22, the display device 20' includes a storage box 21', a control box 22', and a display screen 23'; the storage box 21' is installed on the fixing housing 100'; at least part of the control box 22' is located inside the storage box 21', and the control box 22' is electrically connected to the control board 300' for receiving images captured by the endoscope probe 50'; at least part of the display screen 23' is located inside the storage box 21', and the display screen 23' is electrically connected to the control box 22' for displaying images captured by the endoscope probe 50'. The display screen 23' is also used to display cable extension length data and/or retraction length data.

Among them, the storage box 21' is used to store components such as the control box 22', display screen 23', and centralizer 60' (which will be introduced later). The specific structure of the storage box 21' will be elaborated in the following text. The specific installation method between the storage box 21' and the fixing housing 100' is not limited here, and designers can make reasonable designs according to actual needs; for example, the storage box 21' can be, but is not limited to, detachably connected to the fixing housing 100' through at least one of screw connection, card connection, or plug-in connection; for another example, the storage box 21' can also be non removable connected to the fixing housing 100' through riveting, bonding, or welding, but not limited to.

The control box 22' can serve as the control center and/or power supply center for the display device 20', and the specific structure of the control box 22' will be introduced in the following text. The control box 22' can be entirely located inside the storage box 21', or a part of the control box 22' can be located inside the storage box 21', and the remaining part can be located outside the storage box 21'.

The entire display screen 23' can be located inside the storage box 21', or a portion of the display screen 23' can be located inside the storage box 21' and the remaining portion can be located outside the storage box 21'.

By designing a storage box 21', it is used to store components such as the control box 22', display screen 23', and centralizer 60', making it easier for users to transport; by designing the control box 22' and display screen 23', the image captured by the endoscope probe 50' is transmitted to the control board 300' through cable 40'. The control board 300' transmits the image to the electrically connected control box 22', and the control box 22' transmits the image to the electrically connected display screen 23', so that the display screen 23' displays the image. At this time, the user can understand the internal situation of the pipeline by observing the image displayed on the display screen 23'; the display screen 23' can also be used to display cable extension and retraction length data, so that users can directly observe the cable extension and retraction length data displayed on the display screen 23' to understand the extension or retraction length of the cable 40'.

As shown in FIGS. 26-28, the control box 22' includes a main body 22a' and an electronic control component 22b' arranged on the main body 22a'. The electronic control component 22b' is electrically connected to the control board 300', and the electronic control component 22b' is further configured to be electrically connected to the display screen 23'. Specifically, the electronic control component 22d' includes a first circuit board 22m, a battery 22k electrically connected to the first circuit board 22m, a first electrical interface 22d', and a second electrical interface 22d'. The first circuit board 22m is installed inside the main body 22a', and the first electrical interface 22c' is electrically connected to the first circuit board 22m and exposed on the main body 22a' through an opening. The first electrical interface 22c' is electrically connected to the control board 300', the second electrical interface 22d' is electrically connected to the first circuit board 22m and exposed on the main body 22a' through another opening, and the second electrical interface 22d' is electrically connected to the display screen 23'.

As shown in FIG. 18, the display device 20' also includes a triggering element 24', which is installed on the main body 22a' and electrically connected to the electronic control component 22b' (specifically the first circuit board 22m mentioned above). The triggering element 24' is suitable for generating a triggering signal under external force operation, and the electronic control component 22b' controls the control board 300' to change the length measurement unit and/or start counting and/or reset data based on the triggering signal.

Among them, the triggering element 24' can include, but is not limited to, a button 520 or knob electrically connected to the first circuit board 22m. For example, when the triggering component 24' includes a button 520 electrically connected to the first circuit board 22m, the user applies a pressing force to the button 520, and the button 520 generates a triggering signal under the action of the pressing force. The electronic control component 22b' also includes a controller 22n integrated on the first circuit board 22m, which can control the control board 300' to change the length measurement unit (such as centimeter → meter, meter → centimeter, etc.) according to the triggering signal. The controller 22n can also control the control board 300' to start counting based on the triggering signal, so as to effectively measure the extension and retraction length of the cable 40'. The controller 22n can also control the control board 300' to reset the data based on the triggering signal, so that the user can intuitively obtain the length of each extension and retraction of the cable 40'. For example, when the triggering element 24' includes a knob electrically connected to the first circuit board 22m, the user applies a rotational force to the knob, and the knob generates a triggering signal under the action of the rotational force. The controller 22n of the electronic control component 22b' can control the control board 300' to change the length measurement unit (such as centimeter → meter, meter → centimeter, etc.) based on the triggering signal. The controller 22n of the electronic control component 22b' can also control the control board 300' to start counting based on the triggering signal, in order to effectively measure the extension and retraction length of the cable 40'. The controller 22n of the electronic control component 22b' can also control the control board 300' to reset the data based on the triggering signal, so that the user can intuitively obtain the length of the cable 40' each extension and retraction.

The battery 22k is arranged inside the main body 22a', which is electrically connected to the first circuit board 22m mentioned above. The battery 22k is used to power the display screen 23'.

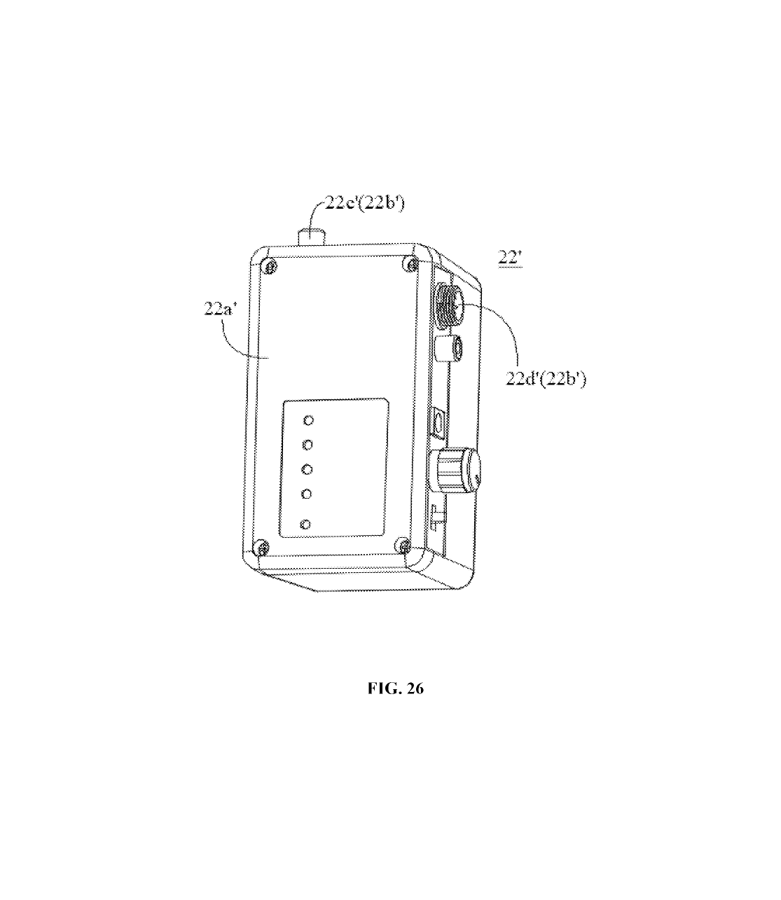

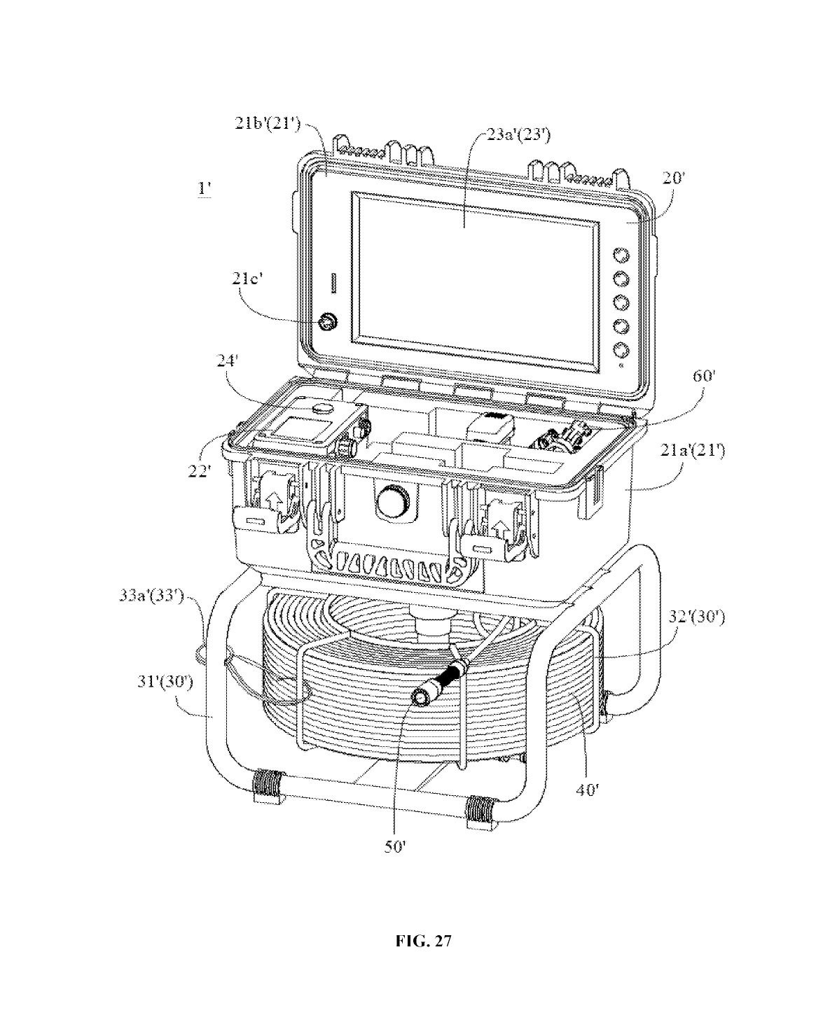

As shown in FIGS. 27-28, the storage box 21' includes a box body 21a' and a cover body 21b' that is movable and connected to the box body 21a'. The control box 22' is set on the box body 21a', and the display screen 23' is installed on the cover body 21b'.

Among them, the cover body 21b' can be, but is not limited to, connected to the box body 21a' through a rotating shaft. At this time, the cover body 21b' opens or closes the opening 112' of the box body 21a' by rotating relative to the box body 21a'; the cover body 21b' can also be connected to the box body 21a' by sliding through the slider 212', but not limited to, at this time, the cover body 21b' opens or closes the opening 112' of the box body 21a' by sliding relative to the box body 21a'.

The specific installation method between the display screen 23' and the cover body 21b' is not limited here, and designers can make reasonable designs according to actual needs; for example, the display screen 23' can be, but is not limited to, detachably connected to the cover body 21b' through card or plug connections; for another example, the display screen 23' can also, but is not limited to, be non removable connected to the cover body 21b' through adhesive bonding.

The triggering element 24' mentioned above can also be installed on the cover body 21b' and placed adjacent to the display screen 23'. The triggering element 24' is electrically connected to the display screen 23' (specifically the second circuit board 22g described below). The triggering element 24' is suitable for generating a trigger signal under external force operation. The control box 22' controls the control board 300' to change the length measurement unit and/or start counting and/or reset data based on the trigger signal.

The triggering element 24' generates a trigger signal under external force operation, and the second circuit board 22g of the display screen 23' receives the trigger signal and sends it to the first circuit board 22m of the electronic control component 22b' of the control box 22'. The controller 22n of the electronic control component 22b' can control the control board 300' to change the length measurement unit (such as centimeter → meter, meter → centimeter, etc.) according to the trigger signal. The controller 22n of the electronic control component 22b' can also control the control board 300' to start counting according to the trigger signal, in order to effectively measure the extension and retraction length of the cable 40'. The controller 22n of the electronic control component 22b' can also control the control board 300' to reset the data according to the trigger signal, so that users can intuitively obtain the length of the cable 40' each extension and retraction.

It should be noted that the triggering element 24' in the second embodiment of the present application is equivalent to the button 520 in the first embodiment of the present application. The difference is that the triggering element 24' in the second embodiment of the present application is installed on the box body 22' of the control box 22' or the cover body 21'of the storage box 21', while the button 520 in the first embodiment of the present application is installed on the fixing housing 100.

In this embodiment, as shown in FIG. 18, the cover body 12b' is equipped with an adapter interface 21c' that is electrically connected to the display screen 23' (specifically the second circuit board 22g described below). The display device 20' also includes an adapter cable 25', with one end of the adapter cable 25' connected to the adapter interface 21c', and the other end of the adapter cable 25' detachably connected to the control box 22' (specifically the second electrical interface 22d' introduced earlier) or the endoscope probe 50'. By designing the adapter cable 25', when the other end of the adapter cable 25' is connected to the control box 22', the circuit formed by the display screen 23', the control box 22', the control board 300', and the endoscope probe 50' is conductive. The image captured by the endoscope probe 50' is transmitted from the endoscope probe 50' to the control board 300', from the control board 300' to the control box 22', and from the control box 22' to the display screen 23' via the adapter cable 25', this allows the display screen 23' to display the image captured by the endoscope probe 50'. By designing an adapter cable 25', and designing the other end of the adapter cable 25' to be detachable from the control box 22' and endoscope probe 50', when the display screen 23' shows unclear or unable to display images, users can connect the other end of the adapter cable 25' with the control box 22' or the endoscope probe 50' to determine if one of the cable 40', control box 22', and endoscope probe 50' is damaged.

For example, if the display screen 23' cannot display images under the above circuit formed by the display screen 23', the control box 22', the control board 300', and the endoscope probe 50', at this time directly connect the endoscope probe 50' to the display screen 23' through the adapter cable 25', if the display screen 23' can display clear images, it can be judged that the endoscope probe 50' is normal, and one of the control box 22' and the cable 40' together with the control board 300' is faulty. If neither the control box 22' nor the endoscope probe 50' is faulty, it can be judged that the cable 40' together with the control board 300' is faulty.

It can be understood that when the endoscope probe 50' is directly connected to the display screen 23', the display screen 23' can also be electrically connected to the control box 22' or connected to other external power sources through a power interface and power cord, thereby obtaining the voltage required for the operation of the display screen 23' and the endoscope probe 50'.

The display screen 23' includes a display body 23a' and a second circuit board 22g. The display body 23a' is mounted on the cover body 21b' and used to display images captured by the endoscope probe 50'. The second circuit board 22g is mounted on the cover body 21b' and located behind the display body 23a'. The second circuit board 22g is electrically connected to the display body 23a' and is also electrically connected to the control box 22'.

The display device 20' also includes a wireless module 22h, which is located on the second circuit board 22g and electrically connected to the second circuit board 22g. The wireless module 22h is used for wireless communication with external terminals to project images captured by the endoscope probe 50' onto the external terminal. Among them, the wireless module 22h can include but is not limited to ceramic dielectric antennas or metal antennas electrically connected to the second circuit board 22g, with sufficient raw materials and easy access. External terminals can include, but are not limited to, mobile phones or laptops. By designing a wireless module 22h, the images captured by the endoscope probe 50' can also be wirelessly transmitted to external terminals through the wireless module 22h. At this time, users can directly use the images displayed by the external terminal to observe the internal situation of the pipeline. In other embodiments, the wireless module 22h can also be installed on the first circuit board 22m in the control box 22'.

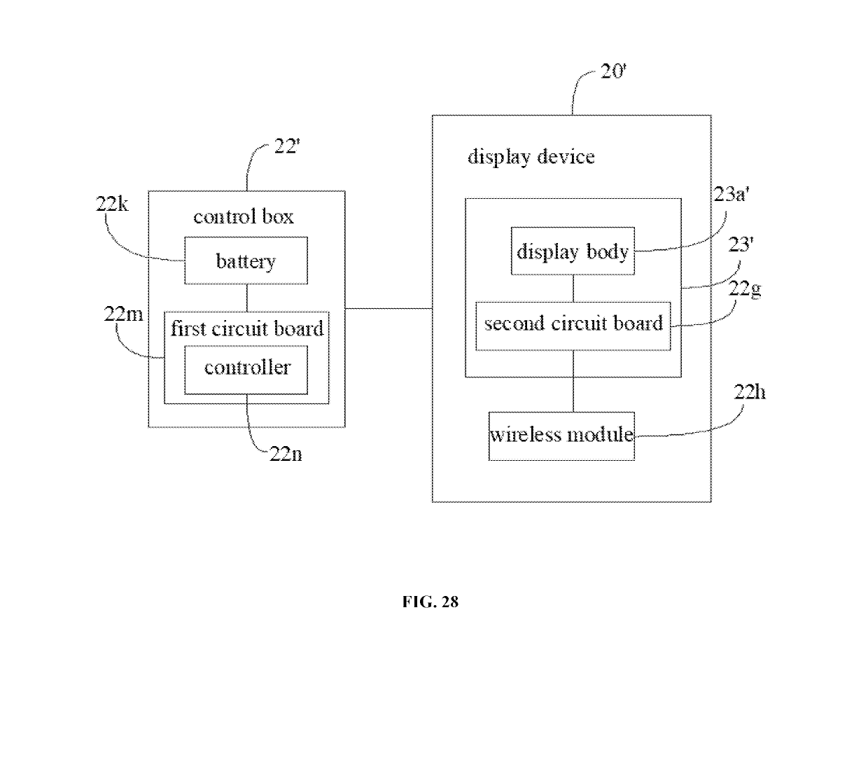

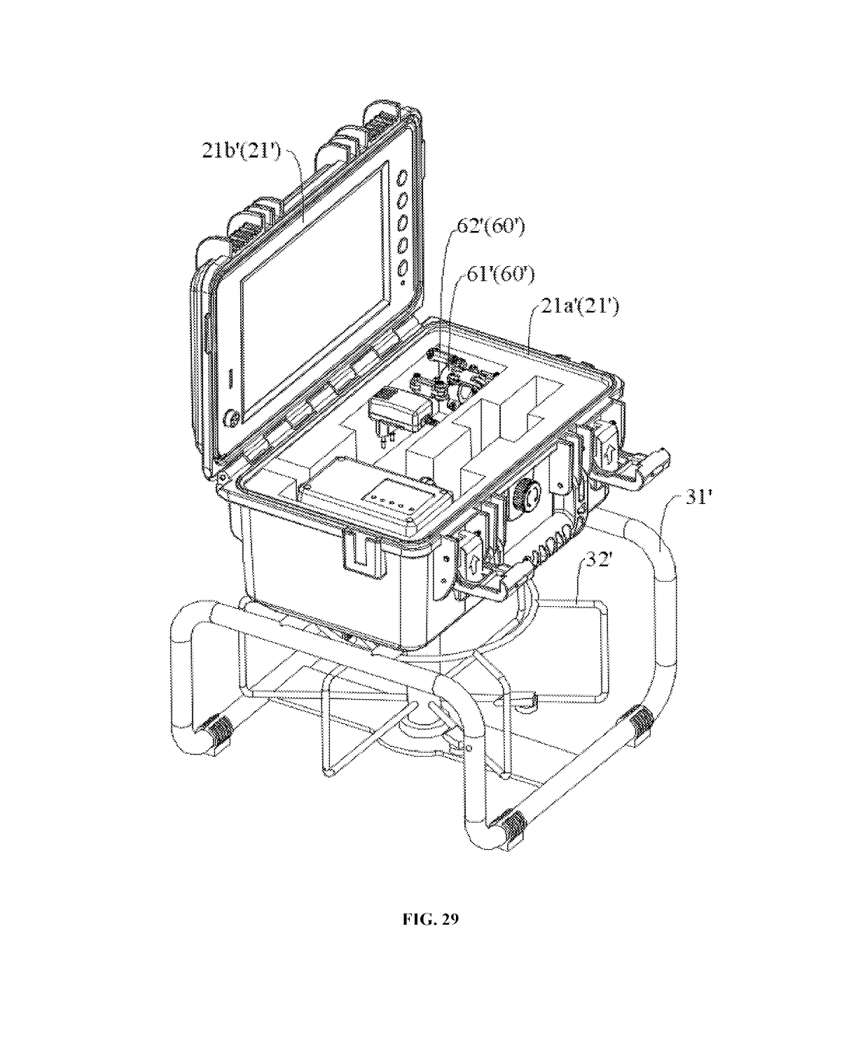

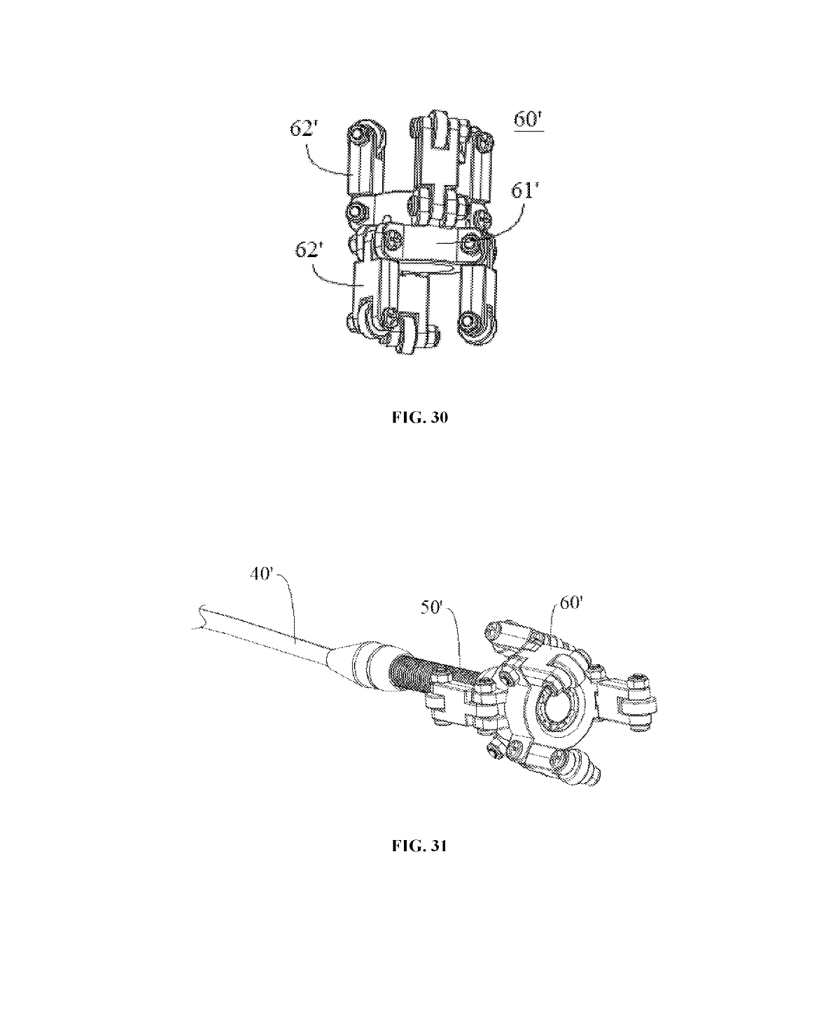

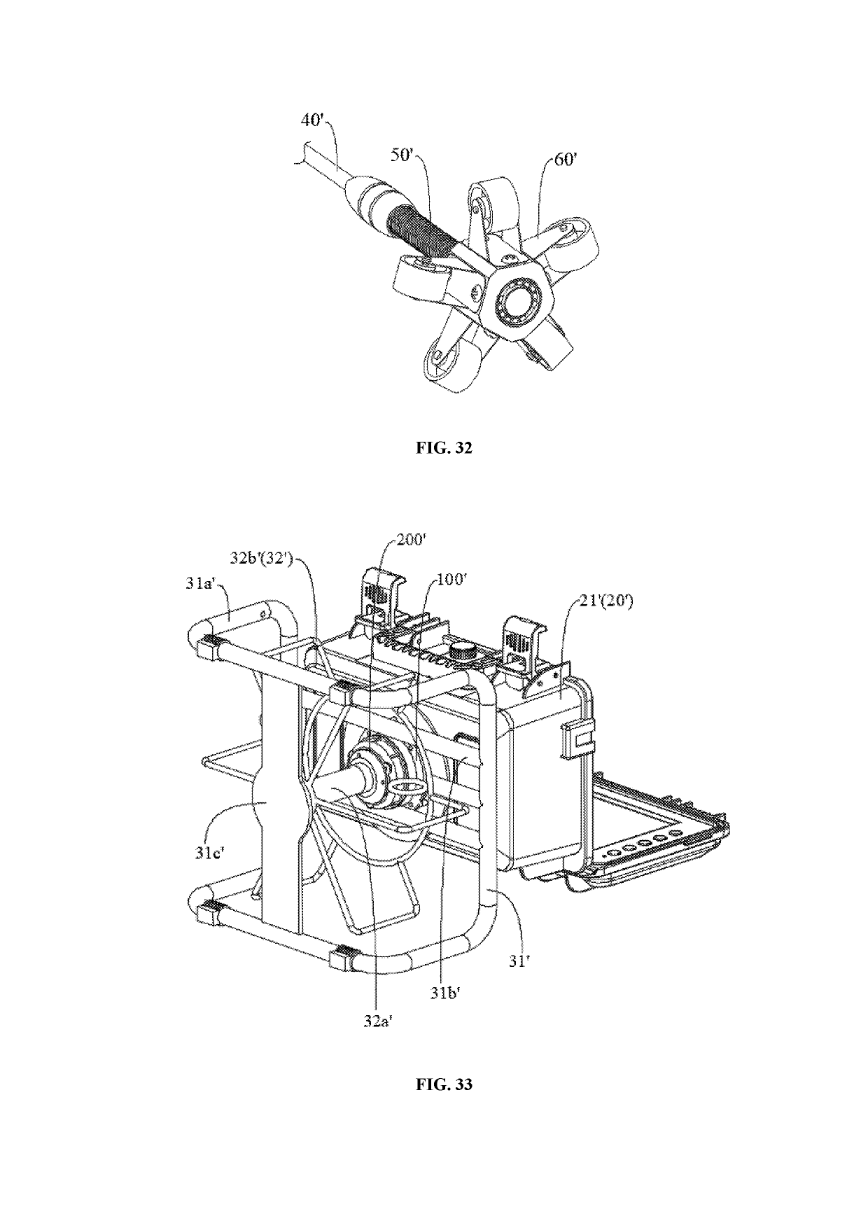

As shown in FIGS. 29-32, the pipeline endoscopic system 1' further includes a centralizer 60', which is detachably fitted around the periphery of the endoscope probe 50'. The centralizer 60' is used to keep the endoscope probe 50' always in the middle position of the radial section of the pipeline when it travels inside the pipeline. By designing the centralizer 60', when it is necessary to detect the internal condition of the pipeline, users can directly set the centralizer 60' around the periphery of the endoscope probe 50', at this time, the centralizer 60' is equivalent to the crawling foot of the endoscope probe 50' providing stable support for the centralizer 60', while also ensuring that the endoscope probe 50' is always located in the middle of the radial section of the pipeline, ensuring that the captured image has no dead corners in 360 degrees and that the endoscope probe 50' can stably crawl inside the pipeline. Of course, when there is no need to detect the internal condition of the pipeline, the centralizer 60' can be removed from the periphery of the endoscope probe 50', and then placed in the storage box 21' for storage for future use.

Specifically, the centralizer 60' includes a main body 61' and multiple support parts 62'. The main body 61' is detachably fitted around the periphery of the endoscope probe 50', and multiple support parts 62' are movably connected to the main body 61'. When the endoscope probe 50' travels inside the pipeline, one end of the multiple support parts 62' away from the main body part 61' is used to make contact with the inner wall of the pipeline. By designing the main body 61', which is used to fit around the periphery of the endoscope probe 50', multiple support parts 62' are connected to the endoscope probe 50' through the main body 61'; by designing the support portion 62', when the endoscope probe 50' travels inside the pipeline, the end of the support portion 62' away from the main body portion 61' is used to come into contact with the inner wall of the pipeline to provide support for the endoscope probe 50', so that the endoscope probe 50' is always located in the middle of the radial section of the pipeline.

In this embodiment, as shown in FIGS. 18, 29, and 33, the cable support device 30' further includes a limiting member 33' connected to the support base 31'. When the cable 40' is not laid out, one end of the limiting member 33' is connected to a wheel disc 32b' of the winding wheel 32' to limit the winding wheel 32' rotates relative to the support base 31', in this way, the winding wheel 32' will not rotate relative to the support base 31' at will, so that the cable 40' will not automatically loosen and can be neatly wound around the central axle 32' of the winding wheel 32'.

Specifically, the limiting member 33' includes a hook and loop fastener 33', and a hook tail of the hook and loop fastener 33' is connected to the support base 31'. When the cable 40' is not laid out, a hook head of the hook and loop fastener 33' can be hooked onto the wheel disc 32' of the winding wheel 32'. In this way, when the cable 40' is not laid out, the user can directly press the hook head of the hook and loop 33a', so that the hook head of the hook and loop 33a' is hooked on the wheel disc 32b' of the winding wheel 32'. This can achieve relative fixation between the winding wheel 32' and the support base 31', and the winding wheel 32' will not rotate relative to the support base 31', so that the cable 40' will not automatically loosen and can be neatly wound on the central axle 32a' of the winding wheel 32'. Of course, the limiting member 33' can also include a rope strap, with one end of the rope strap tied to the support base 31'. When the cable 40' is not laid out, the other end of the rope strap can be tied to the wheel disc 32b' of the winding wheel 32'.

As shown in FIGS. 18, 29, and 33, the support base 31' includes four U-shaped frames 31', with two U-shaped frames 31' facing each other in the front to rear direction and standing upright, and the other two U-shaped frames 31' facing each other in the left to right direction and inverted. The four U-shaped frames 31' are connected in sequence from beginning to end. The support base 31' also includes three upper cross beams 31b' extending in the left to right direction, and are arranged at intervals in the front to rear direction. Two upper cross beams 31b' at outer sides are fixedly connected to the two U-shaped frames 31a' with both ends, the upper cross beam 31b' at the middle is fixedly connected to the fixing housing 100', and the upper cross beam 31b' at the middle is also fixedly connected to the U-shaped frame 31a'. The support base 31' also includes a lower longitudinal beam 31c' extending in the front to rear direction, and the two ends of the lower longitudinal beam 31c' are fixedly connected to two U-shaped frames 31a' at the front and rear sides, respectively. The central axle 32a' of the winding wheel 32' is rotatably connected to the lower longitudinal beam 31c'.

As shown in FIGS. 20-22, the fixing housing 100' is equipped with a bearing fixing column 110', and the bearing component 600' includes a bearing housing 600a' and a bearing 600b'. The bearing housing 600a' can be fixedly connected to the rotating housing 200' through locking screws, and the bearing housing 600a' has a roughly circular ring structure. The outer ring 620' of the bearing 600b' is connected to the bearing housing 600a' through interference fit to achieve relative fixation between the bearing 600b' and the bearing housing 600a'. The inner ring 610' of the bearing 600b' is connected to the bearing fixing column 110' through interference fit to achieve the connection between the bearing 600b' and the bearing fixing column 110', and the relative fixation of positions between them. The first detection component 400' mentioned above is set on the bearing housing 600a'; for example, when the first detection component 400' is a magnet, the bearing shell 600a' has two less magnet accommodating slots 101' on the side facing the fixing housing 100', and the magnet is inserted into the magnet receiving slots 101'. By setting up this structure, multiple magnet accommodating slots 101' are evenly spaced along the circumference of the rotating housing 200', which can effectively locate and accommodate magnets. On the one hand, it ensures the stability of the product, and on the other hand, it also fixes the central angle between adjacent magnets, making it convenient to calculate the rotation angle of the rotating housing 200', and then calculate the length of the cable 40' expansion and contraction.

As shown in FIGS. 20-22, the fixing housing 100' is provided with a control board accommodating slot 201' and a first limiting column 210'. The first limiting column 210' extends upward along the bottom wall of the control board accommodating slot 201', and the control board 300' is inserted into the control board accommodating slot 201'. A limiting hole 301' is provided on the control board 300', and the first limiting column 210' is inserted into the limiting hole 301'. By setting up this structure, the control board 300' is placed in the control board accommodating slot 201', which can effectively protect the control board 300' and prevent it from being damaged; the first limiting column 210' is inserted into the limiting hole 301', which can prevent the control board 300' from moving radially or circumferentially in the control board accommodating slot 201', further ensuring the stability of the product; meanwhile, since the second detection component 310' is set on the control board 300', the stability of the control board 300' can also limit the position of the second detection component 310', preventing the displacement of the second detection component 310' from affecting the measurement results.

As shown in FIGS. 20-22, the fixing housing 100' is also provided with a second limiting column 220', which extends upward from the bottom wall of the control board accommodating slot 201', and contacts the surface of the control board 300'. By setting up this structure, the second limiting column 220' can be pressed against the surface of the control board 300' to restrict the axial movement of the control board 300', further ensuring the stability of the product; at the same time, a connection space is formed between the surface of the control board 300' and the bottom wall of the control board accommodating slot 201', the connection space allows the conductive connection wire 800' to be connected to the control board 300', facilitating the transmission of signals and data, and the product structure distribution is more reasonable.

As shown in FIGS. 20-22, the cable length measuring device 10' further includes a rotary transmission component 700', which is arranged on the fixing housing 100' along a rotation axis direction thereof. The rotary transmission component 700' is electrically connected to the control module 300A' (specifically the control board 300' mentioned above) and the cable 40', thus, the electrical connection between the control module 300A' (specifically the control board 300' mentioned above) and the cable 40' can be achieved. When the rotating housing 200' rotates relative to the fixing housing 100', the rotary transmission component 700' is used to maintain electrical conductivity between the control module 300A' (specifically the control board 300' mentioned above) and the cable 40'. By setting up this structure, when in use, one end of the rotary transmission component 700' is electrically connected to the control board 300', and the other end is electrically connected to the cable 40', so as to maintain a stable electrical connection between the control board 300' and the cable 40' when the rotating housing 200' rotates relative to the fixing housing 100', in order to achieve stable signal and data propagation. The rotary transmission component 700' is also a rotatable electrical connector, such as an electrical slip ring.

At the center of the bearing fixing column 110', there is a first receiving groove 111', and the rotary transmission component 700' is inserted into the first receiving groove 111' and connected to the bearing fixing column 110'. By setting up this structure, the rotary transmission component 700' is inserted into the first receiving groove 111', which can effectively protect the rotary transmission component 700', ensure the stability of the product, and stably connect the rotary transmission component 700' to the bearing fixing column 110'.

The inner part of the central axle 32a' of the winding wheel 32' is hollow to form a cavity 32d', and the outer surface of the central axle 32a' of the winding wheel 32' is provided with a first threading hole 32c' connected to the cavity 32d'. The rotating housing 200' is equipped with a second threading hole 200a' that is connected to the cavity 32d'. The bearing fixing column 110' is also provided with an opening 112' connected to the first receiving groove 111', and the fixing housing 100' (specifically the bottom wall of the control board accommodating slot 201') is provided with a third threading hole 100a' connected to the interior of the display device 20' (specifically the storage box 21'). The first data cable group 710' of the rotary transmission component 700' is electrically connected to the control module 300A' (specifically the control board 300') through the opening 112', and the conductive connecting wire connected to the control board 300' is electrically connected to the display device 20' (specifically the control box 22') through the third threading hole 100a'. The second data cable group 720' of the rotary transmission component 700' is electrically connected to the cable 40' through the second threading hole 200a' and the first threading hole 32c'.

By setting the above structure, the opening 112' can allow the first data cable group 710' to pass through, to electrically connect the control board 300' with the rotary transmission component 700', and to electrically connect the cable 40' with the rotary transmission component 700' through the second data cable group 720', achieving electrical connection of the entire electrical system. The product structure is reasonable, and signal and data transmission are stable; when in use, the control board 300' transmits the counting signal generated by the second detection component 310' and the video data transmitted by the endoscope probe 50' to the control board 300' through the rotary transmission component 700', and finally displays it through the display device 20'.

The rotary transmission component 700' includes a connecting part 740' and a rotating part 750'. The connecting part 740' is set in the fixing housing 100' (specifically inserted into the first receiving groove 111' of the bearing fixing column 110' mentioned above), and the rotating part 750' is rotatably connected to the connecting part 740' and electrically connected to the connecting part 740'. The connecting part 740' is electrically connected to a first data line group 710', and the rotating part 750' is electrically connected to a second data line group 720'. The connecting part 740' is connected to the control module 300a' (specifically the control board 300' mentioned above) via the first data line group 710', and the rotating part 750' is electrically connected to the cable 40' via the second data line group 720'. In this design, when in use, the rotating housing 200' rotates relative to the fixing housing 100', and the second data cable group 720' is electrically connected to the cable 40'. The second data cable group 720' and the rotating part 750' rotate with the rotating housing 200', and the connecting part 740' and the control board 300' are set on the fixing housing 100'. The first data cable group 710' is electrically connected to the control board 300' to achieve data transmission.

It should be noted that the specific structure of the cable length measuring device 10' in the second embodiment of the present application is roughly the same as that of the cable length measuring device in the first embodiment of the present application. Due to the fact that the control board 300' in the second embodiment of the present application is set on one side of the fixing housing 100' (while the control board 300 in the first embodiment of the present application is set on one side of the rotating housing 200), the design of structures such as the first limiting column 210' and the second limiting column 220' has been correspondingly changed in position, and the design of structures such as the first connecting piece, the second connecting piece, and the third connecting piece in the first embodiment of the present application has also been correspondingly adjusted. Therefore, it will not be repeated here.

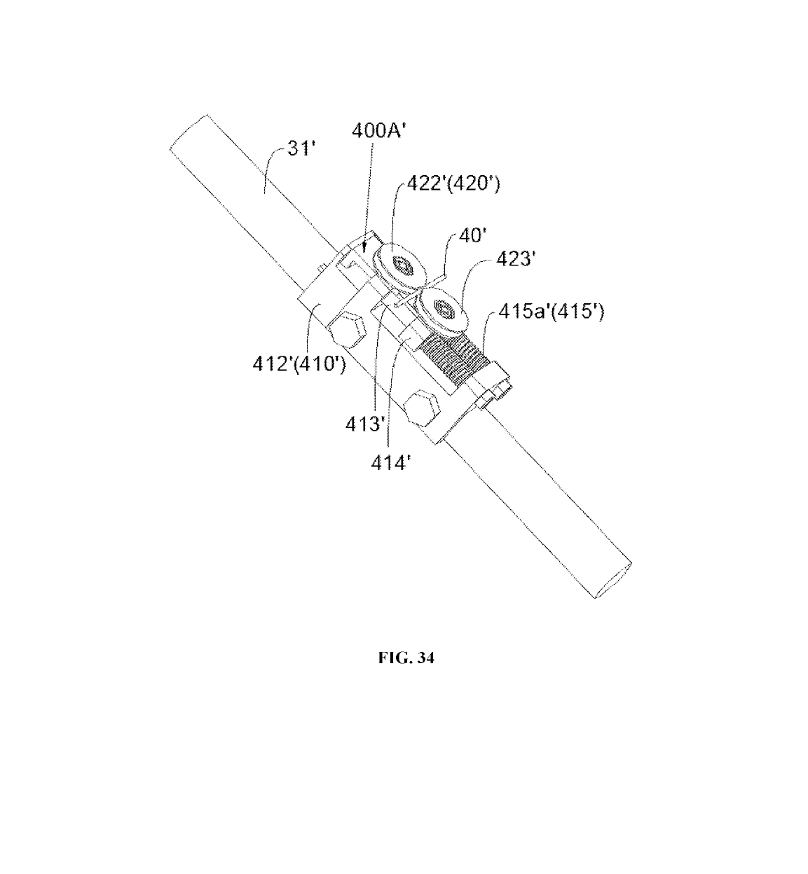

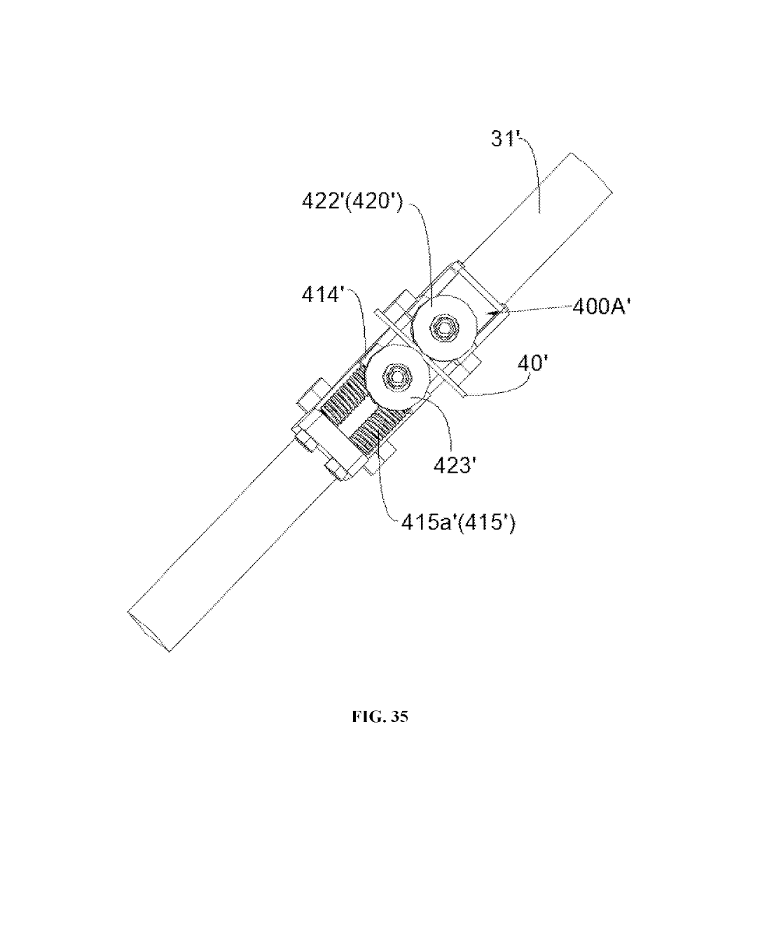

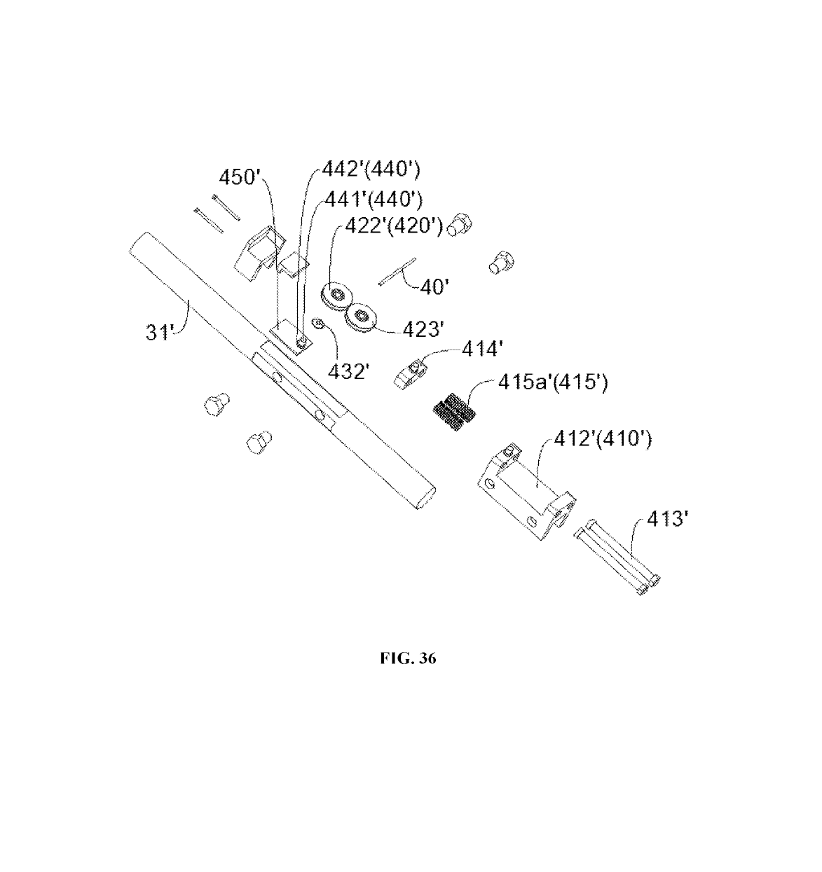

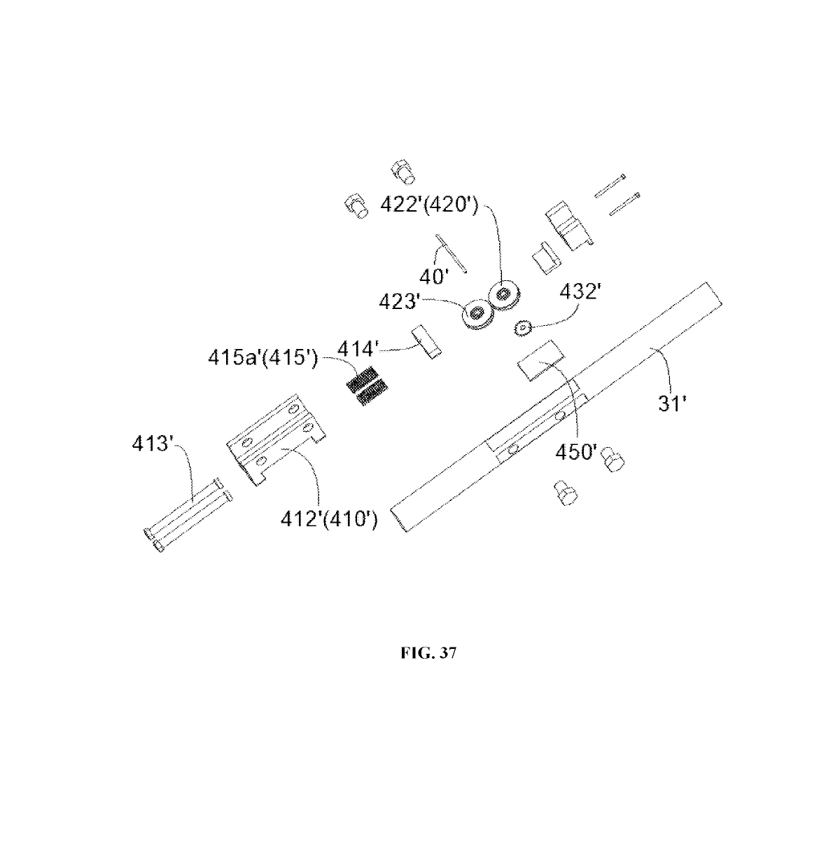

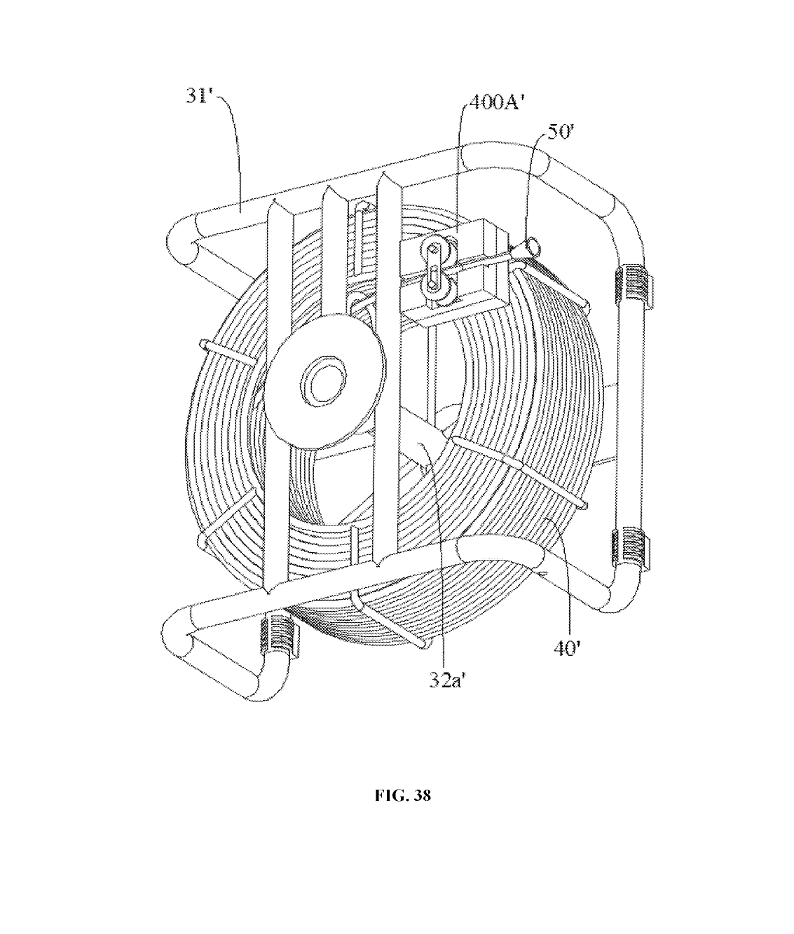

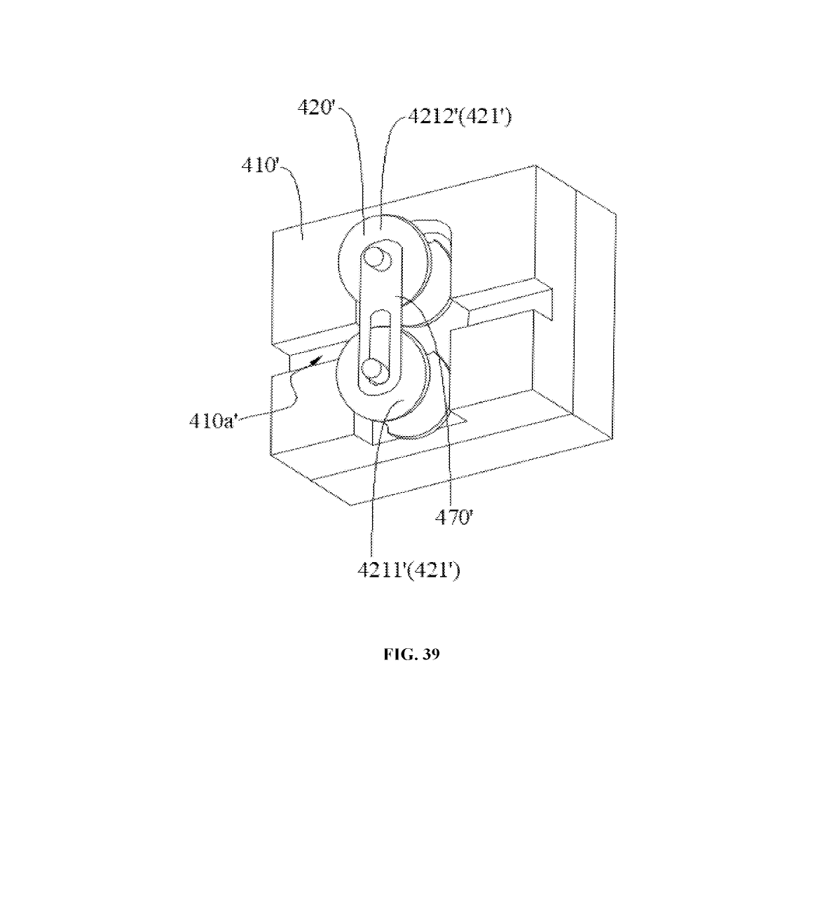

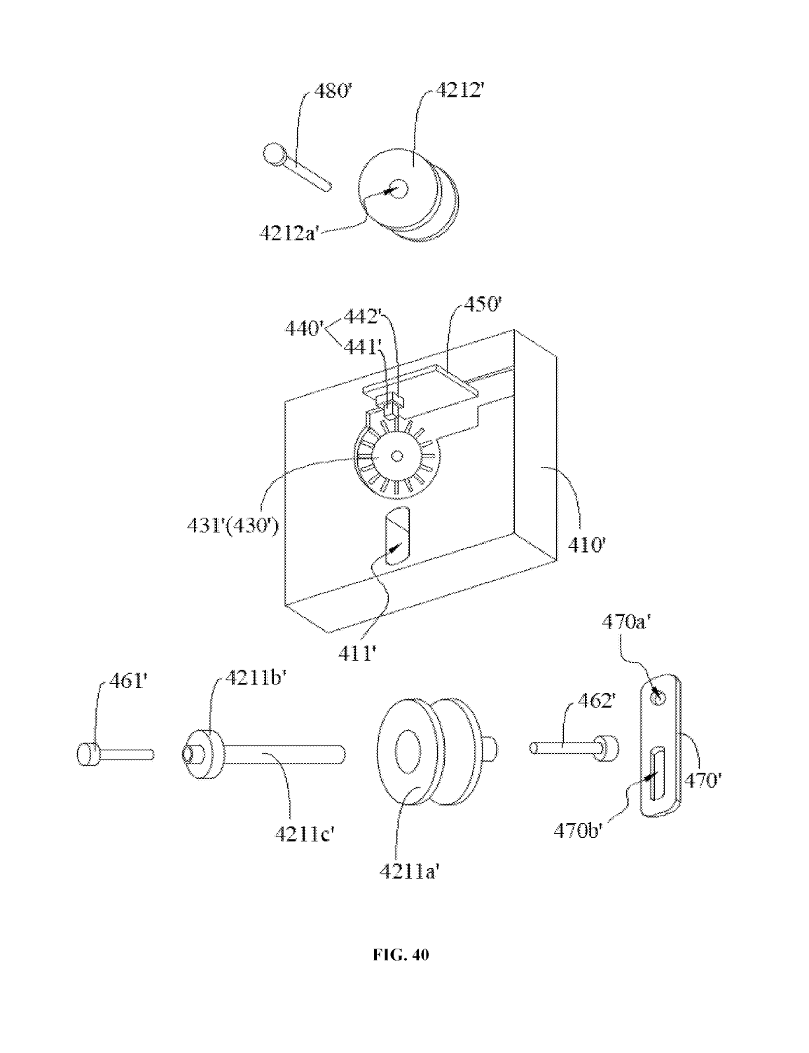

As shown in FIGS. 34-40, FIGS. 34-40 illustrates the structural schematic view of the detection module 400A' in an another modified second embodiment of the present application, which includes a shell 410', a pulley assembly 420', a transmission component 430', an encoder 440', and a counting board 450'.

Specially, the detection module 400A' includes a shell 410' installed on the support base 31', a pulley assembly 420' set on the shell 410', a transmission component 430' connecting the pulley assembly 420', an encoder 440' having a rotating end 441' connected to the transmission component 430', and a counting plate 450' electrically connected to a fixing end 442' of the encoder 440' and installed on the shell 410'. The cable 40' is fixed to the pulley assembly 420' and can drive the pulley assembly 420' to rotate. The transmission component 430' rotates synchronously with the pulley assembly 420' and drives the rotating end 441' of the encoder 440' to rotate during rotation, thereby the fixing end 442' of the encoder 440' outputs the above sensing signal. When the winding wheel 32' rotates, the cable 40' extends, at this time, the cable 40' can drive the pulley assembly 420' to rotate relative to the shell 410'. The rotation of the pulley assembly 420' drives the transmission component 430' connected to it to rotate relative to the shell 410'. The rotation of the transmission component 430' drives the rotating end 441' of the encoder 440' connected to the transmission component 430' to rotate, the rotating end 441 of the encoder 440' rotates relative to the fixing end 442' of the encoder 440' to generate the above-mentioned sensing signal. The encoder 440' transmits the sensing signal to the electrically connected counting board 450', and the counting board 450' transmits the sensing signal to the electrically connected control module 300A', the control module 300A' then calculates the length of extension or retraction of cable 40' around the winding wheel 32 based on the sensing signal.

Referring to FIGS. 34-37, the shell 410' includes a shell body 412' installed on the support base 31', sliding rod 413' extending in a direction perpendicular to the extension and contraction direction of the cable 40' and fixedly connected to the shell body 412', sliding block 414' slidably connected to the sliding rod 413', and an elastic member 415' pressed between the shell body 412' and the sliding block 414'. The transmission member 430', encoder 440', and counting plate 450' are all set in the shell body 412'.

The pulley assembly 420' includes a first roller 422' and a second roller 423'. The first roller 422' is rotatably connected to the shell body 412', and the first roller 422' moves with the transmission component 430'. The second roller 423' is rotatably connected to the sliding block 414', and the second roller 423' and the first roller 422' are arranged in a direction perpendicular to the extension and contraction direction of the cable 40'. The cable 40' is clamped between the first roller 422' and the second roller 423'. When the cable 40' is laid out, the first roller 422' rotates to drive the transmission component 430' to rotate, thereby driving the rotating end 441' of the encoder 440' to rotate relative to the fixing end 442' of the encoder 440' to generate the above-mentioned sensing signal.

By designing the sliding block 414' and sliding rod 413', the sliding block 414' moves on the sliding rod 413' by pressing the elastic member 415' to change the spacing between the first roller 422' and the second roller 423', so that cables 40' of different radial sizes can be sandwiched between the first roller 422' and the second roller 423', enhancing the applicability of the detection module 400'.

The elastic member 415' includes a spring 415a', which is sleeved on the periphery of the sliding rod 413', and the spring 415a' is located on the side of the sliding block 414' away from the first roller 422'. The sliding block 414' moves on the sliding rod 413' by pressing the spring 415a' to change the spacing between the first roller 422' and the second roller 423', so that cables 40' of different radial sizes can be clamped between the first roller 422' and the second roller 423', enhancing the applicability of the detection module 400'.

The number of sliding rods 413' is two, and the two sliding rods 413' are arranged side by side along the extension and contraction direction of the cable 40'. The number of springs 415a' is two, and the two springs 415a' are correspondingly fitted around the periphery of the two sliding rods 413'. By designing two sliding rods 413' arranged side by side along the extension and contraction direction of cable 40', the sliding block 414' is simultaneously connected to both sliding rods 413', which can enhance the motion stability of the sliding block 414'. By designing two springs 415a' to be correspondingly fitted around the periphery of two sliding rods 413', the force on the sliding block 414' is evenly distributed, enhancing the stability of its movement.

The transmission component 430' includes a first counting wheel 432' set on the shell body 412' and connected to the first roller 422' for transmission. The first counting wheel 432' is connected to the rotating end 441' of the encoder 440' for transmission. When the cable 40' is laid out, the first roller 422' rotates to drive the first counting wheel 432' to rotate, thereby driving the rotating end 441' of the encoder 440' to rotate relative to the fixing end 442' of the encoder 440' to generate the above-mentioned sensing signal.

Among them, the first counting wheel 432' can be directly coaxially fixedly connected with the first roller 422' to achieve synchronous rotation of the first counting wheel 432' and the first roller 422', so that the rotating end 441' of the encoder 440' can effectively rotate relative to the fixing end 442' of the encoder 440' to generate the above-mentioned sensing signal. The first counting wheel 432' can also be indirectly connected to the first roller 422' through transmission mechanisms such as other chain wheels in combination with chains, belt wheels in combination with conveyor belts, etc., to achieve synchronous rotation of the first counting wheel 432' and the first roller 422', so that the rotating end 441' of the encoder 440' can effectively rotate relative to the fixing end 442' of the encoder 440' to generate the above-mentioned sensing signal.

The cable 40' is clamped in the gap between the first roller 422' and the second roller 423'. When the winding wheel 32' rotates, the cable 40' extends, at this time, the cable 40' can drive the first roller 422' and the second roller 423' to rotate relative to the shell body 412'. The rotation of the first roller 422' drives the first counting wheel 432' connected to it to rotate relative to the shell body 412'. The rotation of the first counting wheel 432' drives the rotating end 441' of the encoder 440' connected to it to rotate. The rotating end 441 of the encoder 440' rotates relative to the fixing end 442' of the encoder 440' to generate the above sensing signal. The encoder 440' transmits the sensing signal to the counting board 450', which is electrically connected to it, and the counting board 450' transmits the sensing signal to control module 300A' which is electrically connected to the counting board 450' to calculate the length of extension or retraction of cable 40' on winding wheel 32' based on the sensing signal.

Referring to 38-40, the pulley assembly 420' includes two pulleys 421' connected to the shell 410', and the transmission component 430' includes a second counting wheel 431' connected to one pulley 421' for transmission. The second counting wheel 431' is connected to the rotating end 441' of the encoder 440' for transmission. The cable 40' is arranged between two pulleys 421'. When the cable 40' is laid out, the two pulleys 421' rotate to drive the second counting wheel 431' to rotate, thereby driving the rotating end 441' of the encoder 440' to rotate relative to the fixing end 442' of the encoder 440' to generate the above-mentioned sensing signal.

Among them, the second counting wheel 431' can be directly coaxially fixedly connected to one of its pulleys 421' to achieve synchronous rotation between the second counting wheel 431' and the pulley 421', so that the rotating end 441' of the encoder 440' can effectively rotate relative to the fixing end 442' of the encoder 440' to generate the above-mentioned sensing signal.

The second counting wheel 431' can also be indirectly connected to one of its pulleys 421' through transmission mechanisms such as other chain wheels in combination with chains, belt wheels in combination with conveyor belts, etc., to achieve synchronous rotation of the second counting wheel 431' and pulley 421', so that the rotating end 441' of the encoder 440' can effectively rotate relative to the fixing end 442' of the encoder 440' to generate the above-mentioned sensing signal.

The cable 40' is sandwiched between two pulleys 421', when the winding wheel 32' rotates, the cable 40' extends, at this time, the cable 40' can drive the two pulleys 421' to rotate relative to the shell 410'. The rotation of the pulley 421' drives the second counting wheel 431' connected to the pulley 421' to rotate relative to the shell 410'. The rotation of the counting wheel 431' drives the rotating end 441' of the encoder 440' connected to the second counting wheel 431' to rotate. The rotating end 441 of the encoder 440' rotates relative to the fixing end 442' of the encoder 440' to generate the above-mentioned sensing signal. The encoder 440' transmits the sensing signal to the electrically connected counting board 450', and the counting board 450' transmits the sensing signal to the electrically connected control module 300A', which controls module 300A' calculates the extension or retraction length of cable 40' on winding wheel 32' based on the sensing signal.

The two pulleys 421' include a first pulley 4211' and a second pulley 4212'. The position of the first pulley 4211' relative to the shell 410' is adjustable, while the position of the second pulley 4212' relative to the shell 410' is fixed. The second counting wheel 431' is coaxially and fixedly connected to the second pulley 4212'. In this way, the gap size between the first pulley 4211' and the second pulley 4212' can be changed by adjusting the position of the first pulley 4211', so that cables of different radial sizes 40' can be clamped between the first pulley 4211' and the second pulley 4212', improving the applicability of the pipeline endoscopic system 1'.

Specifically, the shell 410' is provided with an elongated through hole 411', and the first pulley 4211' includes a pulley body 4211a', a bearing 4211b', and a fixing sleeve 4211c'. The pulley body 4211a' is fixedly connected to an outer ring of the bearing 4211b', and the fixing sleeve 4211c' is fixedly connected to an inner ring of the bearing 4211b'. The detection module 400A' also includes a first fixing piece 461' and a second fixing piece 462'. The first fixing piece 461' is threaded through a fixing sleeve 4211c' and connected to the inner wall of the fixed sleeve 4211c', and the second fixing piece 462' is threaded through a long strip-shaped through hole 411' and connected to the inner wall of the fixed sleeve 4211c', so as to assemble the pulley body 4211a' and the fixing sleeve 4211c' as a whole and position it in the shell 410'.

Among them, the elongated through hole 411' extends along the arrangement direction of the first pulley 4211' and the second pulley 4212'. Users can adjust the position of the pulley body 4211a' and the fixing sleeve 4211c' assembled as a whole in the elongated through hole 411' according to the actual radial size of the cable 40', and connect the pulley body 4211a' and the fixing sleeve 4211c' together with the fixing sleeve 4211c' through the first fixing piece 461' and the second fixing piece 462' to lock and fix the assembled whole of the pulley body 4211a' and the fixed sleeve 4211c' to the shell 410' from both sides of the shell 410', so as to achieve relative fixation between the position of the pulley body 4211a' and the fixed sleeve 4211c'assembled as a whole and the shell 410'. More specifically, the fixing sleeve 4211c' is a threaded sleeve, the first fixing piece 461' is a first locking screw, and the second fixing piece 462' is a second locking screw. The first locking screw is connected to the threaded sleeve by threads, and the second locking screw is threaded through a long through hole 411' and connected to the threaded sleeve by threads to achieve relative fixation between the pulley body 4211a' and the fixing sleeve 4211c' assembled as a whole and the shell 410'. Of course, the fixing sleeve 4211c' can also be a snap fit sleeve, at this time , the first fixing piece 461' corresponds to the first locking pin, and the second fixing piece 462' corresponds to the second locking pin, the first locking pin is connected to the snap fit sleeve in a snap fit manner, and the second locking pin passes through a long through hole 411' and is connected to the snap fit sleeve in a snap fit manner, in order to achieve relative fixation of the position between the pulley body 4211a' and the fixing sleeve 4211c' assembled as a whole and the shell 410'.

The axle of the second pulley 4212' is equipped with a fixing hole 4212a'. The detection module 400A' also includes a pressing piece 470' and a third fixing piece 480'. The pressing piece 470' is in the shape of a long strip, and is provided with a through hole 470a' and an adjustment through hole 470b' extending along its length direction. The first fixing piece 461' extends through the adjustment through hole 470b' and connected to the inner cylinder wall of the fixing sleeve 4211c', and the third fixing piece 480' is provided with a through hole 470b' and connected to the fixing hole 4212a'.

Among them, the fixing hole 4212a' can be a threaded hole, and at this time, the third fixing piece 480' is the third locking screw. The third locking screw is threaded with a hole 470a' and connected to the threaded hole; the fixing hole 4212a' can also be a clamping hole, in this case, the third fixing piece 480' is a clamping pin, which is pierced with a hole 470a' and connected to the clamping hole for locking.

A cable groove 410a' is provided on the surface of the shell 410' on the side where the pulley assembly 420' (specifically the first pulley 4211' and the second pulley 4212' mentioned above) is located, and at least part of the cable 40' is embedded in the cable groove 410a'. Among them, the cable groove 410a' extends in the direction of extension or retraction along the cable 40'. By designing a cable groove 410a' on the shell 410', the cable 40' is embedded in the cable groove 410a', and the cable groove 410a' guides the cable 40' which is connected to the endoscope probe 50' to facilitate its extension or retraction movement.

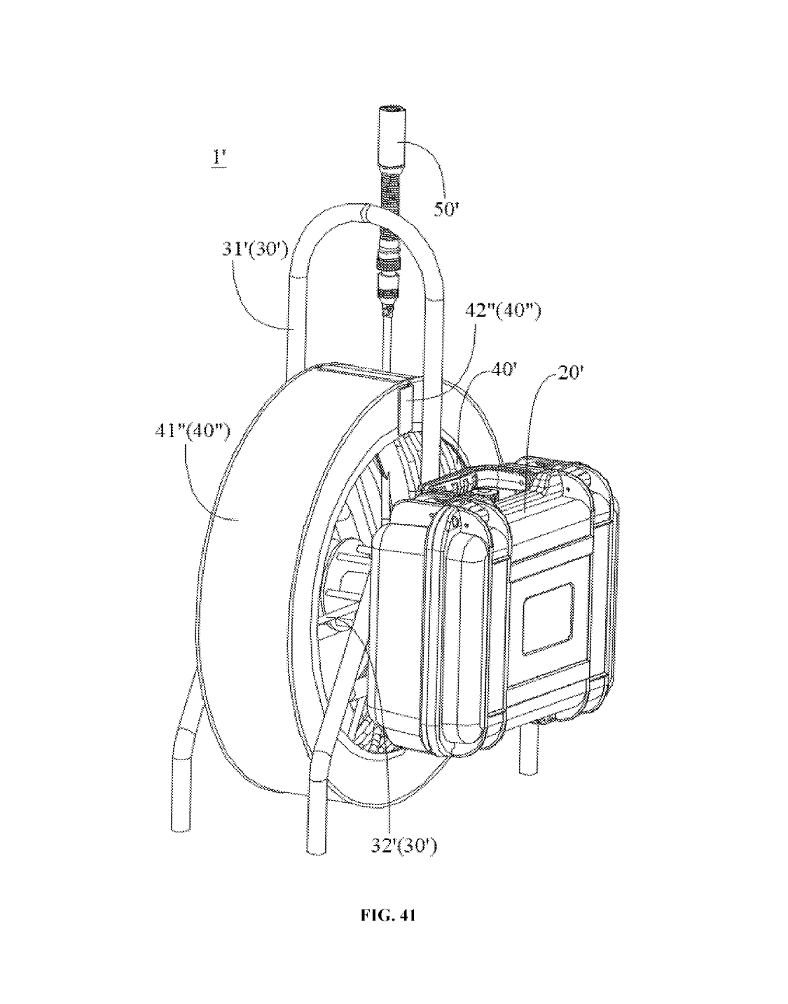

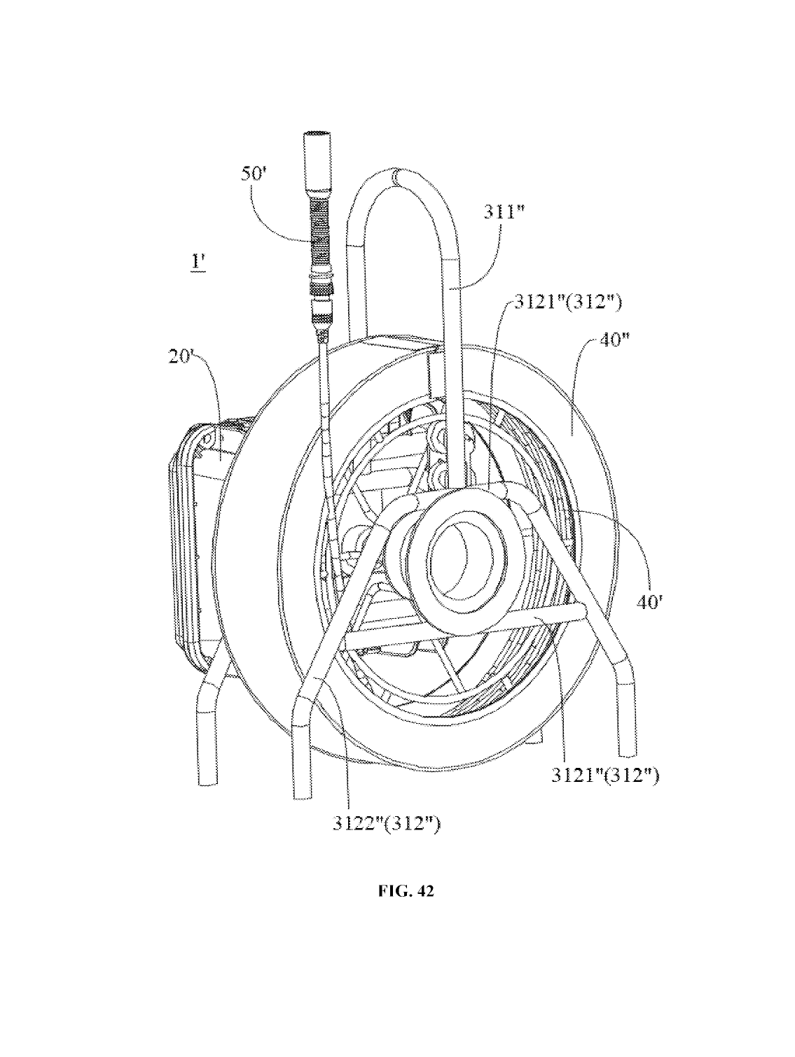

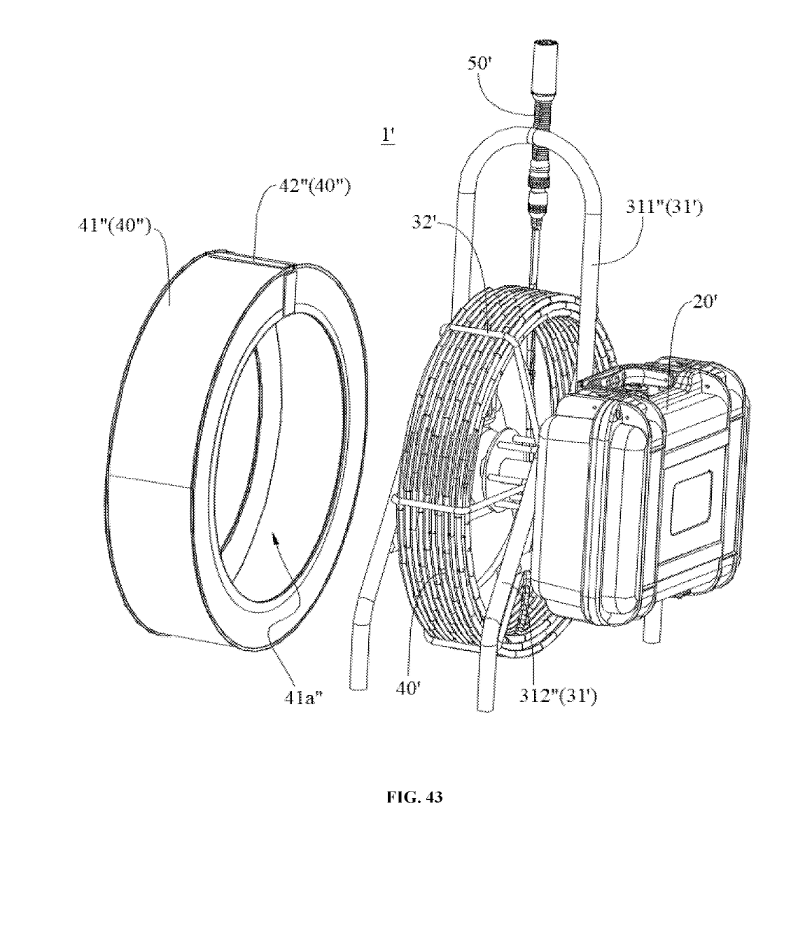

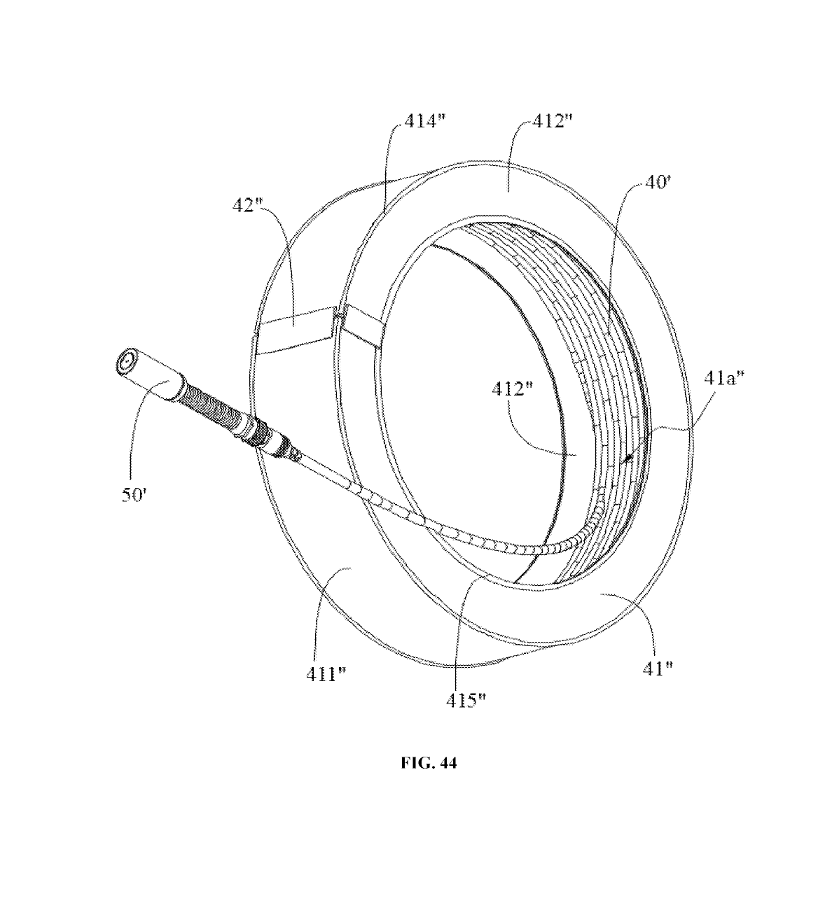

Referring to FIGS. 41-44, the pipeline endoscopic system 1' also includes a protective cover 40", which includes a flexible cover body 41" and a closed structure 42".

The flexible cover body 41" serves as the main body of the protective cover 40", and has an accommodating cavity 41" and an opening 41b" for the winding wheel 32' to extend into the accommodating cavity 41". The specific structure of the flexible cover body 41 will be introduced in the following text.

The closed structure 42" serves as a connecting structure for the protective cover 40", and is located at the position of the opening 41b" of the flexible cover body 41".

The closed structure 42" is configured to allow the opening 41b" of the flexible cover body 41" to open. At this time, the winding wheel 32' can pass out of the accommodating cavity 41" of the flexible cover body 41" through the opening 41b"of the flexible cover body 41", so that the flexible cover body 41" can be disassembled from the winding wheel 32'. Users can release the cable 40' according to actual needs to enable the endoscope probe 50' to effectively survey the internal situation of the pipeline.

The closed structure 42" is also configured to fasten the opening 41b" of the flexible cover body 41", so that the winding wheel 32' cannot pass out of the accommodating cavity 41" of the flexible cover body 41" through the opening 41b" of the flexible cover body 41". Therefore, the flexible cover body 41" is fitted around the periphery of the winding wheel 32', effectively protecting the cable 40'.

By designing a closed structure 42" at the position where the flexible cover body 41" is located at the opening 41b", the flexible cover body 41" can open the opening 41b" of the flexible cover body 41" through the closed structure 42" at the position where the opening 41b" is located, at this time, the winding wheel 32' can pass out of the accommodating cavity of the flexible cover body 41" through the opening 41b" of the flexible cover body 41", so that the flexible cover body 41" can be disassembled from the winding wheel 32'. Users can release the cable 40' according to actual needs to enable the endoscope probe 50' to effectively survey the internal situation of the pipeline. By designing a closed structure 42" at the position where the flexible cover body 41" is located at the opening 41b ", the flexible cover body 41" can be fastened to the opening 41b" of the flexible cover body 41" through the closed structure 42" at the position where the opening 41b" is located, at this time, the winding wheel 32' cannot pass out of the accommodating cavity of the flexible cover body 41" through the opening 41b" of the flexible cover body 41", so that the flexible cover body 41" is fitted around the periphery of the winding wheel 32', effectively protecting the cable 40'. The flexible cover body 41" can provide protection for the cable 40', and its weight is light. Compared with the design of a box in related technologies to protect the cable 40', it will not make the overall weight of the pipeline endoscope system 1' heavier. Moreover, the flexible cover 41 is more in line with the winding frame and will not occupy too much space in the pipeline endoscope system 1', making it easier for users to carry; in addition, through the detachable design of the flexible cover body 41" and the winding wheel 32', users can remove the flexible cover body 41" from the winding wheel 32', so that the endoscope probe 50' will not interfere with the cable 40' during pipeline survey, and the release or winding process of the cable 40' will remain smooth.

As shown in FIG. 44, the flexible cover body 41" includes a side wall 411" and two opposing annular end walls 412". The side wall 411" is located between the two opposing annular end walls 412", and the side wall 411" is connected to the two annular end walls 412" to jointly enclose the accommodating cavity 41" with the two annular end walls 412". The side wall 411" and the two annular end walls 412" form a fracture 413" in the circumferential direction along the winding wheel 32', and the fracture 413" serves as the opening 41b" for the winding wheel 32' to extend into the accommodating cavity 41".

By designing a side wall 411" and two opposing annular end walls 412", the bottom wall and the two annular end walls 412" are enclosed to form a flexible cover body 41" with a cross section in a concave shape. This not only provides good protection for the cable 40' wound around the winding wheel 32', but also saves material for the flexible cover body 41". By designing the side wall 411" and two annular end walls 412" to form a fracture 413" along the circumference of the winding wheel 32', combined with the flexibility of the flexible cover body 41" itself, the fracture 413" of the flexible cover body 41" is enlarged to enhance the convenience of the flexible cover body 41" to detach or cover the winding wheel 32'.

It can be understood that the closed structure 42" is used as a connecting structure to connect the opening 41b" of the flexible cover body 41". The specific manifestations of the closed structure 42" can include but are not limited to the following situations.

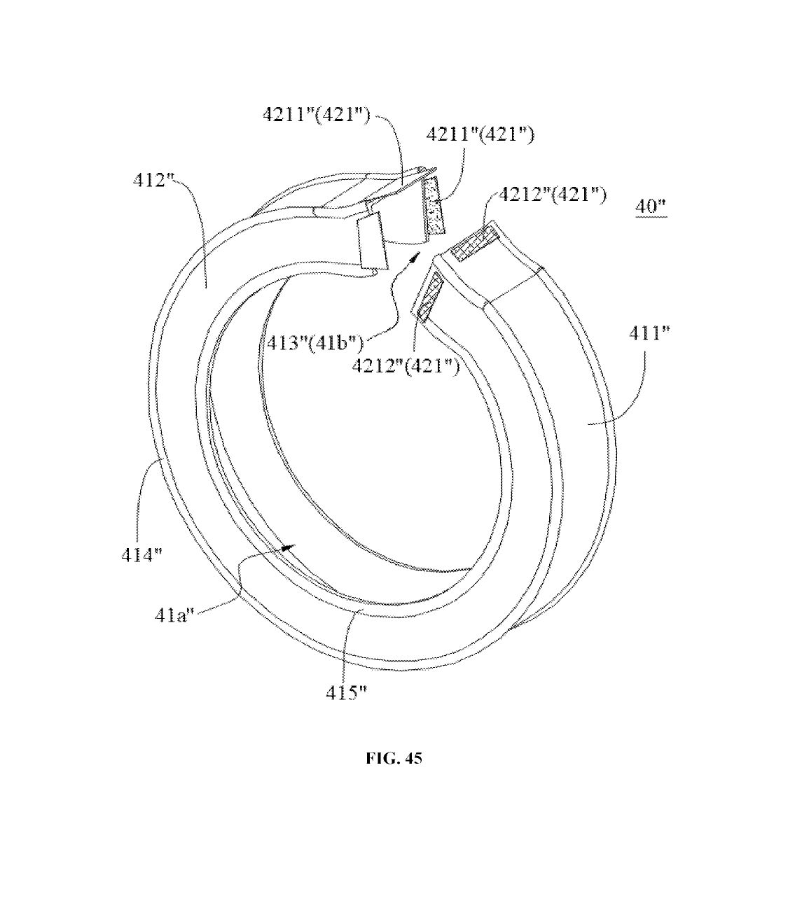

As shown in FIG. 45, in the first scenario, the closed structure 42" includes a Velcro 421", which is fixed to the side wall 411" at the position of the fracture 413", and/or the Velcro 421" is fixed to the two annular end walls 412" at the position of the fracture 413". Among them, the specific connection method between the Velcro 421" and the side wall 411" (and/or the annular end wall 412") is not limited here, and designers can make reasonable designs according to actual needs; for example, the Velcro 421" can be fixedly attached to side wall 411" (and/or annular end wall 412") in a non removable manner, but is not limited to, by adhesive bonding or needle and thread stitching. The Velcro 421" includes a male sticker 4211" and a female sticker 4212". The male sticker 4211" and the female sticker 4212" can be fixed on the side wall 411" (and/or the annular end wall 412") at the position of the fracture 413" according to actual needs. By designing a Velcro 421" at the position of the fracture 413" on the side wall 411 ", the flexible cover body 41" at the position of the fracture 413" can be separated by a male sticker 4211" and a female sticker 4212" to open the fracture 413" of the flexible cover body 41", at this time, the winding wheel 32' can pass out of the accommodating cavity of the flexible cover body 41" from the fracture 413" of the flexible cover body 41", so that the flexible cover body 41" can be disassembled from the winding wheel 32". Users can release the cable 40" according to actual needs to enable the endoscope probe 50" to effectively survey the internal situation of the pipeline. By designing a Velcro 421" at the position of the fracture 413" on the side wall 411", the flexible cover body 41" can be fastened to the fracture 413" of the flexible cover body 41" at the position of the fracture 413" by bonding the male sticker 4211" and the female sticker 4212", at this time, the winding wheel 32' cannot pass out of the accommodating cavity of the flexible cover body 41" through the fracture 413" of the flexible cover body 41", so that the flexible cover body 41" is fitted around the periphery of the winding wheel 32", effectively protecting the cable 40'.

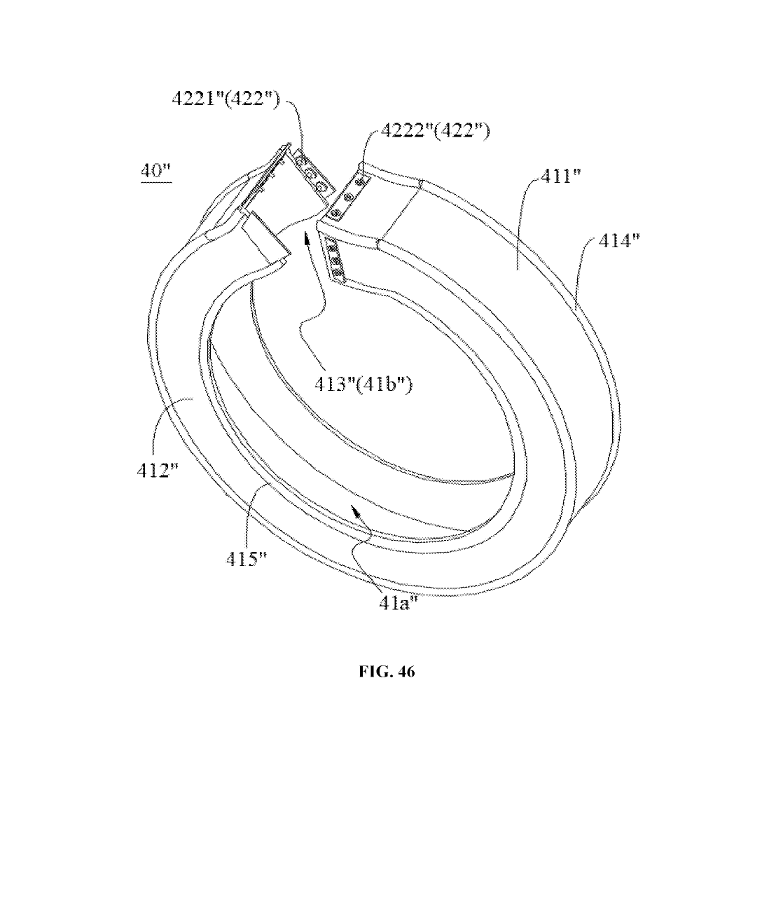

As shown in FIG. 46, in the second scenario, the closed structure 42" includes a buckle 422", which is fixed at the position of the side wall 411" at the fracture 413", and/or the buckle 422" is fixed at the position of the two annular end walls 412" at the fracture 413". Among them, the specific connection method between the buckle 422" and the side wall 411" (and/or the annular end wall 412") is not limited here, and designers can make reasonable designs according to actual needs; for example, the buckle 422" can be fixedly connected to the side wall 411" (and/or the annular end wall 412") in a non removable manner through adhesive bonding, needle and thread stitching, or rivet riveting. The buckle 422" includes a male buckle 4221" and a female buckle 4222". The male buckle 4221" and the female buckle 4222" can be fixed on the side wall 411" (and/or the annular end wall 412") at the position of the fracture 413" according to actual needs. By designing a buckle 422"at the position of the fracture 413" on the side wall 411", the flexible cover body 41" can be detached at the position of the fracture 413" through the male buckle 4221" and the female buckle 4222" to open the fracture 413" of the flexible cover body 41", at this time, the winding wheel 32' can pass out of the accommodating cavity of the flexible cover body 41" from the fracture 413" of the flexible cover body 41", so that the flexible cover body 41" can be disassembled from the winding wheel 32". The user can release the cable 40"according to actual needs to enable the endoscope probe 50" to effectively survey the internal situation of the pipeline. By designing a buckle 422" at the position of the fracture 413" on the side wall 411", the flexible cover body 41" can be fastened to the fracture 413" of the flexible cover body 41" at the position of the fracture 413" through the male buckle 4221" and the female buckle 4222", at this time, the winding wheel 32' cannot pass out of the accommodating cavity of the flexible cover body 41" through the fracture 413" of the flexible cover body 41", so that the flexible cover body 41" is sleeved on the periphery of the winding wheel 32', effectively protecting the cable 40'.

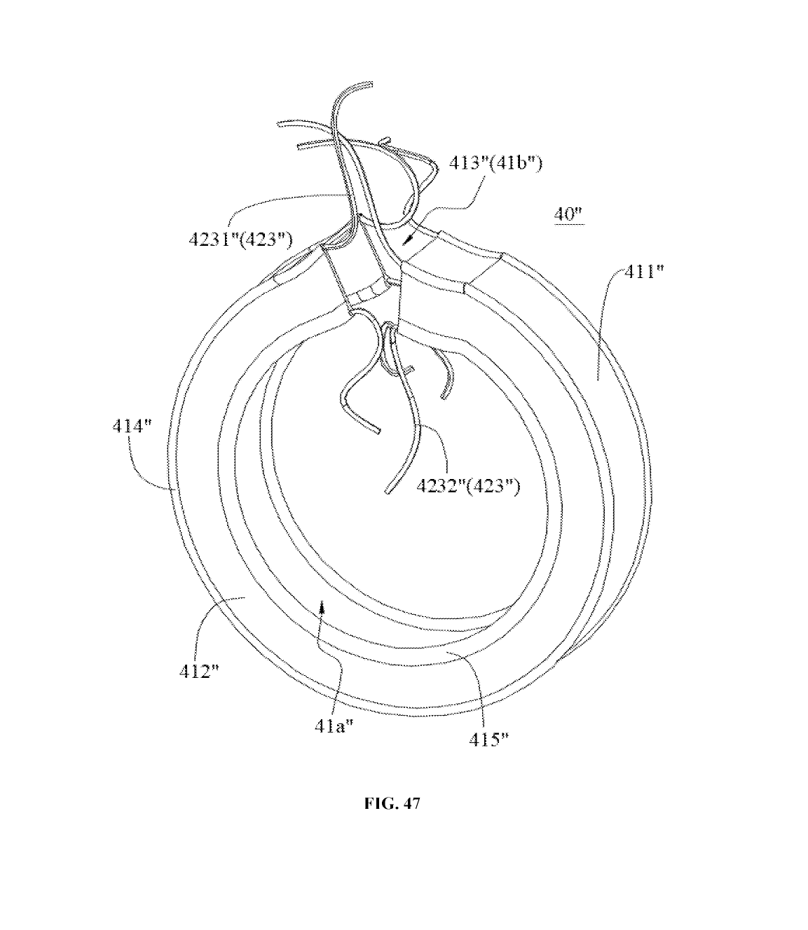

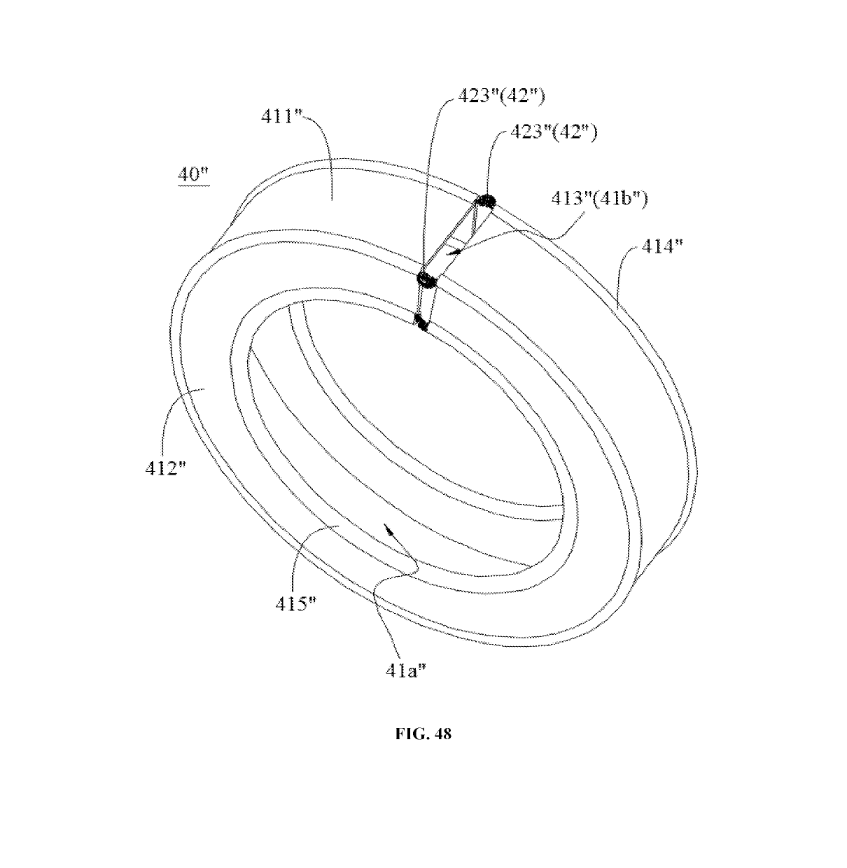

As shown in FIGS. 47 and 48, in the third scenario, the closed structure 42" includes a tether 423", which is fixed to the side wall 411" at the position of the fracture 413", and/or the tether 423" is fixed to the two annular end walls 412" at the position of the fracture 413". Among them, the specific connection method between the tether 423" and the side wall 411" (and/or the annular end wall 412") is not limited here, and designers can make reasonable designs according to actual needs; for example, the tether 423" can be fixedly connected to the side wall 411" (and/or the annular end wall 412") in a non detachable manner, but is not limited to, by adhesive bonding or needle and thread stitching. The rope 423" includes a first rope body 4231" and a second rope body 4232". The first rope body 4231" and the second rope body 4232"can be fixed to the side wall 411" (and/or the annular end wall 412") at the position of the fracture 413" according to actual needs. By designing a tether 423" at the position of the fracture 413" on the side wall 411", the flexible cover body 41" can be separated by the first tether 4231" and the second tether 4232" at the position of the fracture 413" to open the fracture 413" of the flexible cover body 41", at this time, the winding wheel 32' can pass out of the accommodating cavity of the flexible cover body 41" through the fracture 413" of the flexible cover body 41", so that the flexible cover body 41" can be disassembled from the winding wheel 32". The user can release the cable 40" according to actual needs to enable the endoscope probe 50" to effectively survey the internal situation of the pipeline. By designing a tether 423"at the position of the fracture 413" on the side wall 411", the flexible cover body 41" can be fastened to the fracture 413" of the flexible cover body 41" at the position of the fracture 413" through the first tether 4231" and the second tether 4232", at this time, the winding wheel 32' cannot pass out of the accommodating cavity of the flexible cover body 41" through the fracture 413" of the flexible cover body 41", so that the flexible cover body 41" is sleeved on the periphery of the winding wheel 32", effectively protecting the cable 40'.

As shown in FIGS. 44-48, a flexible reinforcing rib 414" is fixedly connected at the connection position between the side wall 411" and the two annular end walls 412". Among them, the flexible reinforcing rib 414" can be fixed at the connection position between the side wall 411" and the two annular end walls 412" by sewing with needle and thread, but not limited to. By designing flexible reinforcement ribs 414", the flexible reinforcement ribs 414" provide support for the connection position between the side wall 411" and the two annular end walls 412", making the flexible cover body 41" less prone to deformation and more rigid as a whole.

As shown in FIGS. 44-48, the inner annular edges of the two annular end walls 412" are fixedly connected with a flexible reinforced flange 415". Among them, the flexible reinforcement flange 415" can be fixed on the inner annular edges of the two annular end walls 412" by sewing with needle and thread, but not limited to. By designing a flexible reinforcement flange 415", the flexible reinforcement flange 415" provides support to the inner annular edges of the two annular end walls 412", making the flexible cover body 41" less prone to deformation and more rigid as a whole; in addition, the flexible reinforcement flange 415" also avoids the inner annular edges of the two annular end walls 412" from contacting the winding wheel 32' or cable 40', effectively reducing the possibility of the inner annular edges of the two annular end walls 412" being worn by the winding wheel 32'or cable 40'.

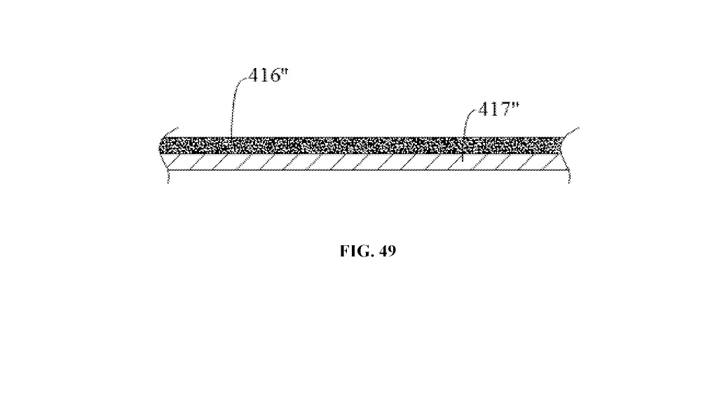

As shown in FIG. 49, the flexible cover body 41" includes a wear-resistant layer 416" as the outer lining and a waterproof layer 417" as the inner lining. The material of the wear-resistant layer 416" includes nylon, polyester, or Oxford cloth, and/or the material of the waterproof layer 417" includes polyurethane (PU) or polyvinyl chloride (PVC). The wear-resistant layer 416" serves as the outer lining layer, mainly to resist friction, scratching, and tearing, and to protect the waterproof layer 417" as the inner lining layer from damage. The waterproof layer 417" serves as the inner lining layer, mainly for waterproofing.

Specifically, as shown in FIGS. 41-43, the support base 31' includes a U-shaped rod 311' and two opposing support legs 312'. The two ends of the U-shaped rod 311' are fixedly connected to the two opposing support legs 312' one by one, and the winding wheel 32' is rotatably connected to the two support legs 312'. Each leg 312" includes two horizontal bars 3121" and two diagonal bars 3122". The two horizontal bars 3121" are arranged vertically, with one diagonal bar 3122" fixedly connected to one end of the two horizontal bars 3121" and the other diagonal bar 3122" fixedly connected to the other end of the two horizontal bars 3121". The two ends of the U-shaped bar 311" are fixedly connected to the two horizontal bars 3121" above the two legs 312". The U-shaped rod 311" is designed in this way to connect the two opposing legs 312" into a whole, so that the two opposing legs 312" can be stably placed on external carriers such as the ground, providing stable support for the winding wheel 32'. In addition, the U-shaped rod 311" is also used as a grip for users to hold, facilitating the transportation of the pipeline endoscope system 1'.

The above descriptions are only preferred embodiments of the present disclosure, and are not intended to limit the patent scope of the present disclosure. Any equivalent structural transformation made by using the content of the specification and the drawings of the present disclosure under the invention idea of the present disclosure, directly or indirectly applied to other related technical fields, shall all be included in the scope of patent protection of the present disclosure.

What is claimed is:

1. A pipeline endoscope system, comprising:
an endoscope probe, configured for extending into a pipeline and capturing images of the pipeline;
a cable, configured for electrically connecting the endoscope probe;
a cable support device, comprising a winding wheel for winding the cable; and
a measurement display module, comprising a cable length measuring device and a display device, wherein the cable length measuring device comprises a control module and a detection module; at least part of the detection module is connected to the cable and rotates with the winding wheel or the cable, and the control module is electrically connected to the cable to receive images captured by the endoscope probe; and the display device communicates with the control module to receive and display the images captured by the endoscope probe;
the detection module is configured to generate a sensing signal when the winding wheel rotates, and the control module is capable of receiving the sensing signal, and calculating a length of the cable extension or retraction on the winding wheel based on the sensing signal.

2. The pipeline endoscope system according to claim 1, wherein the cable support device further comprises a support base connected to the winding wheel and supporting the winding wheel;
the cable length measuring device further comprises a housing assembly, and the housing assembly comprises a fixing housing;
the winding wheel comprises a hollow central axle, and the central axle of the winding wheel is rotatably connected to the fixing housing, and the detection module is located in a cavity formed by the central axle and the fixing housing.

3. The pipeline endoscope system according to claim 1, wherein the detection module includes an encoder electrically connected to the control module, the encoder comprises a rotating end and a fixing end, with the rotating end fixed to the central axle of the winding wheel and the fixing end housed within the fixing housing;
the control module internally stores calculation models corresponding to multiple different winding wheels, based on preset winding wheel size data or user-provided winding wheel size data, the control module calculates the length of cable extension or retraction by combining the sensing signal and one of the calculation models.

4. The pipeline endoscope system according to claim 3, wherein the rotating end of the encoder is electrically connected to the cable, the images captured by the endoscope probe are transmitted to the control module via the cable and the encoder, while the control module supplies power to the endoscope probe through the encoder and the cable;
the encoder includes a signal transmission terminal for transmitting image signals from the endoscope probe, a power signal transmission terminal for transmitting a power supply signal, and a sensing signal transmission terminal for transmitting the sensing signal.

5. The pipeline endoscope system according to claim 4, wherein the cable length measuring device further comprises a rotary transmission component comprising a connecting part and a rotating part, the connecting part is fixedly connected to the fixing housing, and the rotating part is rotatably connected to the connecting part and maintains electrical connection with the connecting part;
the fixing end of the encoder and the cable are electrically connected to the rotating part, and the connecting part is electrically connected to the control module;
wherein the fixing end of the encoder rotates relative to the rotating end of the encoder to generate the sensing signal; the encoder transmits the sensing signal to the rotary transmission component which then transmits the sensing signal to the control module.

6. The pipeline endoscope system according to claim 2, wherein the housing assembly further comprises a rotating housing rotatably connected to the fixing housing, the winding wheel comprises a central axle, the rotating housing is connected to the central axle and rotates with the winding wheel, and the detection module is located in a cavity formed by the rotating housing and the fixing housing;
the control module comprises a control board, which is mounted on the fixing housing and electrically connected to the cable;
the detection module comprises a first detection component and a second detection component, wherein the first detection component is located on one side of the rotating housing, and the second detection component is provided on the control board and electrically connected to the control board;
wherein when the rotating housing rotates relative to the fixing housing, the second detection component cooperates with the first detection component to generate the sensing signal, and the control board calculates the length of the cable extension or retraction on the winding wheel based on the sensing signal.

7. The pipeline endoscope system according to claim 6, wherein the first detection component comprises at least one magnet located in the rotating housing, and the second detection component comprises at least one Hall sensor located on the control board and is electrically connected to the control board;
the at least one magnet comprises at least two magnets, and the at least two magnets are evenly spaced along a circumference of the rotating housing; and/or the at least one Hall sensor comprises at least two Hall sensors, and the at least two Hall sensors are evenly spaced along a circumference of the fixing housing.

8. The pipeline endoscope system according to claim 6, wherein the first detection component comprises a transmitter located in the rotating housing, and the second detection component comprises a receiver located on the control board and is electrically connected to the control board;
the transmitter comprises at least two transmitters, and the at least two transmitters are arranged at equal intervals along a circumference of the rotating housing; and/or
the receiver comprises at least two receivers, which are arranged at equal intervals along a circumference of the fixing housing;
the transmitter is an infrared transmitter, a photoelectric transmitter, or an ultrasonic transmitter, and the receiver is an infrared receiver, a photoelectric receiver, or an ultrasonic receiver.

9. The pipeline endoscope system according to claim 1, wherein the cable support device further comprises a support base connected to the winding wheel and supporting the winding wheel;
the detection module comprises a shell installed on the support base, a pulley assembly set on the shell, a transmission component connected to the pulley assembly, an encoder comprising a rotating end connected to the transmission component and a fixing end, and a counting board electrically connected to the fixing end of the encoder and installed on the shell;
the cable is fixed to the pulley assembly and is capable of driving the pulley assembly to rotate; the transmission component rotates synchronously with the pulley assembly and drives the rotating end of the encoder to rotate during rotation, thereby allowing the fixing end of the encoder output the sensing signal.

10. The pipeline endoscope system according to claim 9, wherein the shell comprises a shell body installed on the support base, sliding rods extending in a direction perpendicular to an extension and contraction direction of the cable and fixedly connected to the shell body, sliding blocks each slidably connected to one of the sliding rods, and an elastic member connected between the shell body and the sliding blocks; the transmission member, encoder, and counting plate are arranged in the shell body;
the pulley assembly includes a first roller and a second roller, the first roller is rotatably connected to the shell body, and the first roller moves with the transmission component, the second roller is rotatably connected to the sliding blocks, and the second roller and the first roller are arranged in a direction perpendicular to the extension and contraction direction of the cable;
the cable is clamped between the first roller and the second roller; when the cable is laid out, the first roller rotates to drive the transmission component to rotate, thereby driving the rotating end of the encoder to rotate relative to the fixing end of the encoder to generate the sensing signal.

11. The pipeline endoscope system according to claim 10, wherein the elastic member includes springs each sleeved on a periphery of one of the sliding rods, and the springs are located on a side of the sliding blocks away from the first roller;
wherein the sliding rods comprises two sliding rods, and the two sliding rods are arranged side by side along the extension and contraction direction of the cable; the springs comprises two springs, and the two springs each are correspondingly fitted around the periphery of one of the sliding rods;
the transmission component includes a first counting wheel set on the shell body and connected to the first roller for transmission, the first counting wheel is connected to the rotating end of the encoder for transmission; when the cable is laid out, the first roller rotates to drive the first counting wheel to rotate, thereby driving the rotating end of the encoder to rotate relative to the fixing end of the encoder to generate the sensing signal.

12. The pipeline endoscope system according to claim 9, wherein the pulley assembly includes two pulleys connected to the shell, and the transmission component includes a counting wheel connected to one of the pulleys for transmission; the counting wheel is connected to the rotating end of the encoder for transmission;
the cable is arranged between the two pulleys, when the cable is laid out, the two pulleys rotate to drive the counting wheel to rotate, thereby driving the rotating end of the encoder to rotate relative to the fixing end of the encoder to generate the sensing signal.

13. The pipeline endoscope system according to claim 12, wherein the two pulleys comprise a first pulley and a second pulley; a position of the first pulley relative to the shell is adjustable, and a position of the second pulley relative to the shell is fixed; and the counting wheel is coaxially fixedly connected to the second pulley.

14. The pipeline endoscope system according to claim 13, wherein the shell is provided with an elongated through hole, and the first pulley comprises a pulley body, a bearing, and a fixing sleeve; the pulley body is fixedly connected to an outer ring of the bearing, and the fixing sleeve is fixedly connected to an inner ring of the bearing;
the detection module also comprises a first fixing piece and a second fixing piece; the first fixing piece is threaded through the fixing sleeve and connected to an inner wall of the fixing sleeve, and the second fixing piece is threaded through the elongated through hole and connected to the inner wall of the fixing sleeve, so as to position the pulley body and the fixing sleeve as a whole in the shell; the fixing sleeve is a threaded sleeve, the first fixing piece is a first locking screw, and the second fixing piece is a second locking screw;
wherein an axle of the second pulley is provided with a fixing hole, and the detection module further comprises a pressing piece and a third fixing piece; the pressing piece is in a strip shape, and the pressing piece is provided with a through hole and an adjustment through hole extending along a lengthwise direction thereof;
the first fixing piece extends the adjustment through hole and connected to the inner wall of the fixing sleeve, and the third fixing piece extends the through hole and connected to the fixing hole.

15. The pipeline endoscope system according to claim 9, wherein the cable support device further comprises a limiting member connected to the support base, when the cable is not laid out, one end of the limiting member is connected to a wheel disc of the winding wheel to limit the rotation of the winding wheel relative to the support base;
the limiting component comprises a hook buckle, and a hook tail of the hook buckle is connected to the support base, when the cable is not laid out, a hook head of the hook buckle is hooked into the wheel disc of the winding wheel.

16. The pipeline endoscope system according to claim 9, wherein the support base includes four U-shaped frames, with two U-shaped frames facing each other in a front to rear direction and standing upright, and the other two U-shaped frames facing each other in a left to right direction and standing inverted; the four U-shaped frames are connected in sequence;
the support base further includes three upper cross beams extending in the left to right direction and arranged at intervals in the front to rear direction, with two of the upper cross beams are fixedly connected to the two U-shaped frames, and the remaining one of the upper cross beams is fixedly connected to the fixing housing and fixedly connected to the U-shaped frame;
the support base further comprises a lower longitudinal beam extending in the front to rear direction, and the lower longitudinal beam is fixedly connected to the two U-shaped frames respectively, a central axle of the winding wheel is rotatably connected to the lower longitudinal beam.

17. The pipeline endoscope system according to claim 1, wherein the cable support device comprises a support bracket;
the cable length measuring device further comprises a housing assembly, and the housing assembly comprises a fixing housing and a rotating housing, the fixing housing is fixedly connected to a support bracket, while the rotating housing is rotatable relative to the fixing housing, the winding wheel is fixedly connected to the rotating housing;
the detection module includes an encoder electrically connected to the control module; a rotating end of the encoder is fixedly connected to the support bracket, and a fixing end of the encoder is fixedly connected to the rotating housing.

18. The pipeline endoscope system according to claim 17, wherein the cable length measuring device further comprises a rotary transmission component comprising a connecting part and a rotating part, the connecting part is fixedly connected to the fixing housing, and the rotating part is rotatably connected to the connecting part and maintains electrical connection with the connecting part;
the fixing end of the encoder is electrically connected to the rotating part, and the connecting part is electrically connected to the control module;
the control module incudes an aviation connector, which is installed on the fixing housing and electrically connected to the connecting part; the rotating housing is provided with a wire hole, and the cable is threaded through the wire hole and electrically connected to the rotating part;
the cable length measuring device further comprises a first bearing, an inner ring of the first bearing is fixedly connected to the fixing housing, and an outer ring of the first bearing is fixedly connected to the rotating housing, thereby when the rotating housing rotates relative to the fixing housing, the rotating housing drive the outer ring of the first bearing to rotate relative to the inner ring of the first bearing.

19. The pipeline endoscope system according to claim 1, wherein the cable support device comprises a support base connected to the winding wheel and supporting the winding wheel;
wherein the pipeline endoscope system further comprises:
a flexible cover body comprising an accommodating cavity and an opening for the winding wheel to extend into the accommodating cavity; and
a closed structure located at a position of the opening of the flexible cover body, and the closed structure is configured to allow the opening of the flexible cover body to be open, so that the flexible cover can be disassembled from the winding wheel; the closed structure is also configured to allow the opening of the flexible cover to be fastened, so that the flexible cover can be fitted around a periphery of the winding wheel.

20. The pipeline endoscope system according to claim 19, wherein the flexible cover body includes a side wall and two opposing annular end walls, the side wall is located between the two opposing annular end walls, and the side wall is connected to the two annular end walls to jointly enclose the accommodating cavity with the two annular end walls;
the side wall and the two annular end walls cooperatively form a fracture in a circumferential direction along the winding wheel, and the fracture serves as the opening for the winding wheel to extend into the accommodating cavity.
